(19) United States
(12) Patent Application Publication
(10) Pub. No.: US 2014/0099625 A1
(43) Pub. Date: Apr. 10, 2014

(54) SYSTEM AND METHOD FOR HEALTHCARE ORGANIZATIONAL ETHICS

(71) Applicants: Richard Gennuso, McKees Rocks, PA (US); Kathleen Detar Gennuso, McKees Rocks, PA (US)

(72) Inventors: Richard Gennuso, McKees Rocks, PA (US); Kathleen Detar Gennuso, McKees Rocks, PA (US)

(21) Appl. No.: 14/046,529

(22) Filed: Oct. 4, 2013

Related U.S. Application Data
(60) Provisional application No. 61/709,443, filed on Oct. 4, 2012.

(51) Int. Cl. G09B 7/00

(52) U.S. Cl. CPC G09B 7/00
USPC 434/350

(57) ABSTRACT

The present invention (referred to herein as EthAssist) is a computer software application that delivers healthcare, life sciences, and academic industries professionals and educators an integration of academic and applied bioethics for daily use in their facilities. EthAssist provides a standardized methodology and process for gathering information supported by a comprehensive searchable body of current, relevant, academic research on clinical ethics topics specific to four knowledge bases: Knowledge-ICB, EthicsConsult, Curriculum Builder, and Internal Review Board Quality Assurance (IRBQA).

### CROSS-REFERENCE TO RELATED APPLICATIONS

This application is a Non-provisional application that claims the benefit of U.S. Provisional Application Ser. No. 61/709,443, titled HEALTHCARE ORGANIZATIONAL TOOLKIT FOR ETHICS, filed Oct. 4, 2012, which is incorporated by reference herein.

### FIELD OF THE INVENTION

This invention relates to the field of ethics training, more particularly, this invention relates to a real-time system that provides a database with current materials on ethics topics in the sciences, medical, research, and other professions capable of being searched and compiled into a customizable format for dissemination to professionals, students, and administrators.

### BACKGROUND OF THE INVENTION

Many organizations lack bioethics manpower and expertise, and tackle ethics-related issues by engaging a variety of staff or others who may possess limited knowledge about bioethics best practices. By doing so, they often experience decision-making difficulty and run the risk of significant exposure when serious issues arise. There are no similar tools on the market currently that can be used by any healthcare facility or life science business that has a requirement for an ethics function.

### SUMMARY OF THE INVENTION

The present invention (referred to as herein as EthAssist) is a computer software application that delivers healthcare, life sciences, and academic industries professionals and educators an integration of academic and applied bioethics for daily use in their facilities. EthAssist provides a standardized methodology and process for gathering information supported by a comprehensive searchable body of current, relevant, academic research on clinical ethics topics specific to four knowledge bases:

Clinical Ethics—serving healthcare facilities and universities focusing on medical ethics;

Clinical Research Ethics—serving the life science industries and universities;

Public Health Ethics—serving government organizations supporting preparedness planning and community initiatives; and

Healthcare Organizational Ethics—serving all life science and healthcare organizations with compliance and culture initiatives.

EthAssist can be used by any healthcare facility or life science business that has a requirement for an ethics function.

### BRIEF DESCRIPTION OF THE DRAWINGS

The present invention is illustratively shown and described in reference to the accompanying drawings, in which:

FIG. 1 is a system diagram of the present invention;

FIGS. 2A and 2B are system diagrams that depict the interrelationship of EthAssist modules and human and machine interfaces;

FIGS. 3A-3C is an example of a report generated by the present invention;

FIGS. 4A-4E is an illustration of an exemplary database schema of the present invention;

FIG. 5 is an exemplary database structure of the present invention;

FIGS. 6A-6G are web page screen shots examples of the present invention;

FIGS. 7A-7F are exemplary questions that can be asked during an interview and match the prototype functionally;

FIGS. 8A-8P is a conceptual diagram of Curriculum Builder module;

FIGS. 8A-8K are screen shots of the Educator Template process;

FIGS. 8L-8Q are screen shots of the Student My Lessons process; and

FIGS. 9A1-9M2 are the flow charts that document decision points and warning or critical responses to questions and “Calls” to send and receive information to Knowledge-ICB.

### DETAILED DESCRIPTION OF THE INVENTION

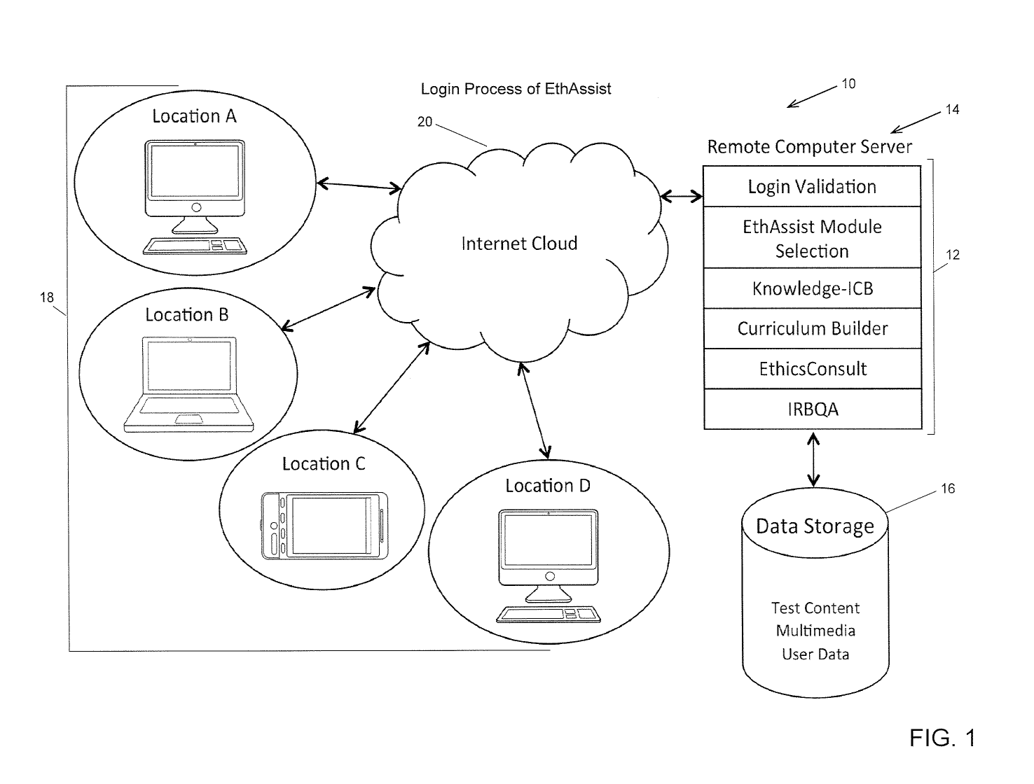

Now turning to FIG. 1 that illustrates an overview of an exemplary computer system of the present invention 10. The present invention (referred to herein as EthAssist) is a Saas (Software as a service) technical software model 12, which is software that resides on a remote computer server 14 and data storage 16 managed by an outside service that guarantees capacity, network speed, and security back up. This strategy also provides system access by users 18 from anywhere (for example, location A—first personal computer, location B—laptop, location C—mobile device, location D—second personal computer, etc.) in the world via the internet cloud 20. Though the exemplary system 10 illustrates ethics topics, system 10 is not limited to ethics topics. System 10 can be setup for educating any subject matter using the same RLO concept.

Core Idea

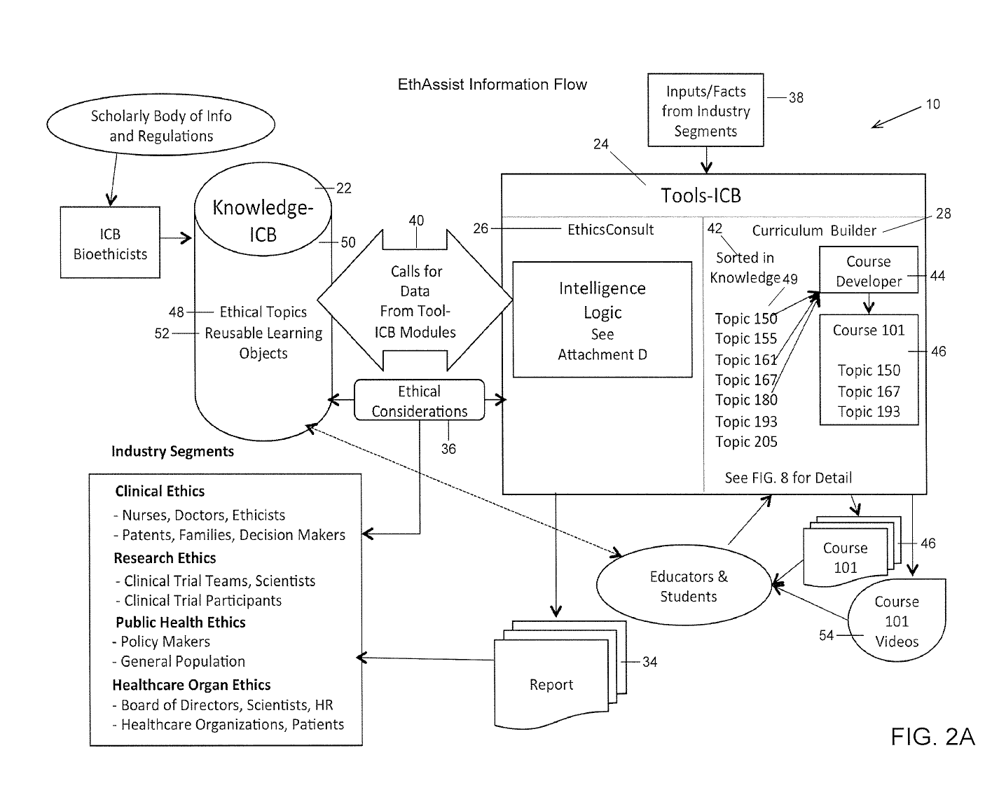

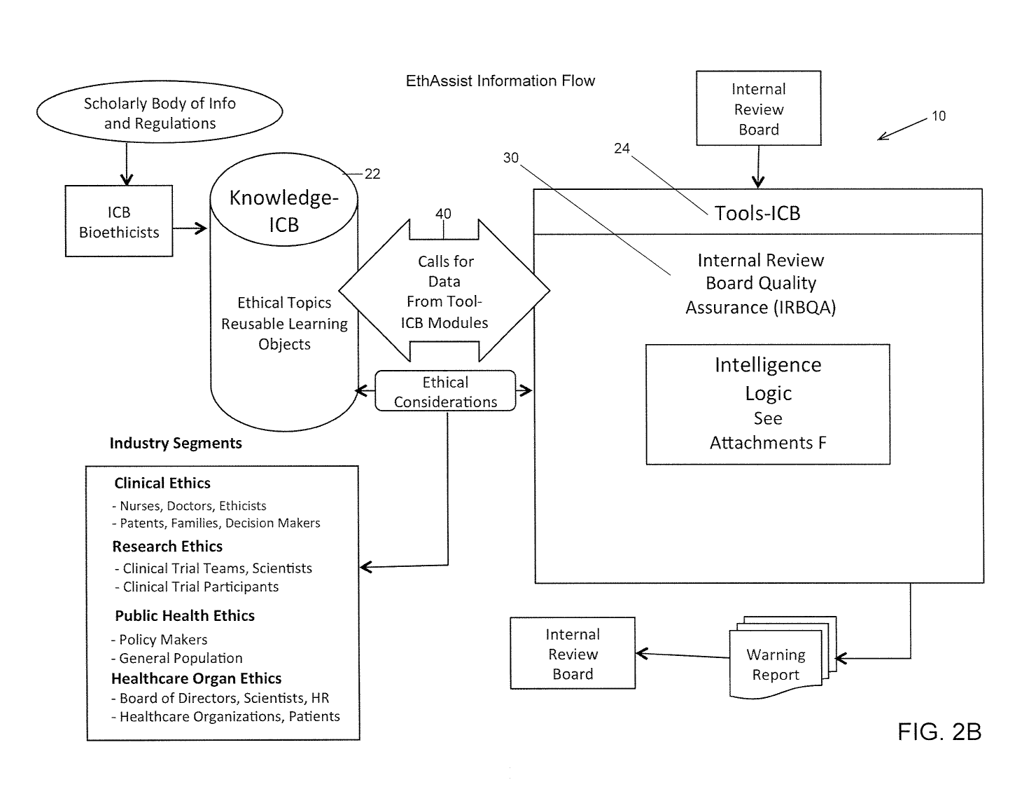

Now turning to FIGS. 2A and 2B for illustrations of EthAssist 10 that can comprise four software modules: Knowledge-ICB 22, EthicsConsult 26, Curriculum Builder 28, and Internal Review Board Quality Assurance (IRBQA) 30. Knowledge-ICB 22 and in a category of Tools-ICB 24 (previously referred to as Reliance-ICB), are the other three software modules: EthicsConsult 26, Curriculum Builder 28, and Internal Review Board Quality Assurance (IRBQA) 30. The core idea of the product is the bridge and integration of Knowledge-ICB 22 (the academic modules), and Tools-ICB 24 (the applied ethics module). The intelligence built into components of Tools-ICB 24 extracts information from Knowledge-ICB 22 integrating it into the other modules 26, 28, 30 as required and directed by the users 18. This integration provides users 18 with relevant ethics learning or process guidance, in a 24/7 environment, pertinent to the situation at-hand.

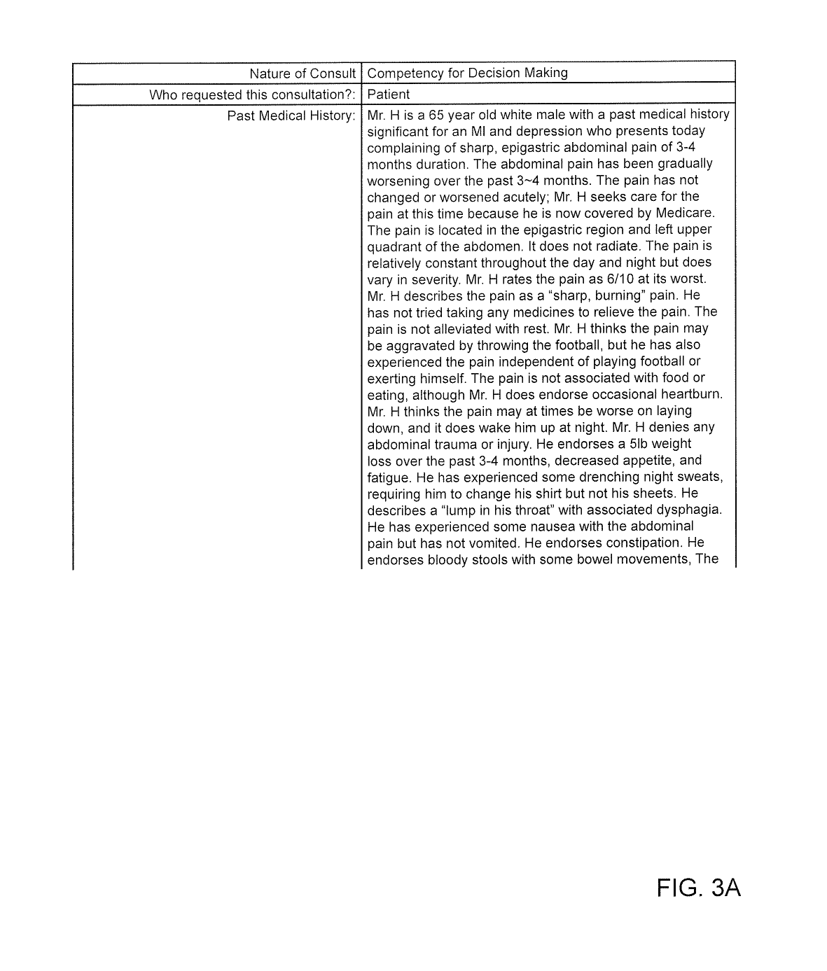

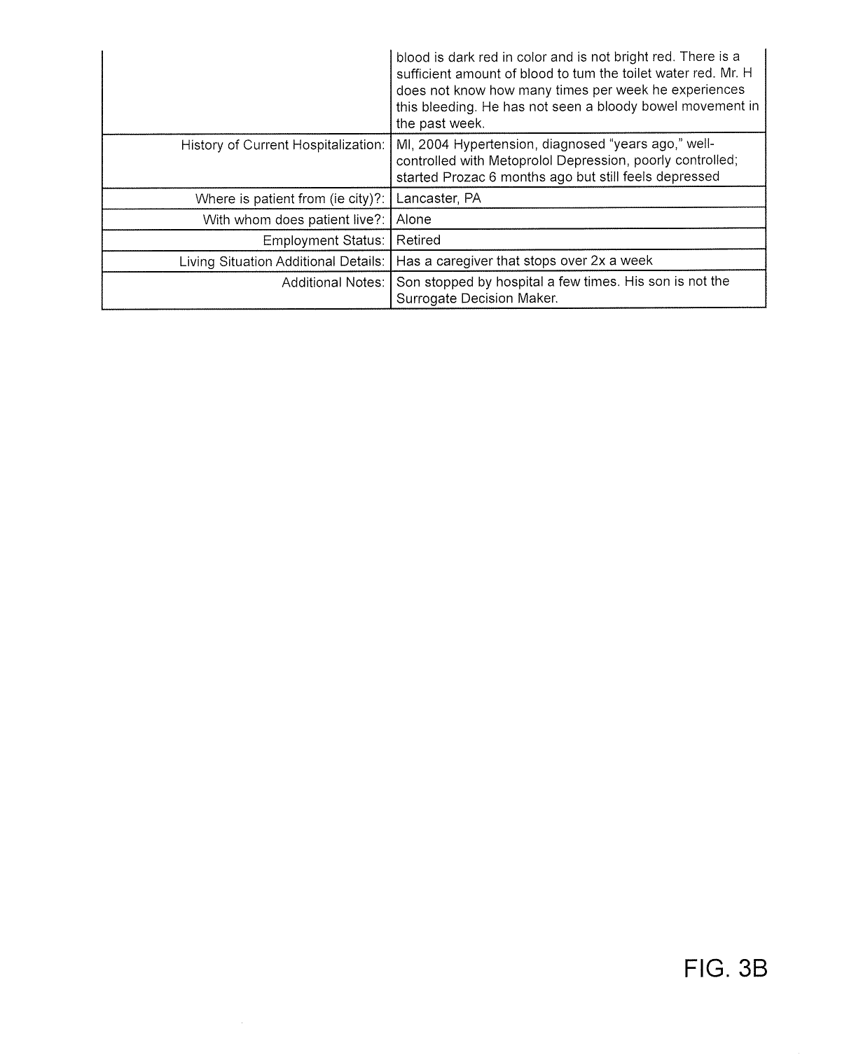

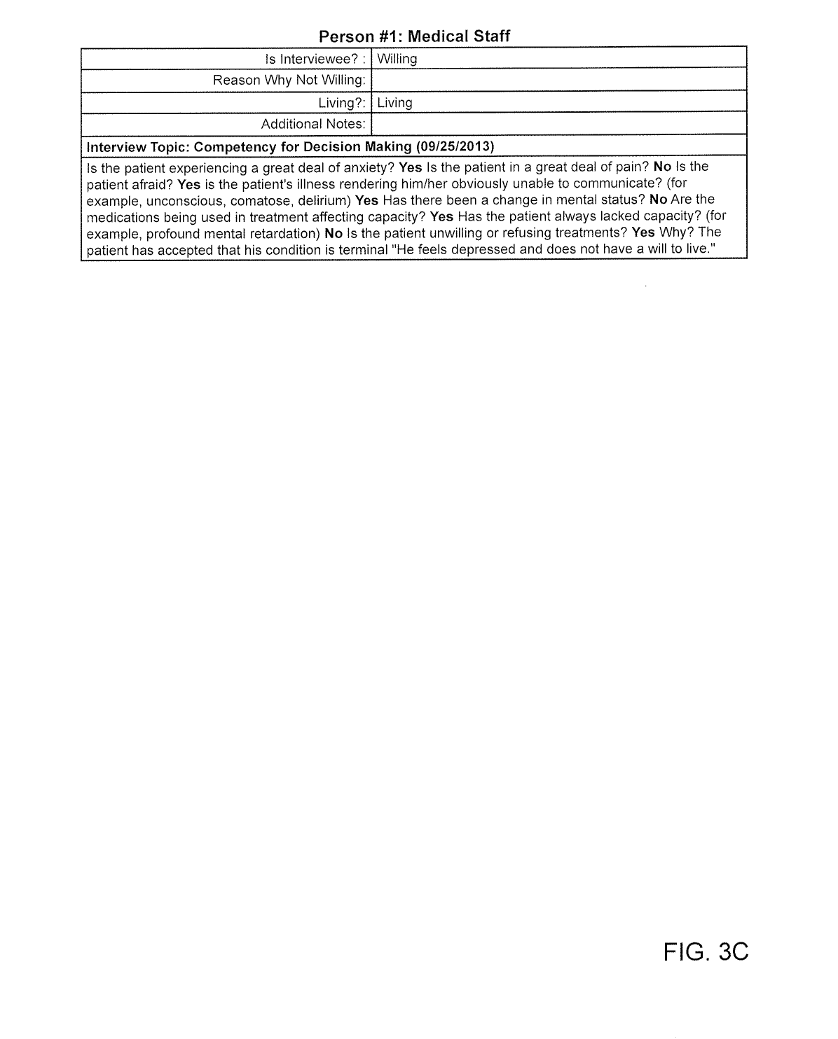

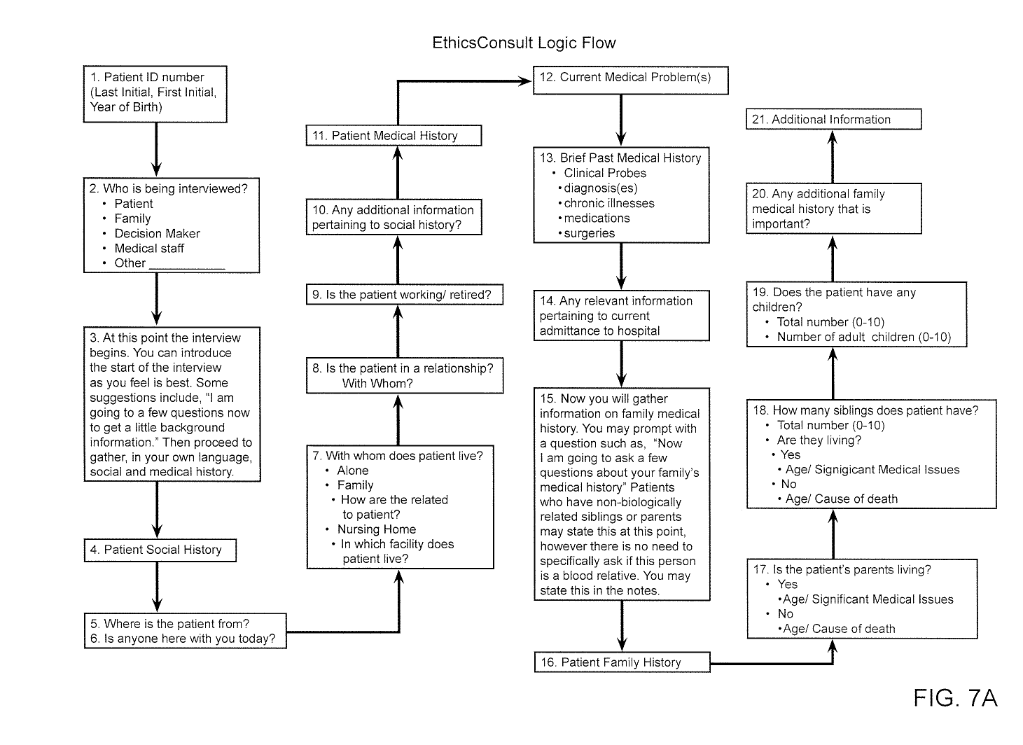

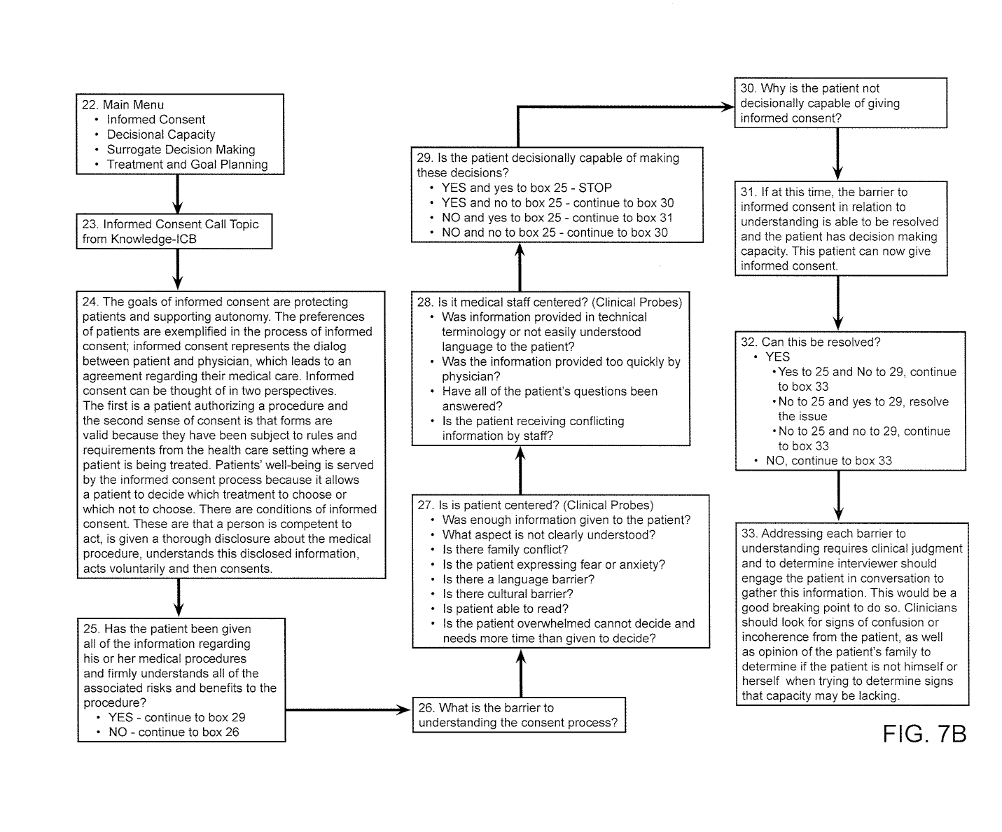

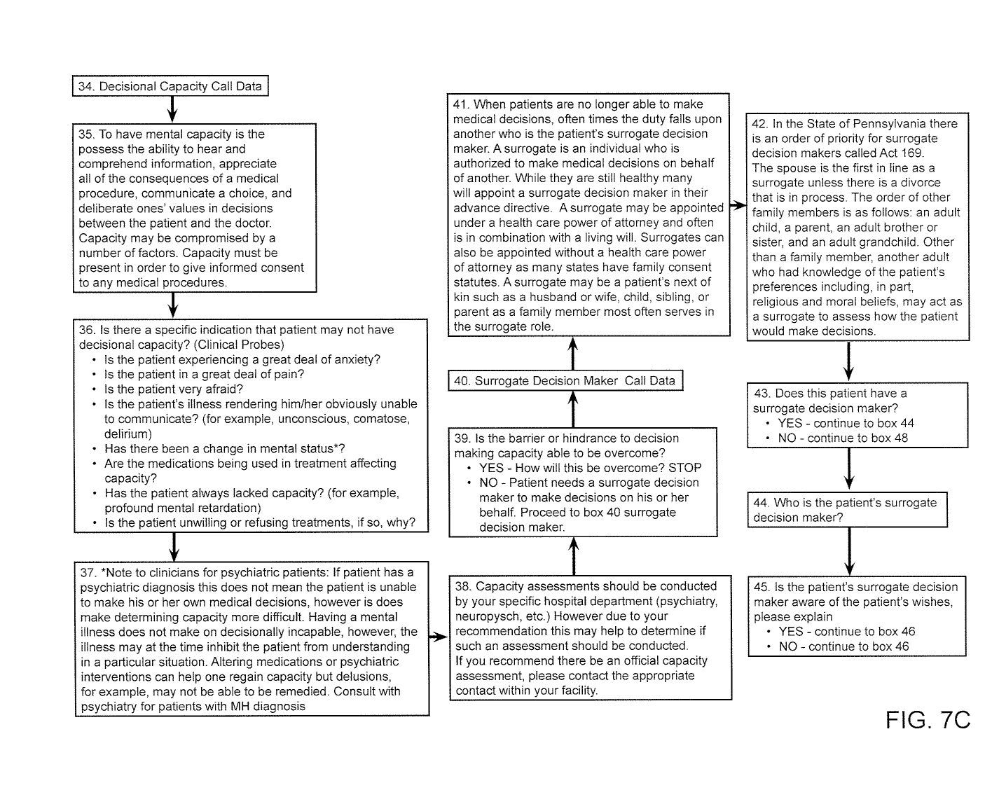

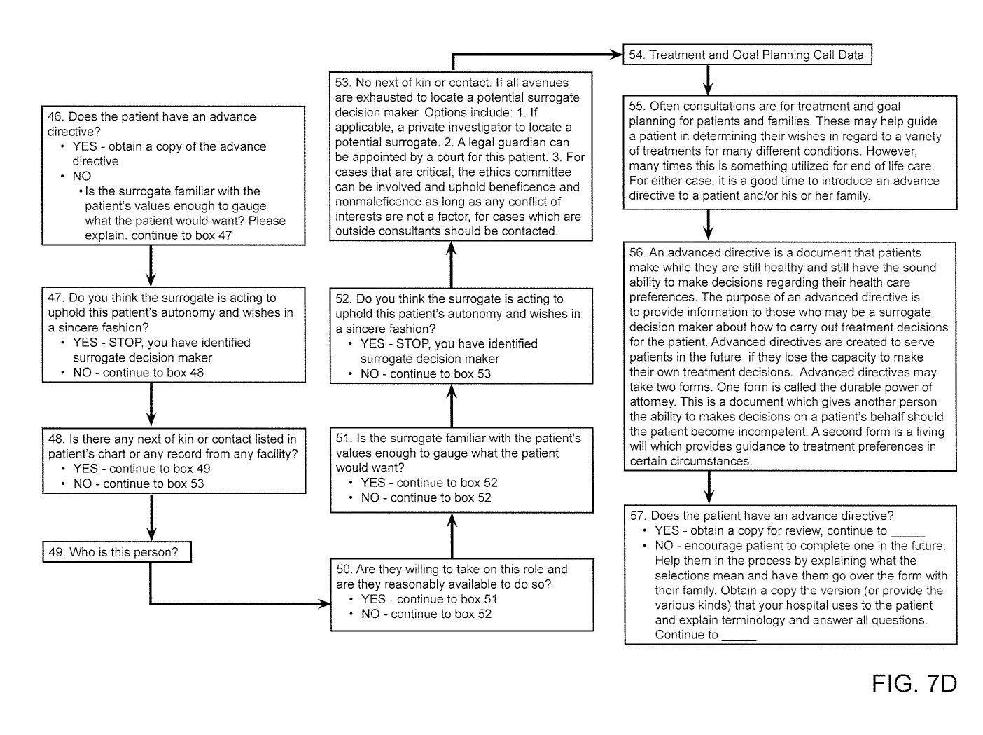

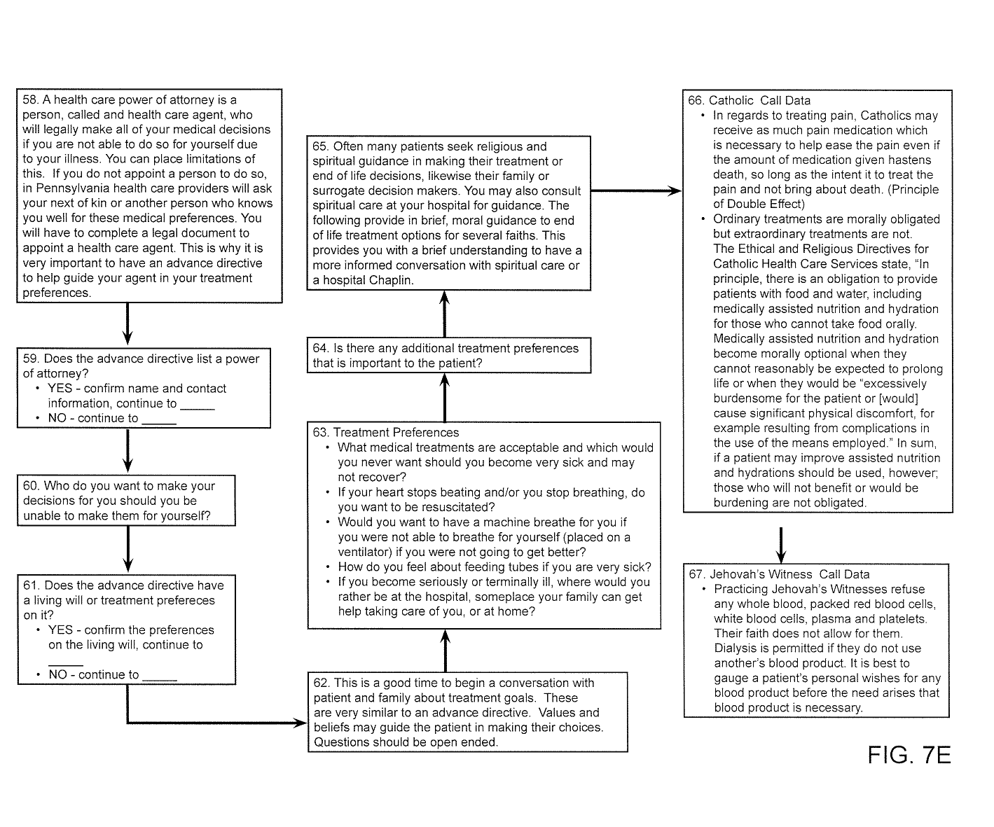

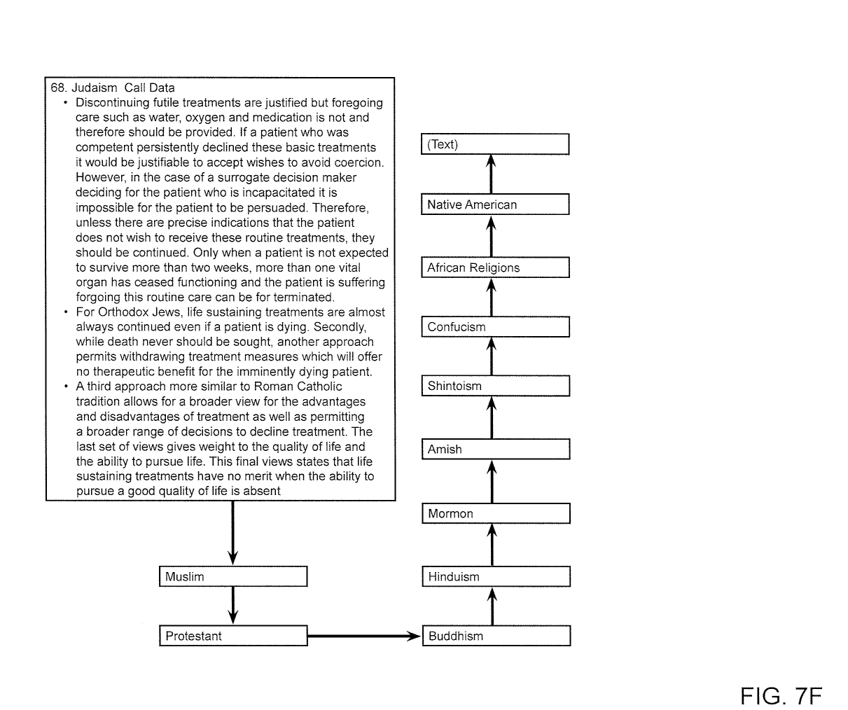

EthicsConsult 26 and IRBQA 30 are self-documenting tools. Both use embedded logic trees with decision points as indicated in FIGS. 7A-7F. A report 34 is generated at the conclusion of each tool processing documents, questions posed, and corresponding responses. IRBQA 30 reports critical and warning messages based on the importance of the question and response. See FIG. 3 for an example of a report 34.

In FIGS. 2A and 2B, the block labeled “Ethical Considerations” 36 are thought processes humans inject as indicated on FIG. 7C steps 34 and 40, into decisions based on conditions presented by the software. In both EthicsConsult 26 and IRBQA 30, the interviewer or IRB member has the option to extract an RLO from Knowledge-ICB regarding the particular ethics situation. This on the spot education would be available to be viewed by anyone involved in the EthicsConsult or IRBQA process.

FIGS. 2A and 2B depict the interrelationship of EthAssist modules and human and machine interfaces. Interfaces between Knowledge-ICB 22 and EthicsConsult 26, FIG. 1A, and interfaces between Knowledge-ICB 22 and IRBQA 30, FIG. 2A, are similar in nature. In both cases intelligent logic, is built into each of the tools. The logic is driven by the human interface responses to questions the software presents to either an interviewer, or internal review board committee member depicted on the flow charts as “Input/Facts of Industry Segments” 32.

The Curriculum Builder module 28, depicted on FIG. 2A, relies heavily on the human interface (Input/Fact of Industry Segments 38) and data interface 40 to Knowledge-ICB 22. The Curriculum Builder module 28 allows educators to extract predetermined lessons and classes 42, use them as is, modify existing or build customized education by the Course Developer 44 to build a course 46 that suites the needs of a medical facility, clinical research organization or university.

Knowledge-ICB 22

Bioethicists research, synthesize, and incorporate the latest knowledge and best-of-breed practices and theories into the searchable database 50 of Knowledge-ICB 22. Database 50 updates occur on an as-need basis, which can be continuously updated when new material is available or batch updated at a predetermined period, such as hourly, daily, monthly, quarterly, bi-annually, or annually, to best meet the needs of the clients. This model also contains Reusable Learning Objects (RLO) 52 class outlines and content suitable for teaching the associated topic 48. The users 18 of the system can extract information on hundreds of ethical topics 48 directly from Knowledge-ICB 22. Users 18 of the system 10 can use drop down menus of word search technology to find topics 48 that they need information about. Once the particular topic 48 is found, Knowledge-ICB 22 presents the user 18 with a set of related topics 49 for more in-depth information. Information is presented in three forms: on-screen text, video 54, and or voiceover narrations of PowerPoint slides.

Knowledge-ICB 22 is built on a relational database 50 with a keyword search and topic selection capability. Users 18 navigate to the relational database 50 directly from a selection on a home page menu selection. Once there, and option is presented to search Knowledge-ICB relational database 50 by the entry of a word or subject matter query. An alternate method is to select a grouping of topics 48 by ethical subject area and the system presents the user with an number of topics 48 within that group, and another selection is then made from that list to extract the requested information 49. In both query methods, a narrative is presented to the user 18 that contains information of the topic 48. Within the narrative are hyperlinks to related topics 49 pertaining to the subject area.

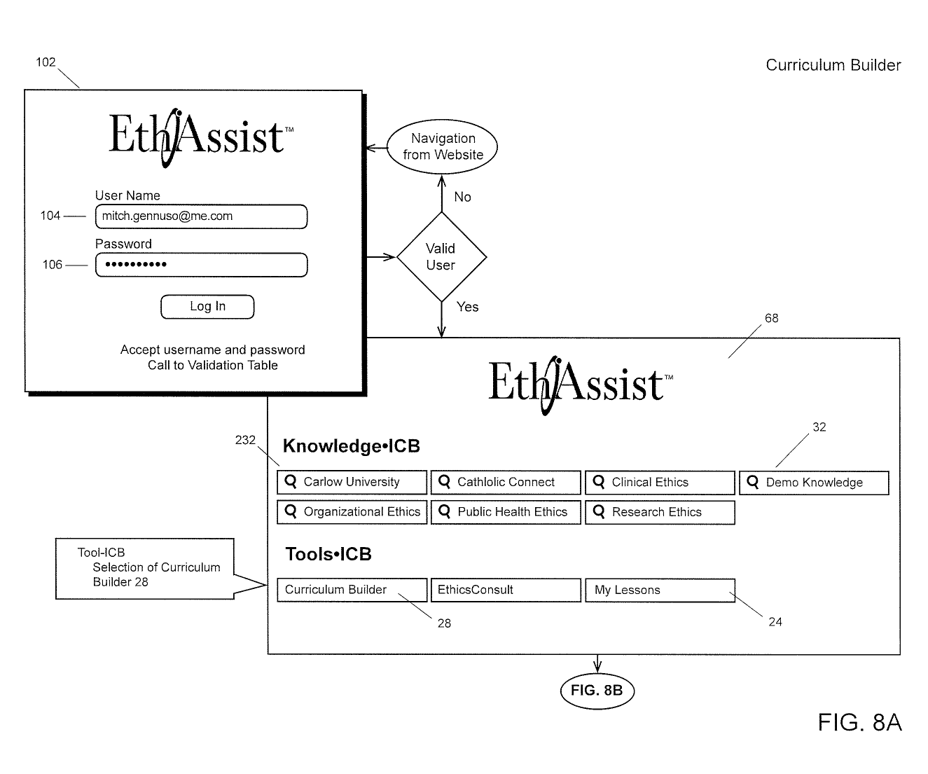

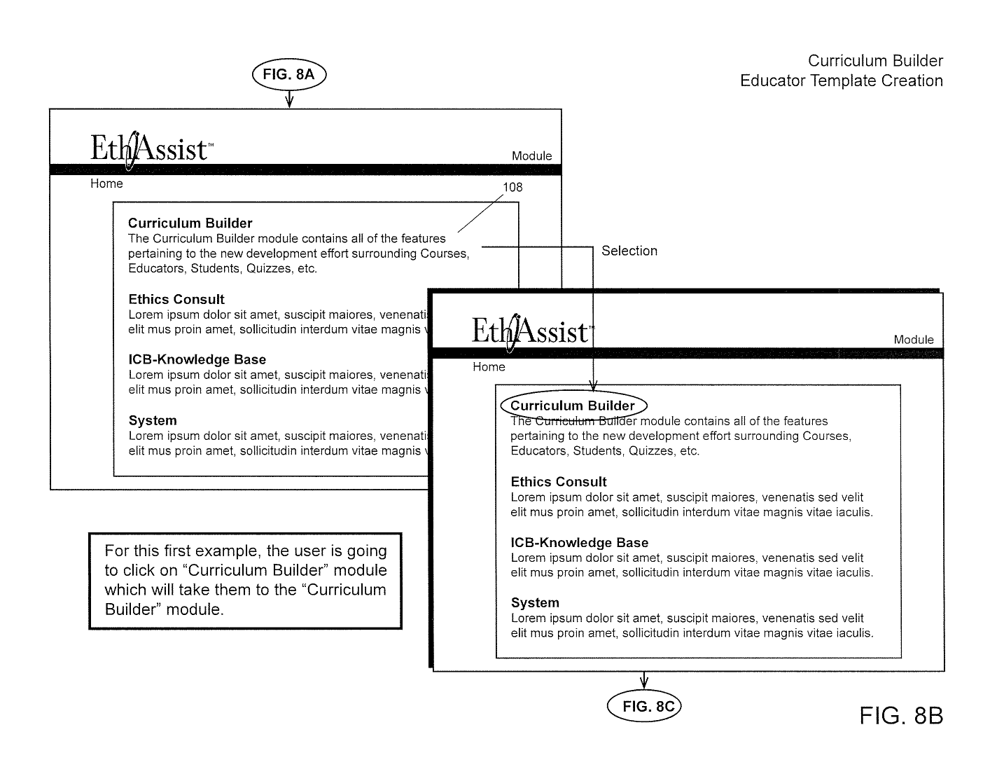

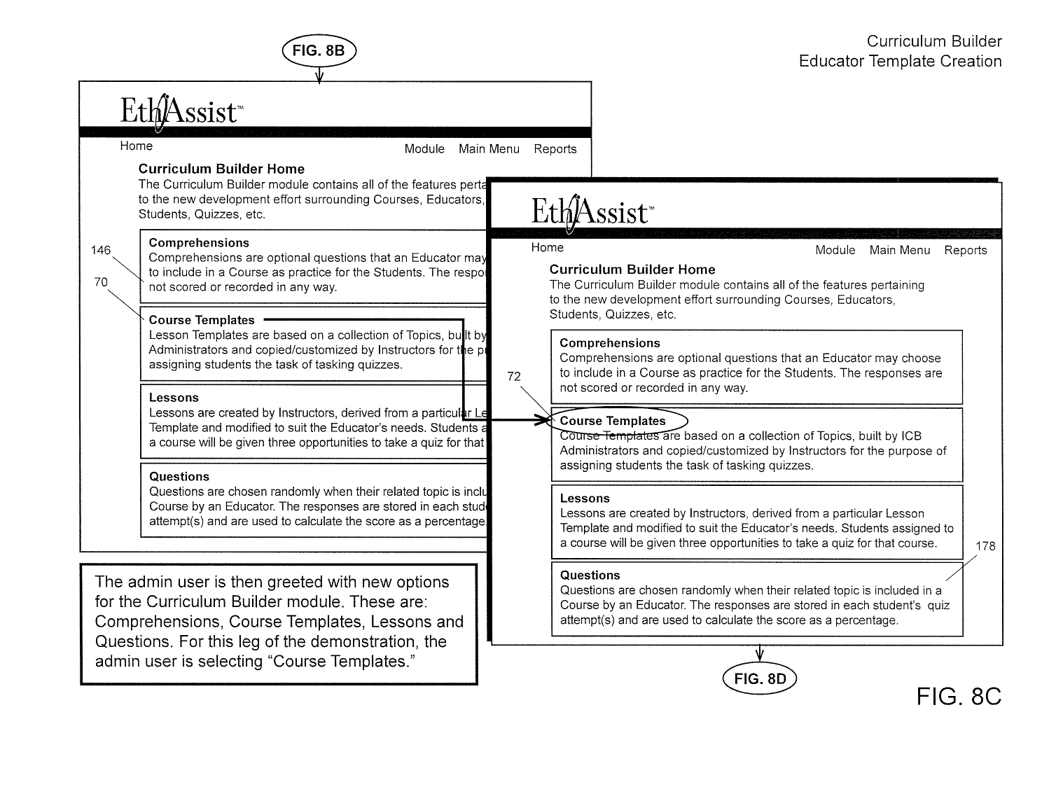

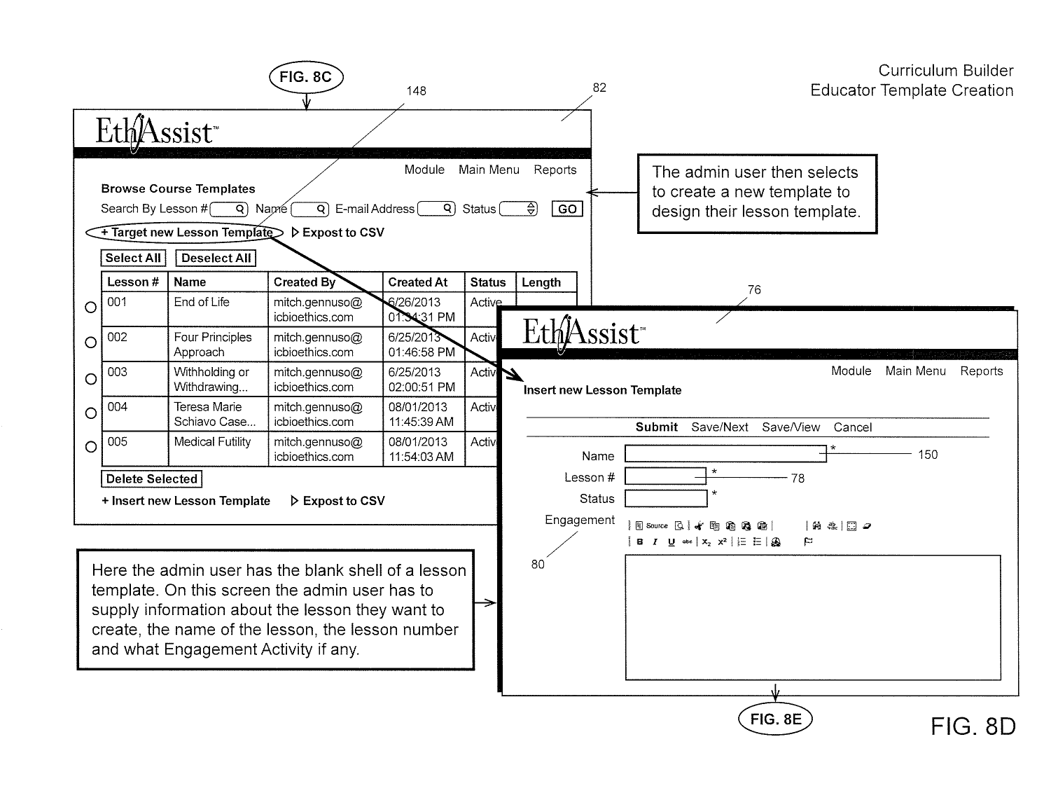

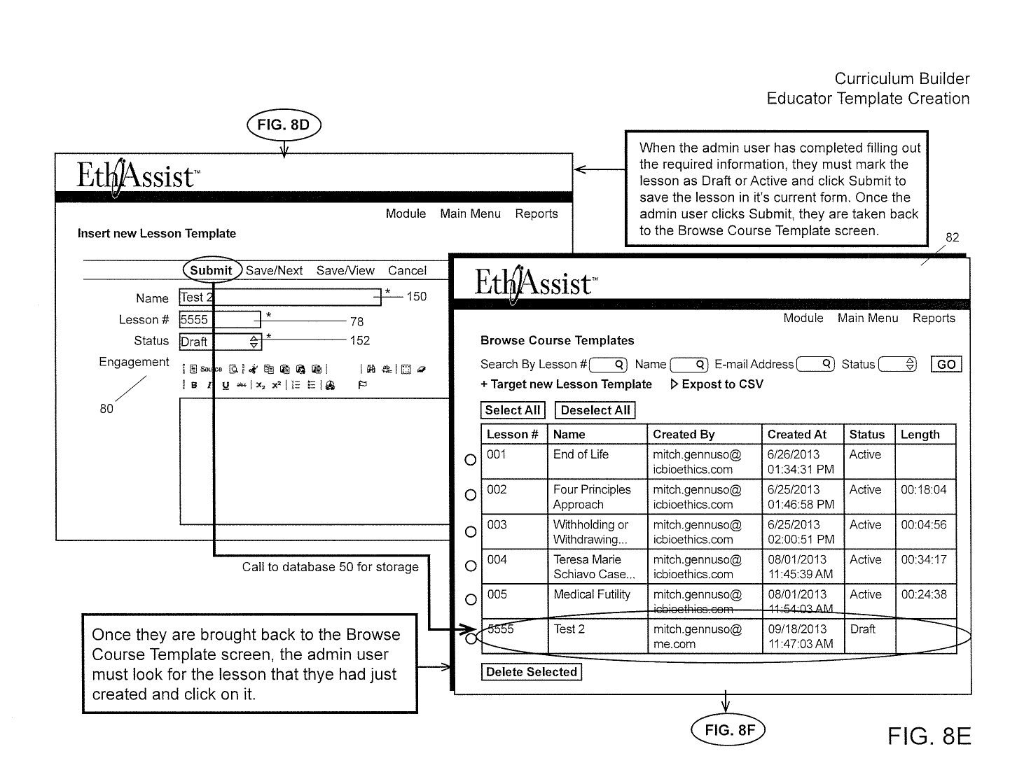

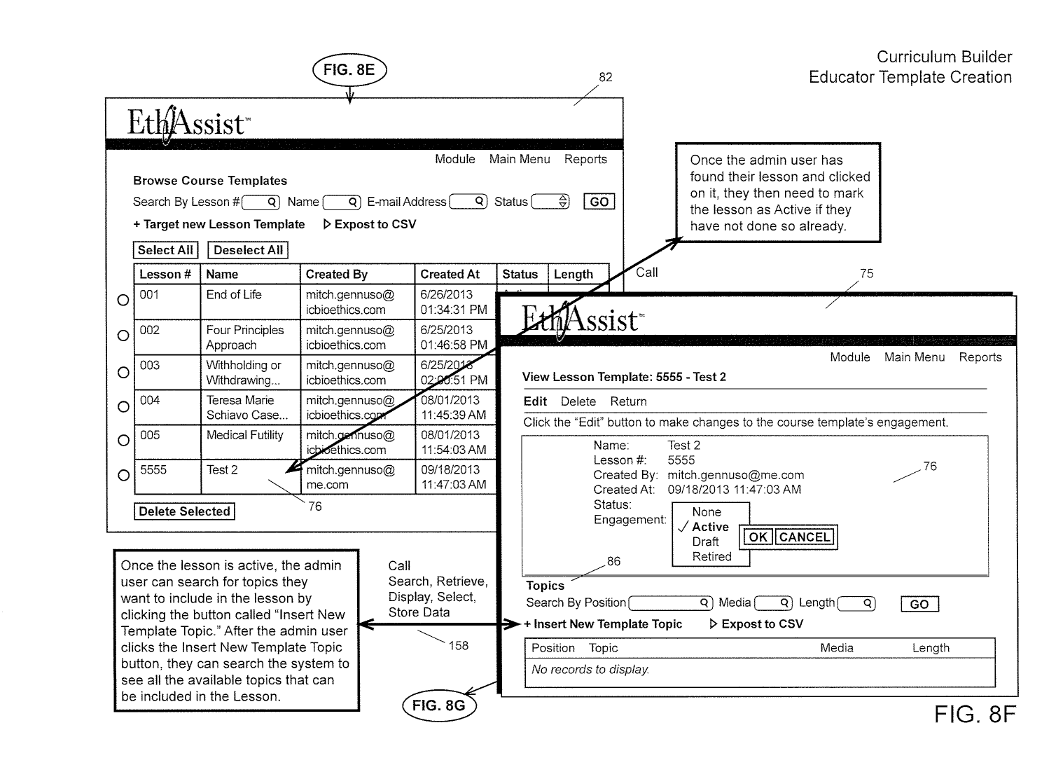

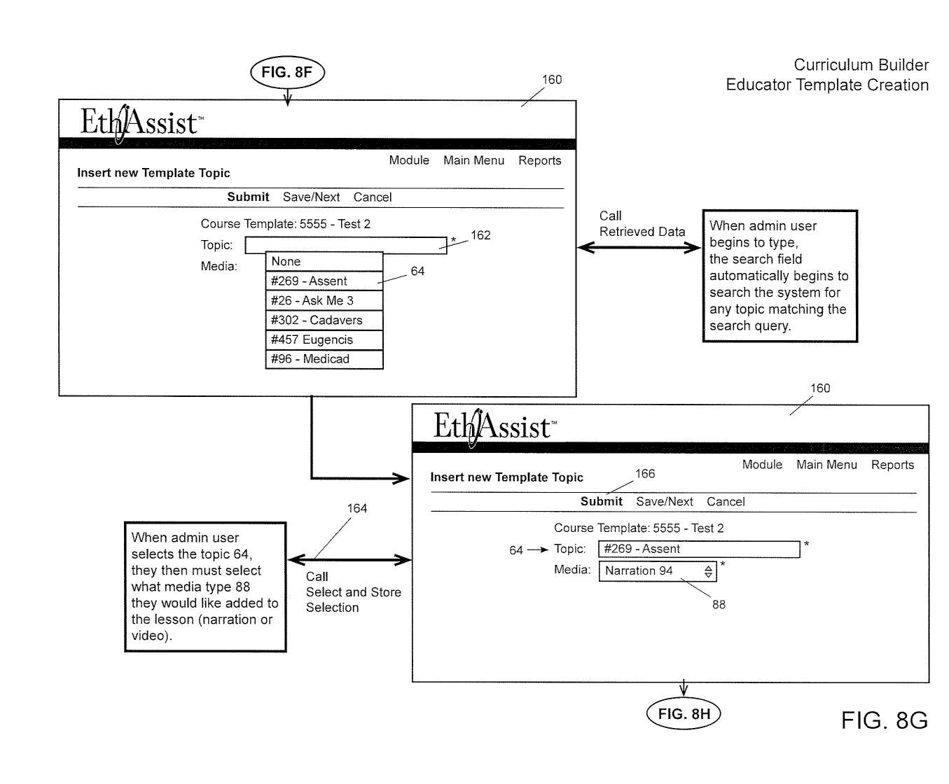

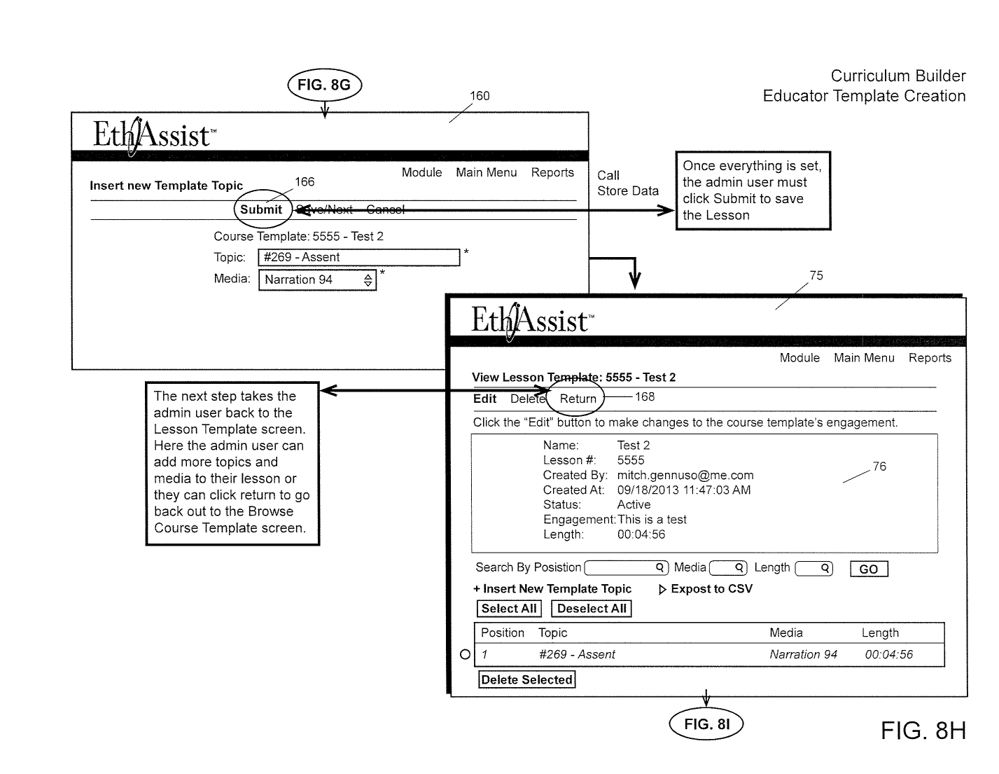

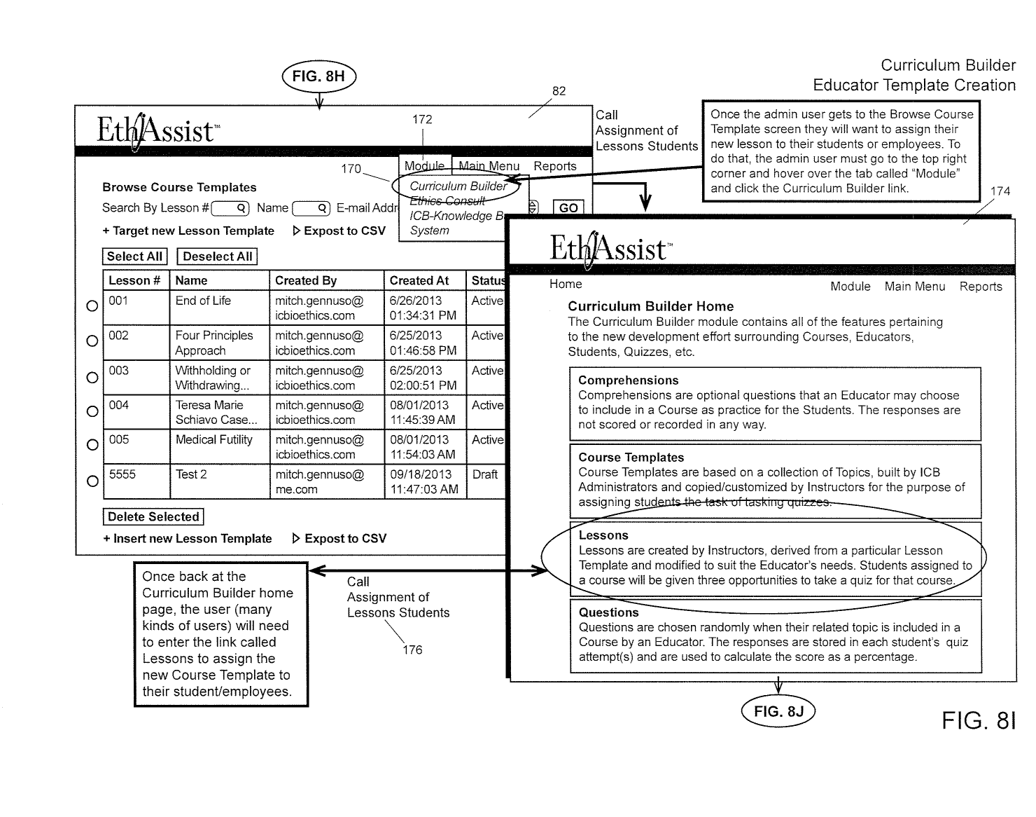

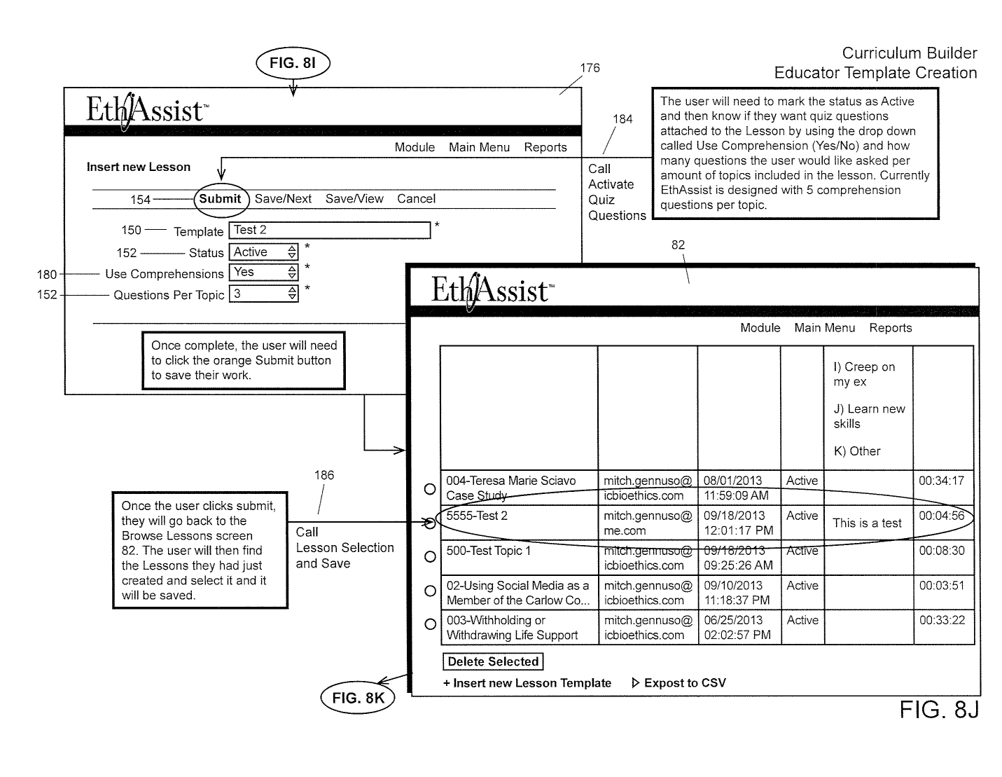

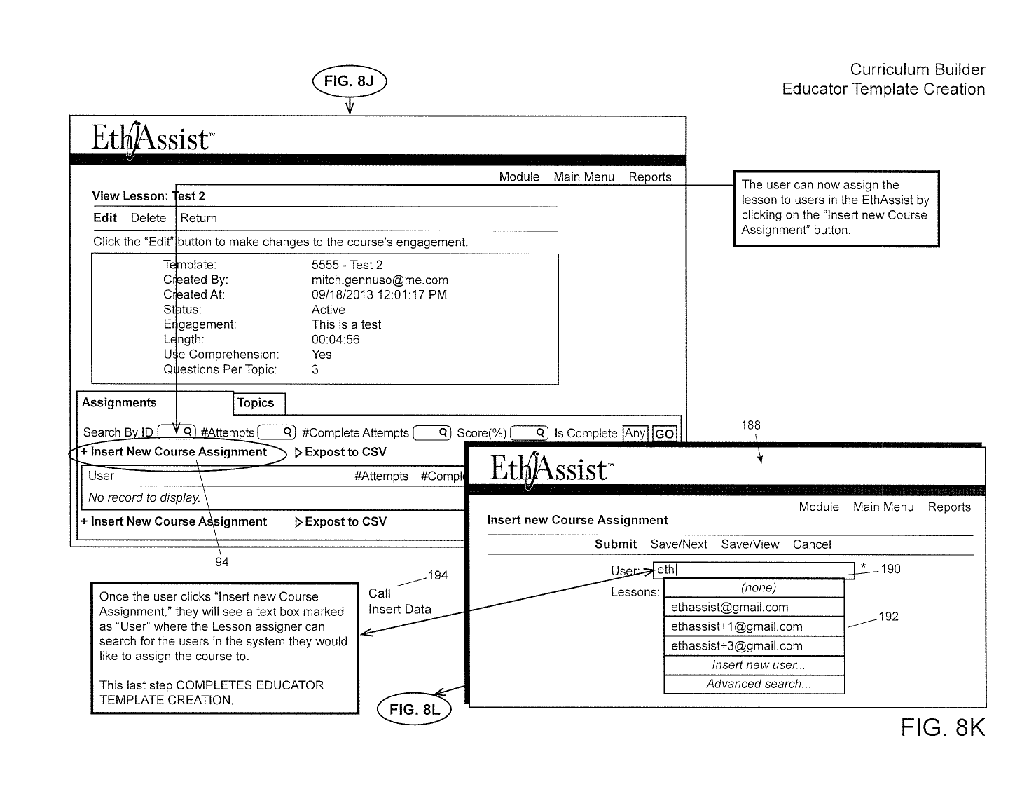

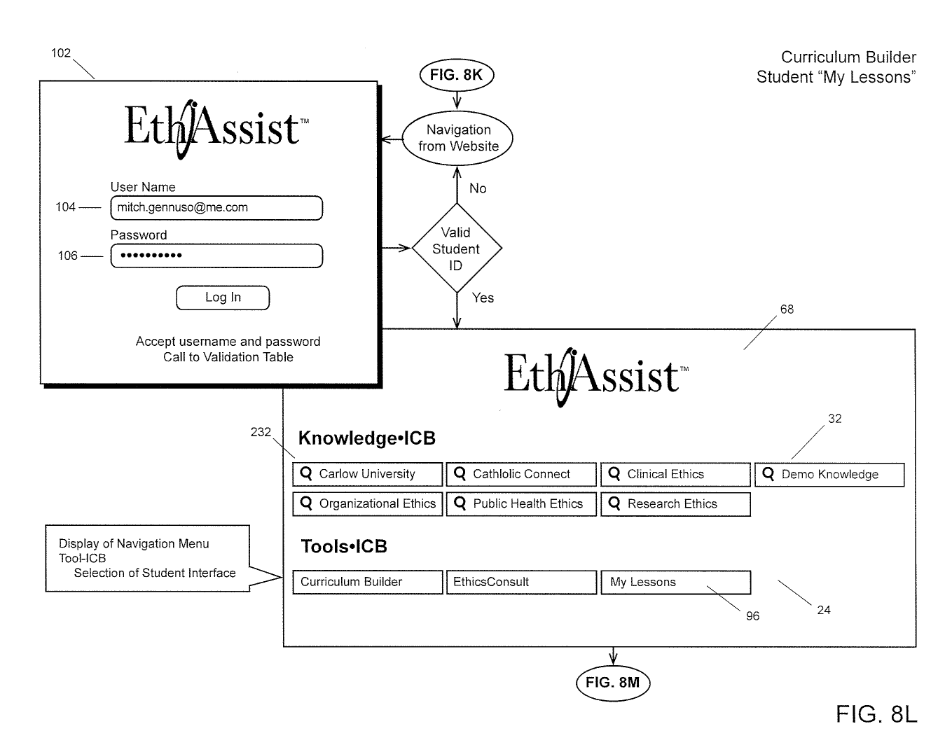

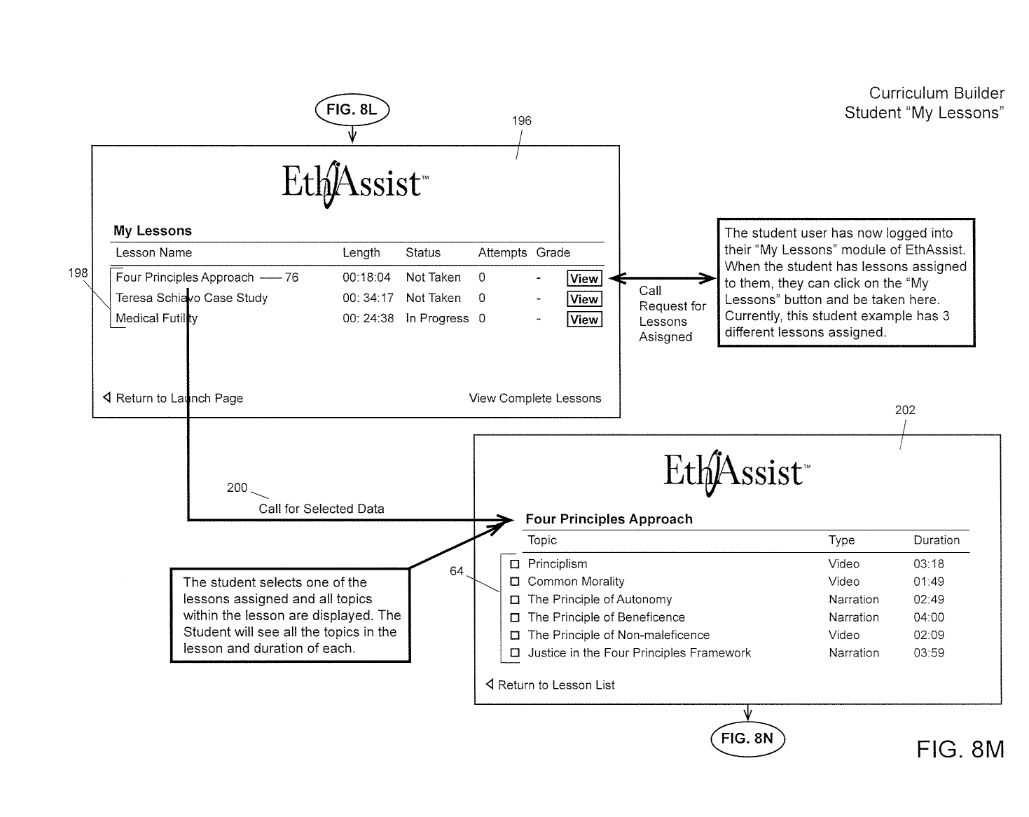

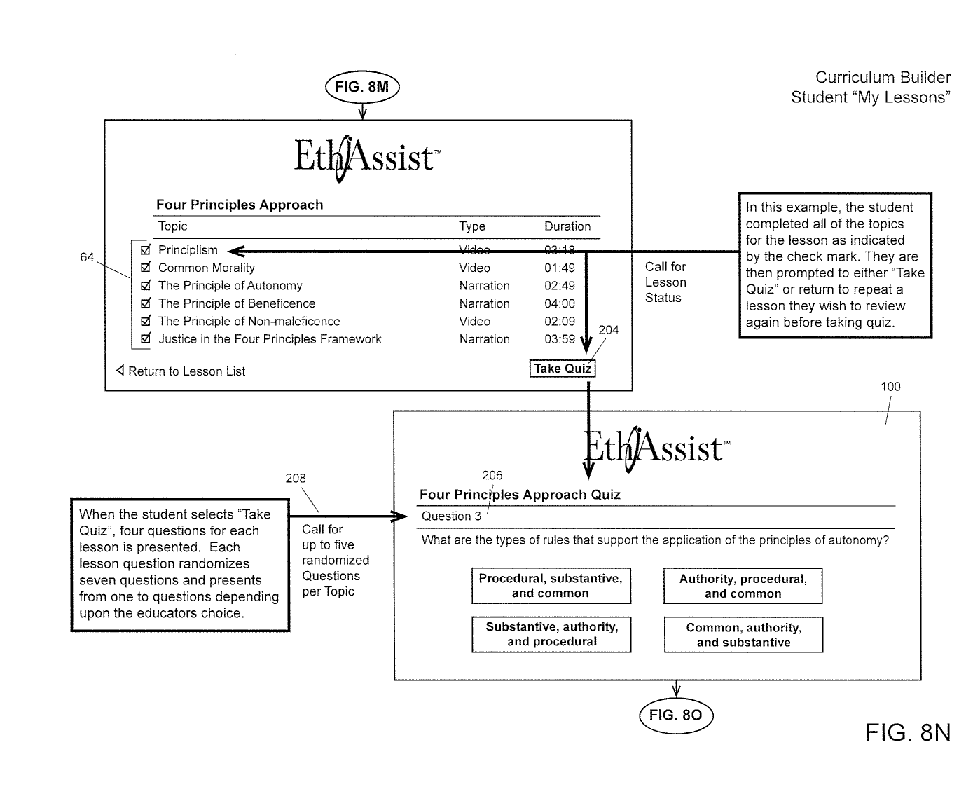

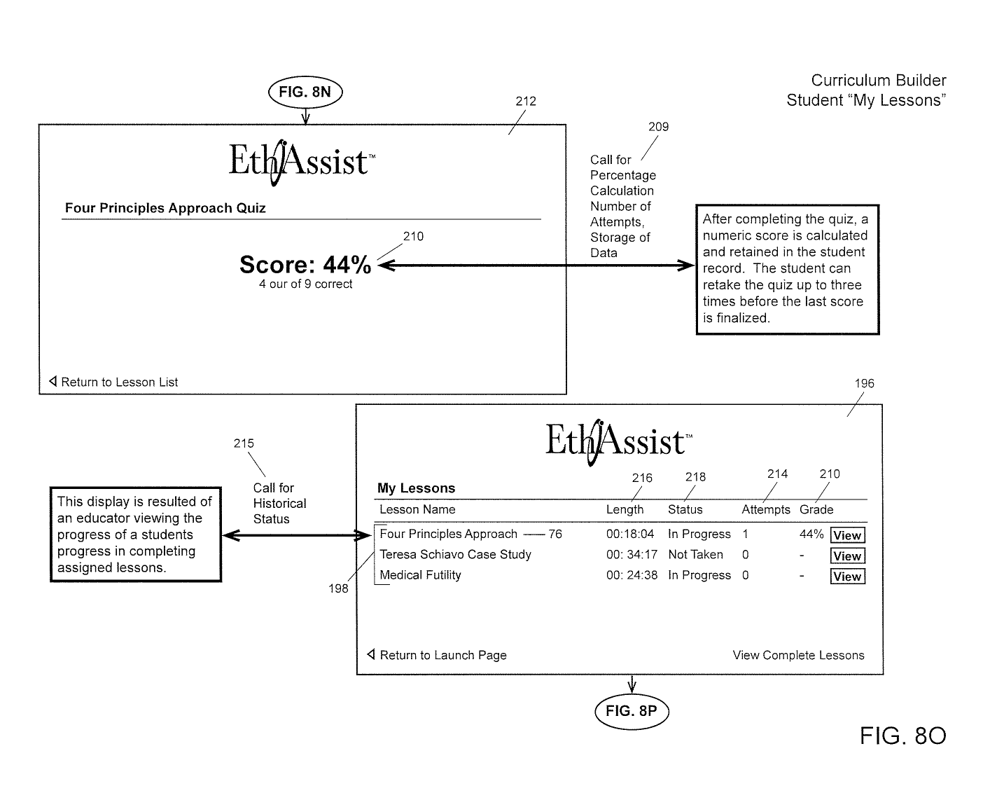

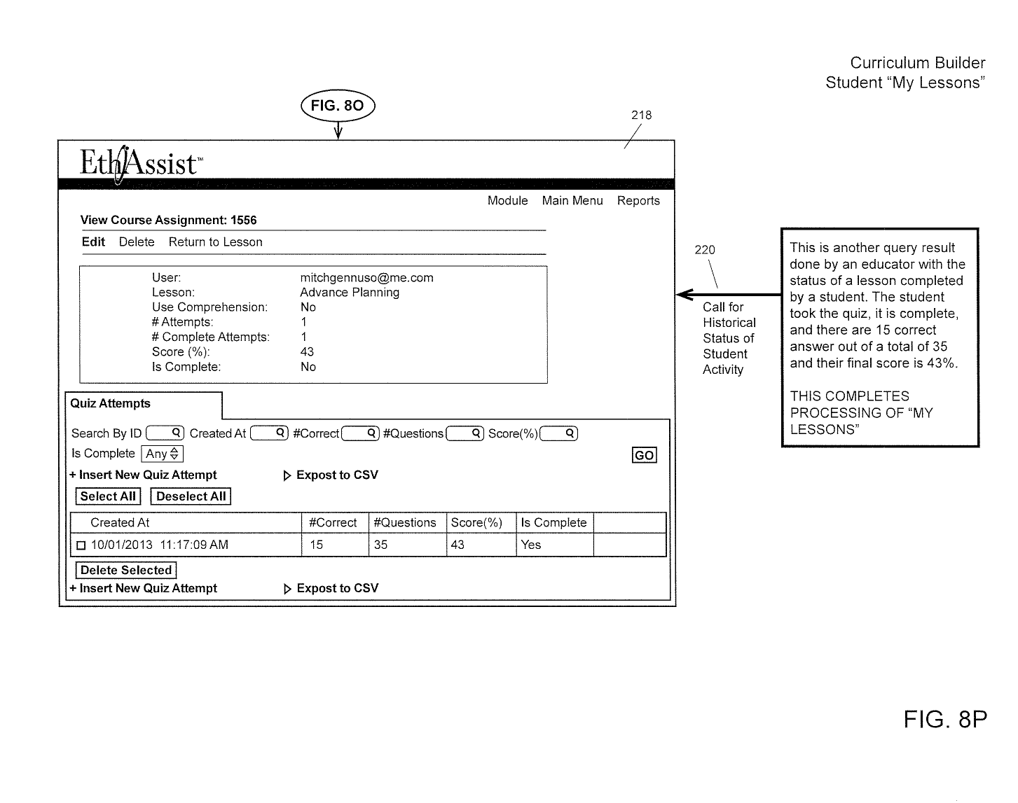

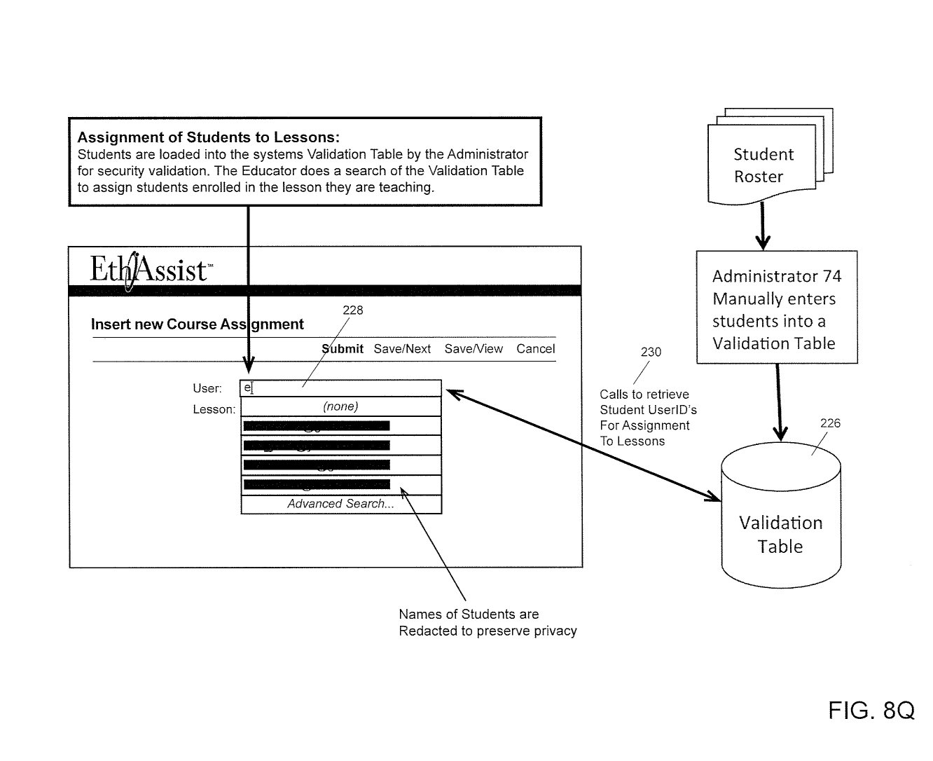

Knowledge-ICB 22 is also built to send and receive queries from Tools-ICB. In these instances information on a topic 48 is sent to any of the three modules in Tools-ICB. EthicsConsult 26 and IRBQA 30 receive topical narratives to be used for reference or as assistance in a required activity. Queries for information are also sent to Knowledge-ICB 22 received from Curriculum Builder 28 where subject matter training material is available from predefined curriculums or sent to the user 18 to construct customized courses. Requests for video extracts or voice over narrations are sent to a multimedia database noted in FIG. 8M and used in classroom or individual training sessions when they occur.

The key data elements of Knowledge-ICB 22 are as follow:

1. Topic Number

2. Topic Grouping

3. Topic Title and Description

4. Topic Narrative

5. Narrative Citations

6. RLO Number

7. RLO Name

8. RLO Duration

9. RLO Out-Line and Scripts

10. RLO Video Number

11. RLO Voice Over Narration Number

12. RLO Assessment Questions

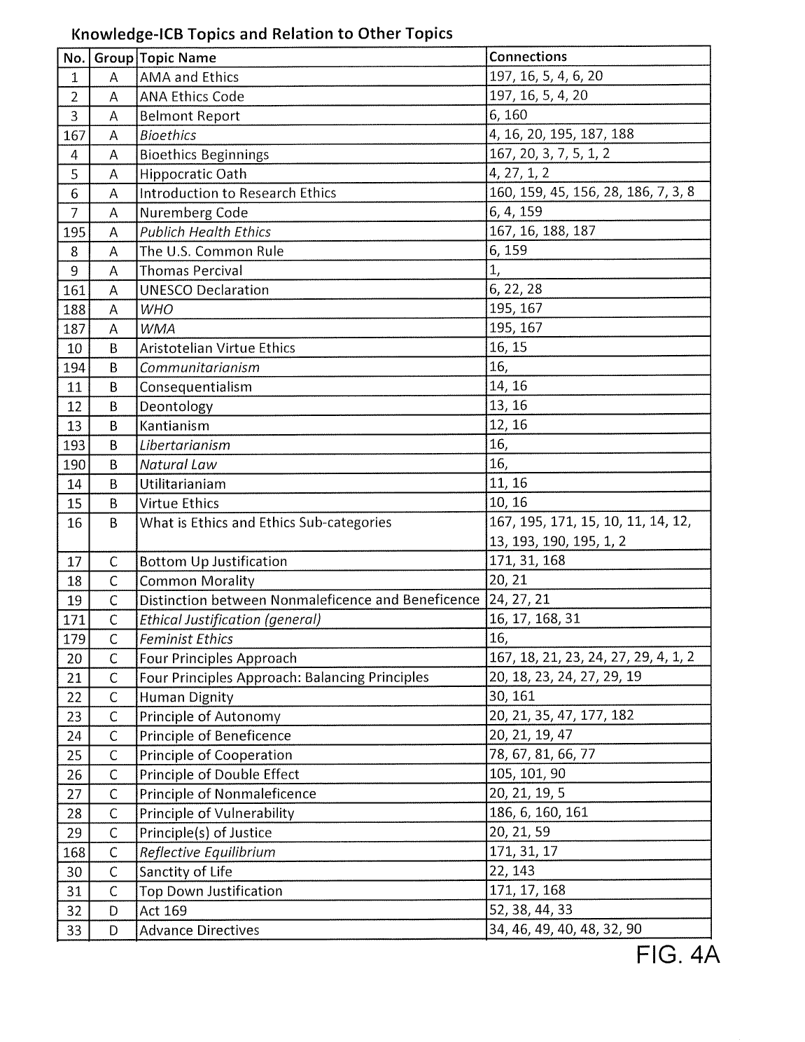

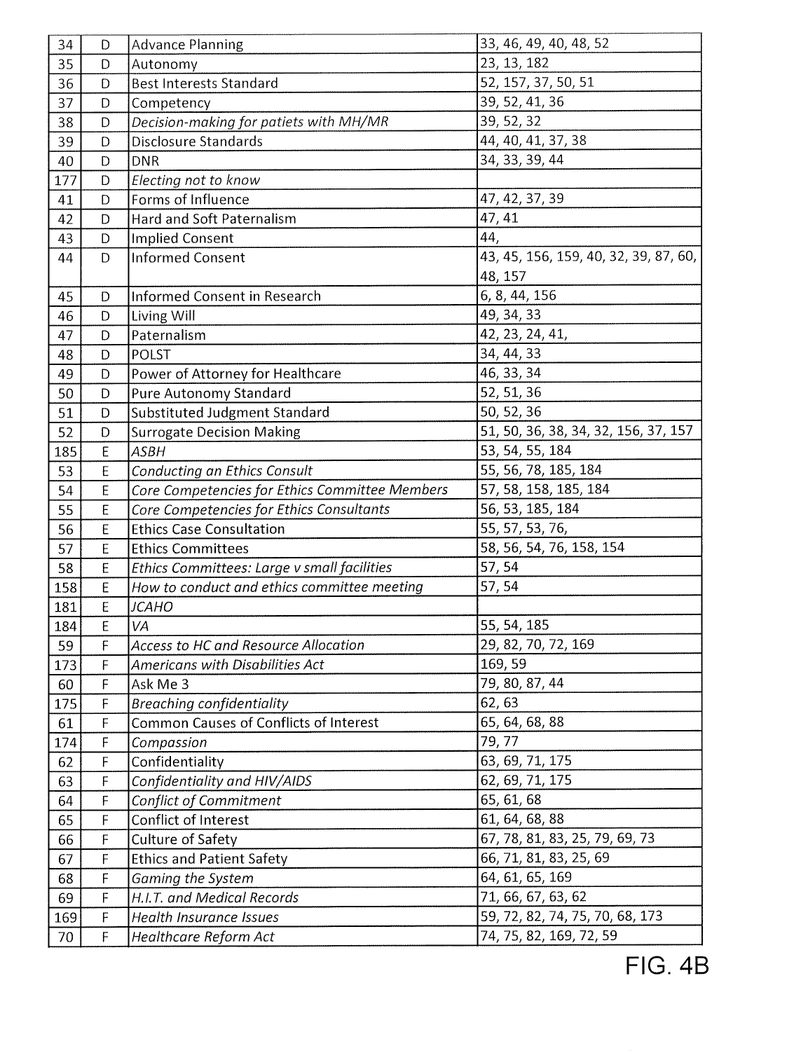

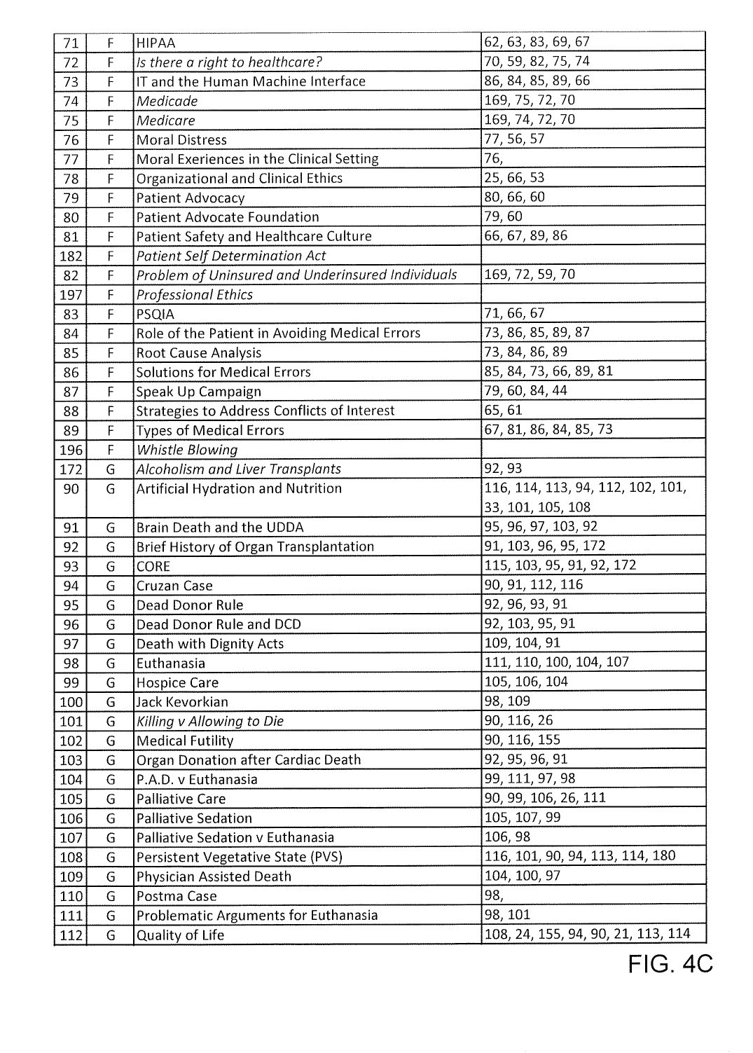

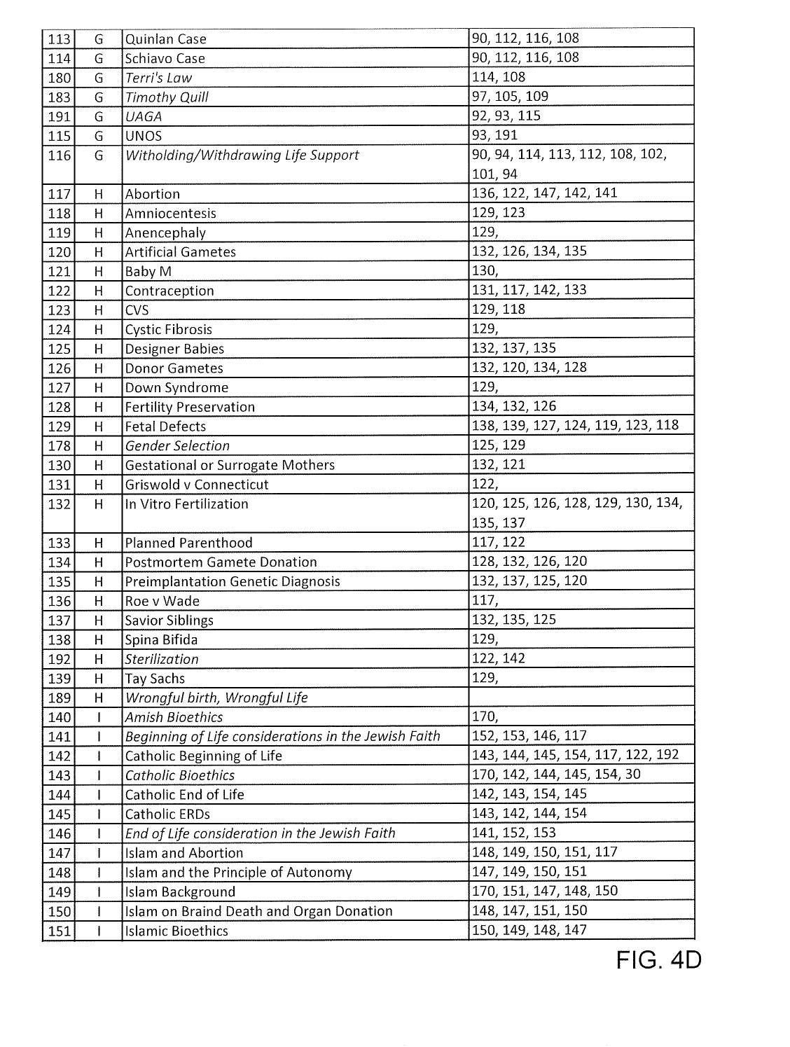

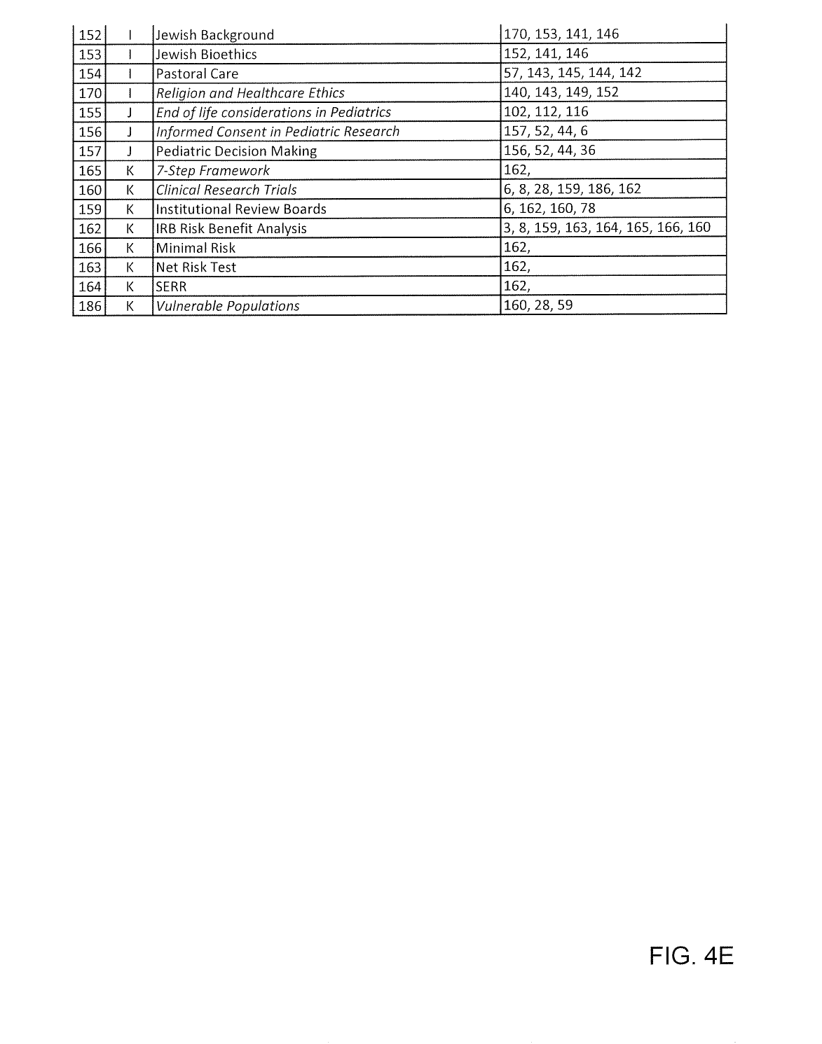

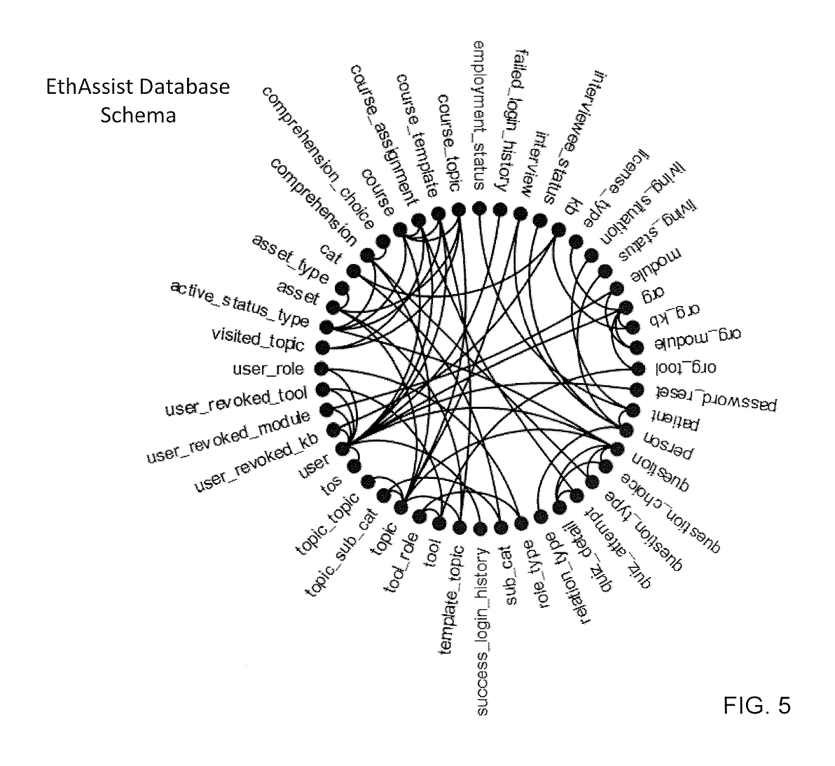

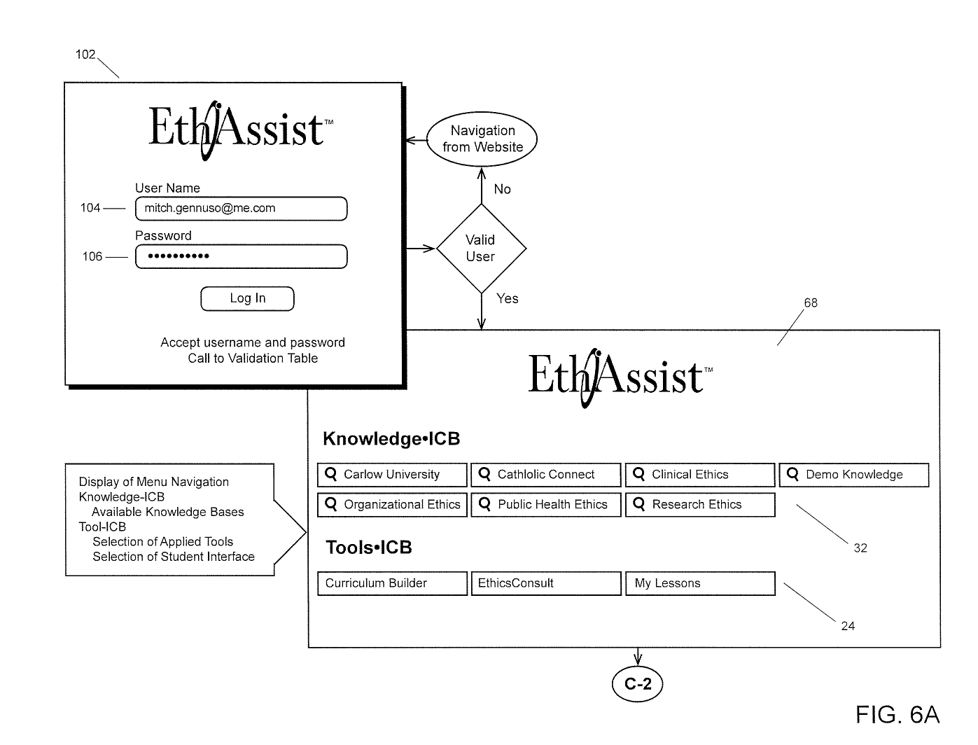

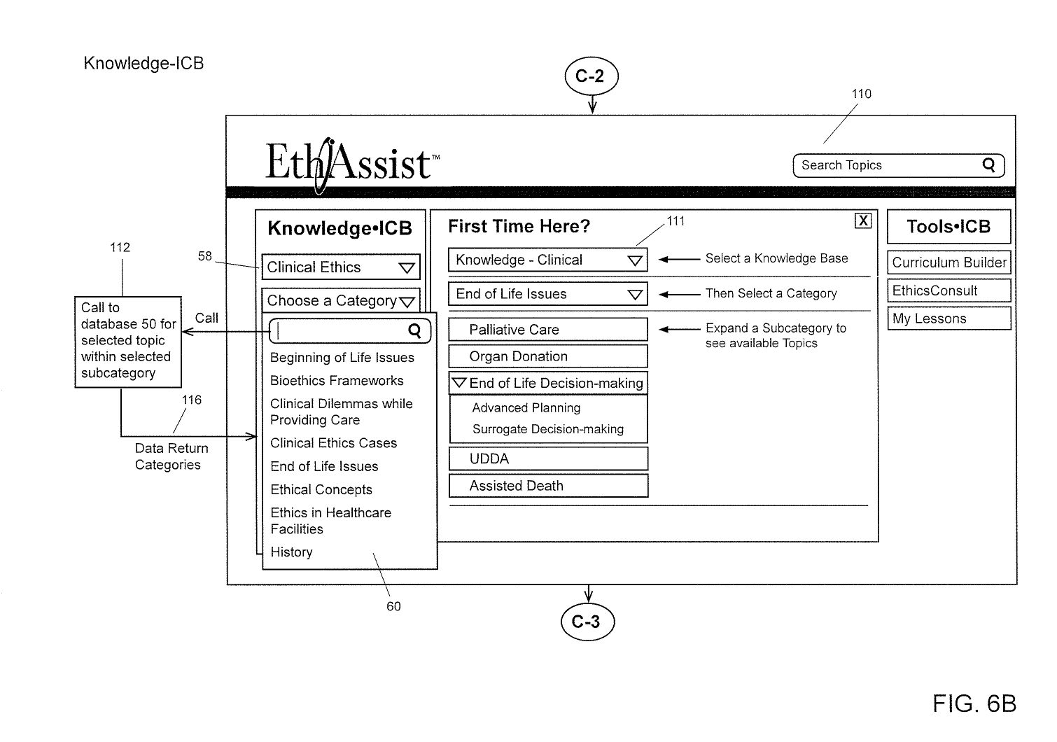

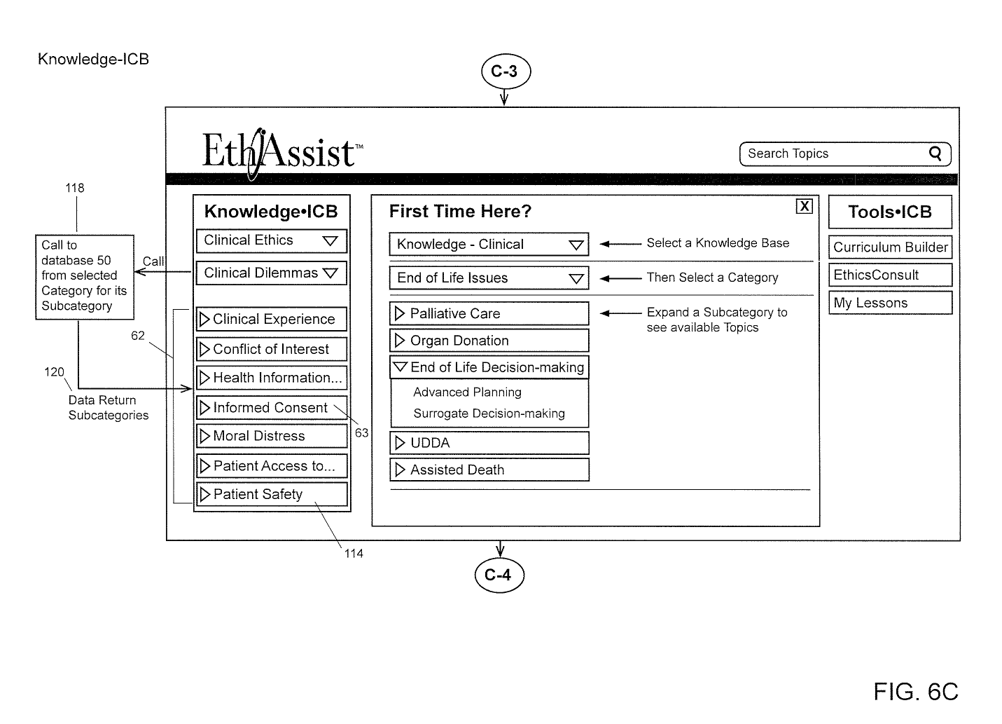

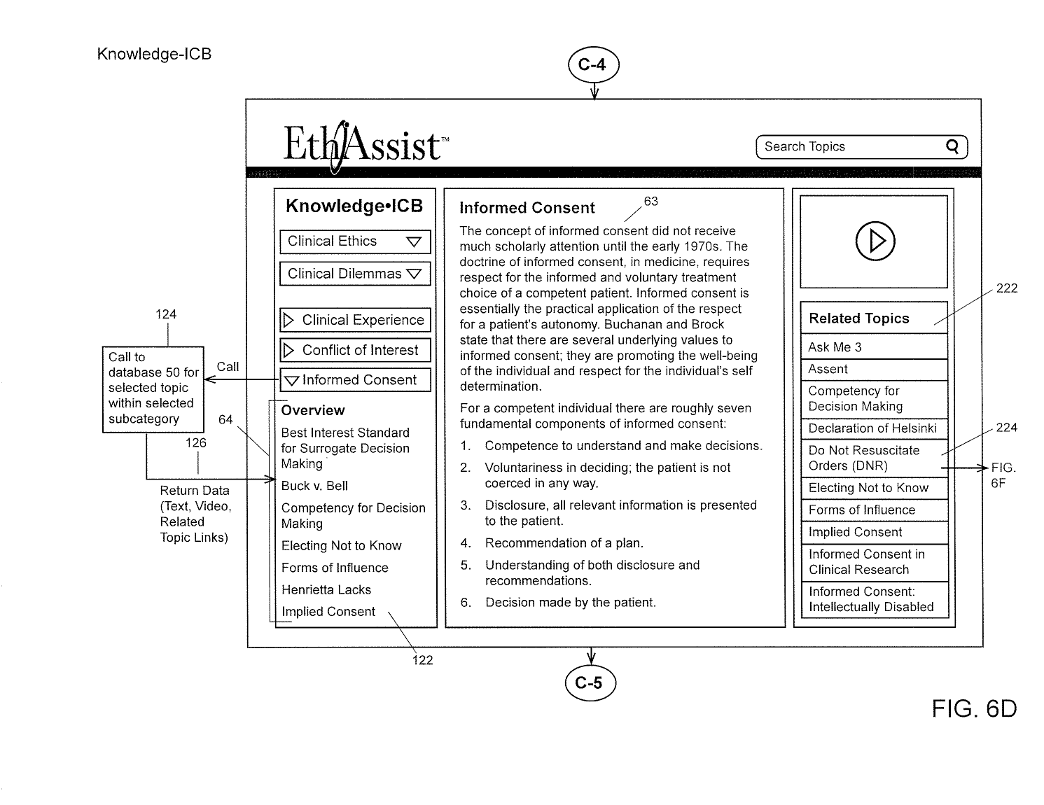

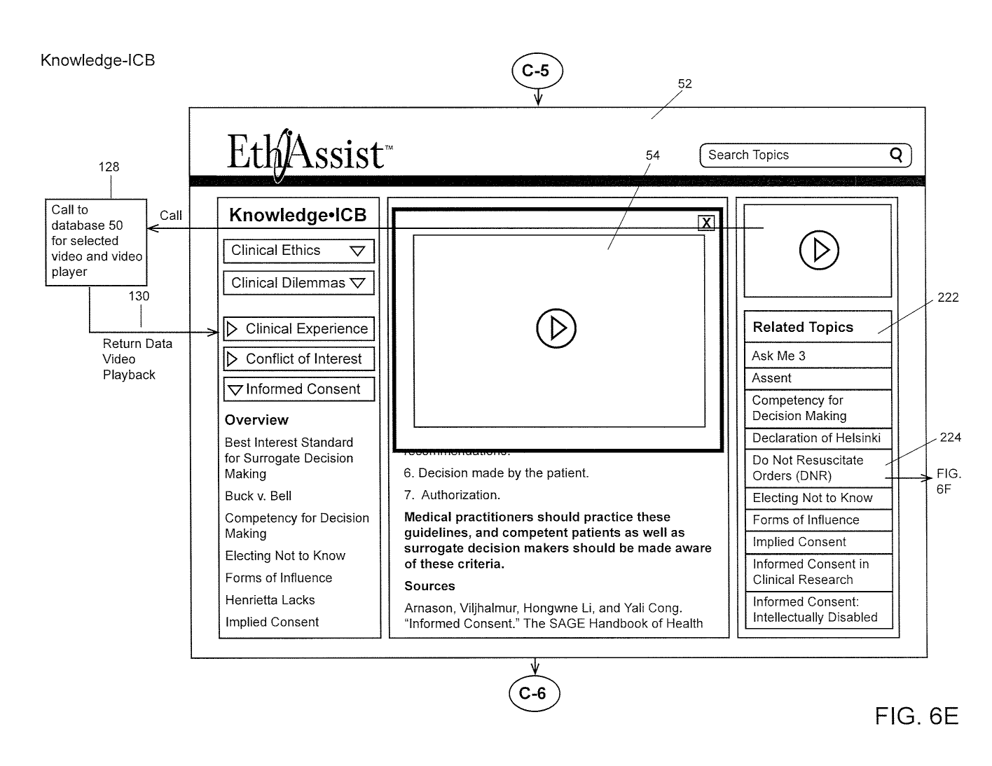

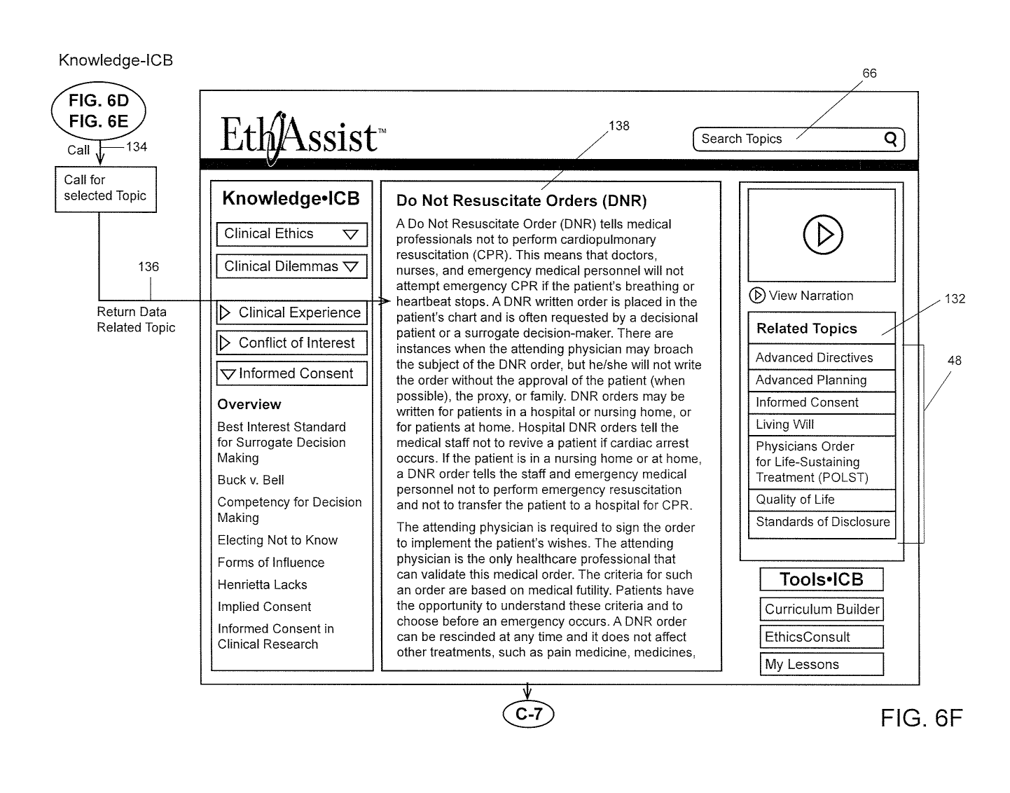

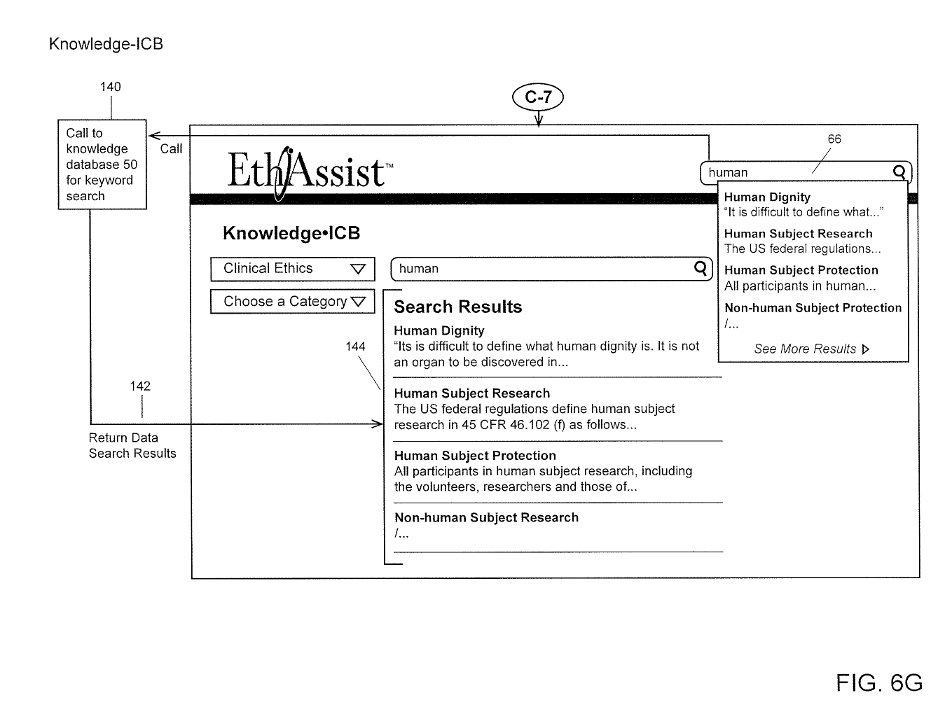

See FIGS. 4A-4E for an exemplary database schema and FIG. 5 for an exemplary database structure of present invention 10. Further, FIGS. 6A-6G are examples of screen shots including navigation and date flow with the notation “Call” for input and output movement of information to Knowledge-ICB's database 50.

Now turning to FIGS. 6A-6G. This is a description of the users interaction of Knowledge-ICB 22. Depicted in FIG. 6A, a user 18 is first presented with a secure login screen 102 where a user id 104 and password 106 is required for entry into the system 10. The user 18 information is setup prior to the user 18 attempting to login by a system administrator. There is a reset password process a user 18 can follow should they forget their password. Once into Knowledge-ICB 22, a menu 68 of navigation options is presented. The menu 68 allows the user 18 to select a database 50 by Industry Segment 32 or select an applied tool from Tools-ICB 24. For this example, the user 18, selects the Clinical Ethics 56 in database 50.

On FIG. 6B, the user 18 is presented with a screen 110 that provides instructions about the structure 111 of the database 50 and a drop down box 58 of Categories 60 to choose from. Once a Category 60 is selected, a call 112 is initiated to the database 50 to retrieve the desired information 116. At this point the system 10 presents another dropdown box 114 to the user 18 with a list of sub-categories 62 to choose from as depicted of FIG. 6C. Once a sub-category 63 is selected (e.g., Informed Consent), another call 118 is initiated to the database 50 to retrieve the information 120 requested as depicted in drop down box 122 in FIG. 6D, where the user 18 is presented with topics 64 (e.g., topics for Informed Consent). The user 18 next selects to desired topic 64 and yet another call 124 is initiated to the database 50 to retrieve the information 126. At this point, the topic 64 information is presented in the form of an RLO 52 that has the topic 64 content (e.g., Informed Consent) as shown in FIG. 6E. The topic 64 content describes the clinical ethics 56 subject, addressing ethics issues, religious and cultural considerations and any legal concerns. Additionally as shown on FIG. 6E, the user 18 has the option to view a video 54 that has more information about the topic 64. If the user 18 selects the video 54, a video call 128 is initiated to the database 50 to retrieve 130 the video 54.

A listing 222 of Related Topics 224 (e.g., Do Not Resuscitate Orders) of the selected sub-category 63 (e.g., Informed Consent) can be displayed as shown in FIG. 6F if user 18 desires more information. User 18 selects related topic 224 (FIG. 6D, 6E) to send a call 134 to database 50 to return content 138 (FIG. 6F) of related topic 224.

Also as depicted on FIG. 6F, a dropdown box 132 is presented with a list of related topics 48 that the user 18 can request from the system 10 if further information is required on the selected topic content 138.

Now turning to FIG. 6G, users 18 of Knowledge-ICB 22 also have the ability to go directly to a topic 64 by using the systems 10 keyword search 66 capability. A keyword search call 140 is sent to database 50 to search stored topics 64 containing the search criteria (e.g., human) that are retrieved 142 from the system 10 and displayed 144 to the user 18. So they can review and select the desired topic 64.

Tools-ICB 24 (Formally Reliance-ICB)

Tool-ICB module 24 is the applied ethics component of EthAssist 10. As mentioned above, Tools-ICB 24 has three separate and distinct software modules that work independently from one another which send and retrieved information from Knowledge-ICB 22.

The EthicsConsult module 26 is an automated methodology to guide patient interviews to ensure all information pertaining to demographic, family relationships, patient condition, and ethical situation is collected and reported consistently. It is built upon a foundation of best-of-breed healthcare ethics procedures and practices. It includes sequenced, connected steps supplied by information from Knowledge-ICB 22 with well-defined inputs and outputs that can interface to any hospital administration system.

The following are examples of the instructions for medical staff conducting clinical interview using EthicsConsult module 26. These examples of questions are not intended to limit the invention. There are information points during the interview that will require information to be retrieved from Knowledge-ICB 22 via calls for data link 40 (FIG. 2A). A case, in most instances, will require interviews of several people, family members, decision makers, medical staff and so on. No actual names are recorded but are codified so as to avoid meaningful use issues. The interview data for each case must be maintained until the interviewer feels that all necessary people are interviewed. Once the interview is complete, the interviewer can either print a summary report; send an electronic version to the hospital admiration system, or both. Once that occurs, all interview data regarding the case is removed from the system 10.

FIGS. 7A-7F are exemplary questions (also listed below) that can be asked during an interview and match the prototype functionally:

1. Case ID number—Computer generated

2. CLINICIAN: Who is being interviewed: Patient, family, decision maker Pull down menu for those three choices.

CLINICIAN: At this point the interview begins. You can introduce the start of the interview as you feel is best. Some suggestions include, “I am going to a few questions now to get a little background information.” Then proceed to gather, in your own language, medical and social history as well as where the patient resides. Also,

3. Patient's medical history: CLINICIAN This includes the following information: Current problem, brief past history, any relevant information pertaining to current admit to hospital text box to enter

4. Patient's social History: text box to enter

5. Where is patient/you from (city)? text box to enter

6. Is anyone here with you?

7. With whom does/do patient/you live? (pull down menu: alone, family, nursing home, other)

a—Family—How are they related to patient/you? text box to enter

b—If nursing home—In which facility does patient/you reside? text box to enter

c—Alone

8. Is the patient is a relationship? If so, with whom? Text box to enter

9. Are you/Is the patient working, retired? text box to enter

10. Any additional information pertaining to social history?

11. CLINICIAN, now you will gather information on patient medical history. You may prompt with a question such as, “Now I am going to ask a few questions about your medical history.”

12. Current Medical Problems.

13. Brief past medical history:

a. clinical probes;

b. diagnosis(es);

c. chronic illness;

d. medications;

e. surgeries; and

f. other data.

14. Any relevant information pertaining to current admittance to hospital.

15. CLINICIAN, now you will gather information on family medical history. You may prompt with a question such as, “Now I am going to ask a few questions about your family's medical history.” Patients who have non-biologically related siblings or parents may state this at this point, however there is no need to specifically ask if this person is a blood relative. You may state this in the notes.

16. Patient Family History

17. Is the patient's parent's living? Yes, age and significant medical issues. No, age and cause of death.

18. How many brothers/sisters do you/does the patient have? Pull down for number of siblings' numbers: 0-10. If 0 siblings, SKIP 18

a. Are any siblings deceased?
If Yes, (any are deceased): What did your/the patient's sibling die from?
No, age and any significant medical issues.

Additional notes: (text box)

19. Does the patient have any children? Pull down for number of children numbers: 0-10. If 0 children, SKIP 19

a. Are any children adults?
If Yes, how many are adults?

20. Any additional family medical history that is important? (text box)

21. Additional Information

22. Main menu

To begin select the main topic which the consultation may utilize: (pull down)

1. Informed consent

2. Decision making capacity

3. Surrogate Decision-making

4. Treatment and goal planning

23. Main menu 1. Informed Consent

Information regarding topic is extracted from Knowledge-ICB 22.

24. See FIG. 7B for recital of step.

25. Has the patient been given all of the information regarding his or her medical procedures and firmly understands all of the associated risks and benefits to the procedure?

The questions below should be specific to how patient answered question 25. If 25 is a NO, go to 26. If 25 is a YES, got to 29.

26. What is the barrier to understanding the consent process?

CLINICIAN PROBES (pull down)

Is it patient centered?
Was enough information given to the patient?
What aspect is not clearly understood?
If there family conflict?
Is the patient expressing fear or anxiety?
Is there a language barrier?
Is there cultural barrier?
Is patient able to read?
Is the patient overwhelmed, cannot decide and needs more time than given to decide?

28. Is it medical staff centered?
Was information provided in technical terminology or not easily understood language to the patient?
Was the information provided too quickly by physician?
Have all of the patient's questions have been answered?

(text field to enter reason why, include this note: Clinician: please ever why you feel that patient understanding is compromised. If needed, use probes for guidance.)

29. Is the patient decisionally capable of making these decisions? Question 25 must be considered along with Questions 29. Rules: Both questions get asked. If yes to 29 and 25, STOP SECTION 1. To indicate section ends insert a prompt stating: This patient is capable of making his or her own medical decisions.

If no to either or both question 29 or question 25, continue with subsequent follow-up questions. One no to either question, 29 or 25 warrants continuing as one NO to 29 or 29 is a sub-threshold criteria.

30. If No to 25. Why is the patient not decisionally capable of giving informed consent?

31. CLINICIAN: If at this time, the barrier to informed consent in relation to understanding is able to be resolved and the patient has decision making capacity. This patient can now give informed consent.

32. Can this be resolved?

a. Yes:

i. YES to 25 and NO to 20, continue to box 33;

ii. NO to 25 and YES to 29, resolve issue;

iii. NO to 25 and NO to 29, continue to box 33.

b. NO, continue to box 33.

33. CLINICIAN: Addressing each barrier to understanding requires clinical judgment and to determine interviewer should engage the patient in conversation to gather this information. This would be a good breaking point to do so. Clinicians should look for signs of confusion or incoherence from the patient, as well as opinion of the patient's family to determine if the patient is not himself or herself when trying to determine signs that capacity may be lacking.

Main menu 2 Decision capacity:

35. To have mental capacity is the possess the ability to hear and comprehend information, appreciate all of the consequences of a medical procedure, communicate a choice, and deliberate ones' values in decisions between the patient and the doctor. Capacity may be compromised by a number of factors. Capacity must be present in order to give informed consent to any medical procedures. Jonsen, 65.

36. Is there a specific indication that patient may not have decisional capacity? CLINICIAN PROBES(pull down)

Is the patient experiencing a great deal of anxiety?

Is the patient in a great deal of pain?

Is the patient very afraid?

Is the patient's illness rendering him/her obviously unable to communicate? (for example, unconscious, comatose, delirium)

Has there been a change in mental status*?

Are the medications being used in treatment affecting capacity?

Has the patient always lacked capacity? (for example, profound mental retardation)

Is the patient unwilling or refusing treatments, if so, why?

37. *Note to clinicians for psychiatric patients: If patient has a psychiatric diagnosis this does not mean the patient is unable to make his or her own medical decisions, however is does make determining capacity more difficult. Having a mental illness does not make on decisionally incapable, however, the illness may at the time inhibit the patient from understanding in a particular situation. Altering medications or psychiatric interventions can help one regain capacity but delusions, for example, may not be able to be remedied. Consult with psychiatry for patients with MH diagnosis.ⁱ (text field to enter reason why, include this note: Clinician: please ever why you feel that patient decision making capacity is compromised. If needed, use probes for guidance)

38. Capacity assessments should be conducted by your specific hospital department (psychiatry, neuropysch, etc.). However due to your recommendation this may help to determine if such an assessment should be conducted. If you recommend there be an official capacity assessment, please contact the appropriate contact within your facility.

39. CLINICIAN: Is the barrier or hindrance to decision making capacity able to be overcome?

Yes (if yes AND no to question A, stop here. Include note: CLINICIAN: how will this be overcome?)

No, (if no patient needs a surrogate decision maker to make decisions on his or her behalf) Proceed to surrogate decision maker 40.

40. Main Issue 3. Surrogate decision maker

41. When patients are no longer able to make medical decisions, often times the duty falls upon another who is the patient's surrogate decision maker. A surrogate is an individual who is authorized to make medical decisions on behalf of another. While they are still healthy many will appoint a surrogate decision maker in their advance directive. A surrogate may be appointed under a health care power of attorney and often is in combination with a living will. Surrogates can also be appointed without a health care power of attorney as many states have family consent statutes. A surrogate may be a patient's next of kin such as a husband or wife, child, sibling, or parent as a family member most often serves in the surrogate role.

42. See FIG. 7C for Pennsylvania Act 169 summary.

Information regarding topic is extracted from Knowledge-ICB 22.

43. Does this patient have a surrogate decision maker?

a. If YES, proceed with these questions:

44. Who is the patient's surrogate decision maker? (text field)

45. Is the patient's surrogate decision maker aware of the patient's wishes, please explain? (text field)

a. If YES, then continue to box 46.

b. If NO, then continue to box 46.

46. Does the patient have an advance directive? YES NO pull down

Information regarding topic is extracted from Knowledge-ICB
Is the surrogate familiar with the patient's values enough to gauge what the patient would want? Please explain. (text field (NOTE TO CLINICIAN: probing for additional details and other patient information is acceptable)

47. CLINICIAN: Do you think the surrogate is acting to uphold this patient's autonomy and wishes in a sincere fashion? (text field). If YES, then STOP, you have identified surrogate decision maker. If NO, then proceed to box 48.

48. Is there any next of kin or contact listed in patient's chart or any record from any facility? (pull down. YES NO pull down. If yes (there is a contact found), then go to box 49. CLINICIAN: Contact this person. If no, go to box 53.

Consensus needed for conflict among siblings, see Pennsylvania Act 169 to determine proper order for surrogacy in PA.

Information regarding topic is extracted from Knowledge-ICB

49. Who is this person? (text box)

Upon contact:

50. Are they willing to take on this role and are they reasonably available to do so? (text box)

51. Is the surrogate familiar with the patient's values enough to gauge what the patient would want? (text box)

52. CLINICIAN: Do you think the surrogate is acting to uphold this patient's autonomy and wishes in a sincere fashion? (text box)

53. No next of kin or contacts can be found: INCLUDE THIS TEXT If all avenues are exhausted to locate a potential surrogate decision maker. Options include: 1. If applicable, a private investigator to locate a potential surrogate. 2. A legal guardian can be appointed by a court for this patient. 3. For cases that are critical, the ethics committee can be involved and uphold beneficence and nonmaleficence as long as any conflict of interests are not a factor, for cases which are outside consultants should be contacted.ⁱⁱ (text box for notes here)

Main Issue 4: Treatment and Goal Planning

55. Text: Often consultations are for treatment and goal planning for patients and families. These may help guide a patient in determining their wishes in regard to a variety of treatments for many different conditions. However, many times this is something utilized for end of life care. For either case, it is a good time to introduce an advance directive to a patient and/or his or her family.

Information regarding topic is extracted from Knowledge-ICB

56. See FIG. 7D for a definition of an Advance Directive.

57. Does the patient have an advance directive?

If yes, CLINICIAN: obtain a copy for review and continue with next question.

If no, CLINICIAN: encourage patient to complete one in the future. Help them in the process by explaining what the selections mean and have them go over the form with their family. Obtain a copy the version (or provide the various kinds) that your hospital uses to the patient and explain terminology and answer all questions. Continue with next question.

Who do you want to make your decisions for you should you be unable to make them for yourself? (Do you have a durable power of attorney for health care? A health care power of attorney is a person, called and health care agent, who will legally make all of your medical decisions if you are not able to do so for yourself due to your illness. You can place limitations of this. If you do not appoint a person to do so, in Pennsylvania health care providers will ask your next of kin or another person who knows you well for these medical preferences. You will have to complete a legal document to appoint a health care agent. This is why it is very important to have an advance directive to help guide your agent in your treatment preferences. See boxes 58-61 of FIG. 7E for a discussion on Health Care Power of Attorney and Living Will and treatment preferences.

62. Is this a consultation for end of life care planning?

If yes, (text) TO CLINICIAN: This is a good time to begin a conversation with patients and families about treatment goals. These are very similar to an advance directive. Values and beliefs may guide the patient in making their choices. Questions should be open ended and include:

63. Treatment preferences include:

i. What medical treatments are acceptable and which would you never want should you become very sick and may not recover?

ii. If your heart stops beating and/or you stop breathing, do you want to be resuscitated?

iii. Would you want to have a machine breathe for you if you were not able to breathe for yourself (placed on a ventilator) if you were not going to get better?

iv. How do you feel about feeding tubes if you are very sick?

v. If you become seriously or terminally ill, where would you rather be at the hospital, someplace your family can get help taking care of you, or at home?

Boxes 64-68 are further boxes that address religious and spiritual issues.

As mentioned above, FIGS. 7a-7E illustrate information flow chart with interface data calls for information from Knowledge-ICB 22 for decision in the EthicsConsult Tool 26. Also FIGS. 3A-3C is a sample EthicsConsult output report which can be created as a data file for input into patients records of a hospital control system.

Now returning to FIG. 2A, the Curriculum Builder module 28 is a tool that uses RLO's 52 enabling educators to customize healthcare ethics training in any number of topics in any order and duration of time. Knowledge-ICB 22 is the source for the information. After constructing a training course 46, the system 10 generates course outlines, teaching guides and scripts. The system 10 is designed to integrate brief video snippets 54 and voiceover narrations into the training on the related topics 49. Curriculum Builder 28 also performs assessment testing providing a variable number of questions, one to five, determined by the educator. These questions are randomized using a total group of seven for each RLO 52. There are also embedded comprehension questions that are interactive using drag and drop and grouping technology. Additionally, Curriculum Builder 28 has a function that allows the trainer to develop and deliver out of system assignments for students to complete.

Curriculum Builder 28 is a tool that allows an individual responsible for education and training to build a customized curriculum or modify an existing one by selecting from hundreds of reusable learning objects (RLO's) 52 for any type of healthcare ethics that are stored in Knowledge-ICB 22. RLO's contain multimedia content, either a video 54 or a voice over narration.

Curriculum Builder 28, Educator function is the process begins with an educator logging into the building a lesson portion of the system. The organizational administrator grants an educator access to the process. It begins with a selection menu display similar to one used in Knowledge-ICB 22. Once a training topic 48 is identified, a selection is made and information extracted from Knowledge-ICB 22 regarding the course outline and multimedia duration. This information is placed in a course-building table and displayed to the educator. A running total of the training duration is accumulated and displayed to the user 18 so that they can determine if the total time required to complete the course meets the requirements or restrictions. The system 10 will allow the user 18 to edit their RLO 52 selection as needed. Once the educator is satisfied with the RLO's, which constitute the class, a complete button is selected, and all the information that is contained in Knowledge-ICB 22 for the selected RLO's is extracted and stored by the educators deification number and a lesson number assigned by the educator.

Curriculum Builder 28, Student function allows students who are assigned to complete an EthAssist course 46 to will be given security access and will log into the student section of Curriculum Builder 28. Once logged in, they will be presented with the courses they are required to complete. When the student chooses to take the class, they select the RLO's in the sequence displayed. Once a topic 48 is selected the multimedia is streamed from the multimedia library. ROL's may have engagement activities assigned with a topic 48 or they may have embedded drag and drop comprehension questions. The student can review the class material up too three occurrences before an assessment test is given. These assessment questions can number from one to five and are presented randomized from a pool of seven questions for each topic in the test. A numerical percentage is displayed and stored for the educators review. The student has an opportunity to improve their score by retaking the assessment test as many as three times. All student activity is logged and date stamped to review by the educator.

See FIGS. 8A-8P for a conceptual diagram of Curriculum Builder 28: FIGS. 8A-8K are screen shots of the Educator Template process; FIGS. 8L-8P are screen shots of the Student My Lessons process. Notations on the flow charts, “Calls,” indicate information input to (requests) and outputs from (responses) Knowledge-ICB 22.

Now turning to FIG. 8A-8P. This is a description of the user's 18 interaction with Curriculum Builder 28. As depicted in FIG. 8A, a user 18 is first presented with a secure login screen 102 where a user id 104 and password 106 is required for entry into the system 10. The user 18 information is setup prior to the user 18 attempting to login by a system administrator. There is a reset password process a user 18 can follow should they forget their password. The user 18 is now at the EthAssist 68 menu page where navigation options are presented. The menu 68 allows the user 18 to select Curriculum Builder 28 from the Tool-ICB 24 section of the menu page.

FIG. 8B is another menu 108 illustration and selection of Curriculum Builder 28 is next executed to take the user 18 into the Educator Template Creation 70 process shown on FIG. 8C, where a secondary menu selection 146 is presented to the user 18. The user 18 selects Course Templates 72 from the Browse Course Template screen 82 to begin the process of creating a new course. The user 18 in this process is called Admin 74. The Admin 74 selects a template design 148 as depicted on FIG. 8D. In this example, a new blank template 76 is called from the database 50 in the Lesson Template Screen 75. Next the Admin 74 will customize a lesson 76 by assigning a name 150, lesson number 78 and Engagement Activity 80 to the lesson 76 as illustrated on FIG. 8E. Once the Admin 74 completes entry of the required data, they will mark status 152 of the lesson 76 as Draft or Active and submit 154 the lesson 76 to the database 50 for storage. After the Admin 74 submits the lesson 76, the system 10 takes the Admin 74 to the Browse Course Template 82 screen where the Admin 74 can see the lesson 76 they just completed.

On FIG. 8F, the Admin 74 clicks on the lesson 76 just created and activate it. At this point, the Admin 74 can select the New Template Topic button 86 and the system 10 will allow the Admin 74 to browse the database 50 in Knowledge-ICB 22 selecting RLO's 52 (FIG. 2A) that they want to include in the lesson 76. Upon finding the desired RLO 52, the Admin 74 by selecting it initiates a call 158 to the system 10 by clicking on the Insert New Template Topic 86 button to launch an Insert new Template Topic screen 160 (FIG. 8G). As depicted on FIG. 8G, the Admin 74 can also search the Knowledge-ICB 22 database 50 using a search capability and a dropdown box 162 containing topics 64 that can be included in the lesson 76. After selection of a topic (e.g., Assent), a request or call 164 for the related media type 88 is sent to database 50, either video 54 or narration 90 (e.g., Narration 94), for selection, which is required. The Admin 74 then selects the submit button 166 and the lesson 76 is stored in the Knowledge-ICB 22 database 50 (FIG. 8H). The Admin 74 can repeat this process as shown on FIG. 8H as many times as required, by returning (via return key 168) to the Lesson Template Screen 75.

The next step in Educator Template Creation 68 is assigning students to the lesson 76. Students are loaded into the systems Validation Table 226 by the admin 74 for security validation as shown in FIG. 8Q. The Educator 98 does a search of the Validation Table 226 by typing the student's name into user name box 228 to assign students enrolled in lesson 76 they are teaching. Call 230 is sent to Validation Table 226 for retrieval of all the students in the Validation Table 226 that meet the search criteria. The Admin 74 must navigate from the Browse Course Templates screen 82 via a dropdown menu 170 when module key 172 is selected that launches a menu page 174 where a call 176 is sent to database 50 to select a lesson 76 to which students will be assigned as illustrated on FIG. 8I.

The last step in creating a lesson 76 is to assign quiz questions. The Questions module 178 in FIG. 8C is selected to launch Insert new Lesson screen 176, as shown on FIG. 8J, where the Admin 74 activates the quiz questions 92 that are associated to the lesson 76. User 18 enters template name 150, status 152, whether or not to Use Comprehension questions 180, and the number of questions 182. Submit button 154 will send a call 184 to the database 50 to activate the quiz questions 92. Questions are randomly generated for each quiz based on known techniques. User 18 will be directed back to (or a call to return to) the Browse Course Template screen 82 to view lesson 76 being created (or updated) and saved.

After selection of lesson 76 on FIG. 8J, out of class homework can be given for lesson 76 by selecting Insert New Course Assignment 94 to launch Insert New Course Assignment screen 188. Lesson assigner can search for users 18 by typing a user's name into User Name box 190. A user name call 194 is sent to database 50 for each letter typed into User Name box 190. A dropdown menu 192 is displayed showing likely known users based on the letters typed into user name box 190. Lesson assigner has the option to select one of the names listed in the dropdown menu 192 or type the full name of the user 18. All calls to the database 50 are depicted on the figures in proper location.

The Student “My Lesson” 96 process starts on FIG. 8L with the secure login and EthAssist 68 menu screen. A student assigned to a class after login will select Student “My Lesson” button 96 from Tool-ICB 24. Upon selection of the “My Lesson” button 96, system 10 launches the My Lessons screen 196 that will present the student with a list of lessons 76 assigned to the student as shown in FIG. 8M. The student can select a lesson 76 (e.g., Four Principles Approach) and the system 10 will send a call 200 to the database 50 to display the topics 64 contained in the lesson 76 in Lesson screen 202. When the student is ready to take lesson 76, the student selects the topic 64 in the order displayed. System 10 indicates (e.g., check mark) that a topic 64 has been completed as shown in FIG. 8N. Once the student takes the lesson 76, the system 10 indicates (e.g., check mark) that the lesson 76 was completed. At the same time, a historical record of the student's activity is maintained on database 50 such that the educator 98 can view the progress of the student. Once the student has completed a lesson 76, the student is required to take a quiz 100. The student selects Take Quiz button 204 that launches the first question 206 of quiz 100. The system 10 will randomly call 208 questions for database 50. For example, quiz 100 can consist of one to four questions randomized from a list of seven questions for each topic. The number of correct and incorrect answers are stored on database 50, as well as the questions taken and not taken, for course analytics and student individualized evaluation. One embodiment of system 100 provides options to repeat lesson 76 prior to taking quiz 100.

After completing the quiz 100, system 10 calls 209 the stored quiz results (e.g., correct and incorrect answers) from database 50 and calculates a numerical score based on the stored quiz results (e.g., correct and incorrect answers) and displays the score 210 in Quiz Score screen 212 to the student, as shown in FIG. 8O. The system 10 has the ability to give the student the option to taken a quiz, up to a predetermined value set by the curriculum builder, for example, three times, after review of the lesson 76 again.

The system 10 stores the results of the quiz 100 and the number of attempts 214 the student completed and can be called 215 from database 50 and displayed on the My Lessons screen 196, along with length of time 216 to complete lesson 76 and status 218 (e.g., not taken, in-progress, completed) of lesson 76 each time the My Lessons screen 196 is launched. As mentioned above, the system 10 also stores incorrect answers such that educators 98 can do analysis on the effectiveness of the course material. All transactions that are stored on database 50 are time and date stamped.

FIG. 8P illustrates a screen 218 that an educator can use to view the status of a student's progress through an educator login screen (similar to user login screen 102) that provides access to students who are assigned to either the educator or a particular course or both. The student's summary is called 220 from database 50.

IRBQA Module 30

Now turning to FIG. 2B, the last module is Internal Review Board Quality Assurance (IRBQA) 30. IRBQA module 30 is an automated guide to walk Internal Review Boards (IRB) members through the IRB process out lined in the IRB Hand Book. IRBQA module 30 requires users 18 to respond to each question specific to the particular trial under review. It is self-documenting proving a report of outstanding responses and note which board member responded to the questions with a time and date stamp. This provides a complete record of IRB's actions to improve quality of clinical trials and can be stored in defenses of their decisions.

The IRBQA module 30 functions as an automated check-list and chronological documentation of Internal Review Boards (IRB) answers to questions to ensure that clinical trials conducted on humane subjects are following best practices to safeguard patients. IRBQA module 30 starts by requiring that the board membership document whom they are and that they have the required education and experience to make decisions regarding the particular clinical trial in which they are participating. If the membership does not have the correct membership the chairman has the responsibility to stop the trial review until the membership is corrected. IRBQA records all answers to the qualification questions and will not allow it use unless the chairman overrides the stop condition, which the override is documented as such. This jeopardizes the fundamental existence of the IRB and any decisions made by them.

The next steps are taken depending upon the type of clinical trial and the groups of subjects that are in the trial. Decisions are made within the process the direct the IRB to follow automated process that record actions and decisions made during the trial. A report is generated that indicates warning messages and critical messages as the trial proceeds. All response to questions are time and date stamped to maintain an audit trial of the IRD decisions.

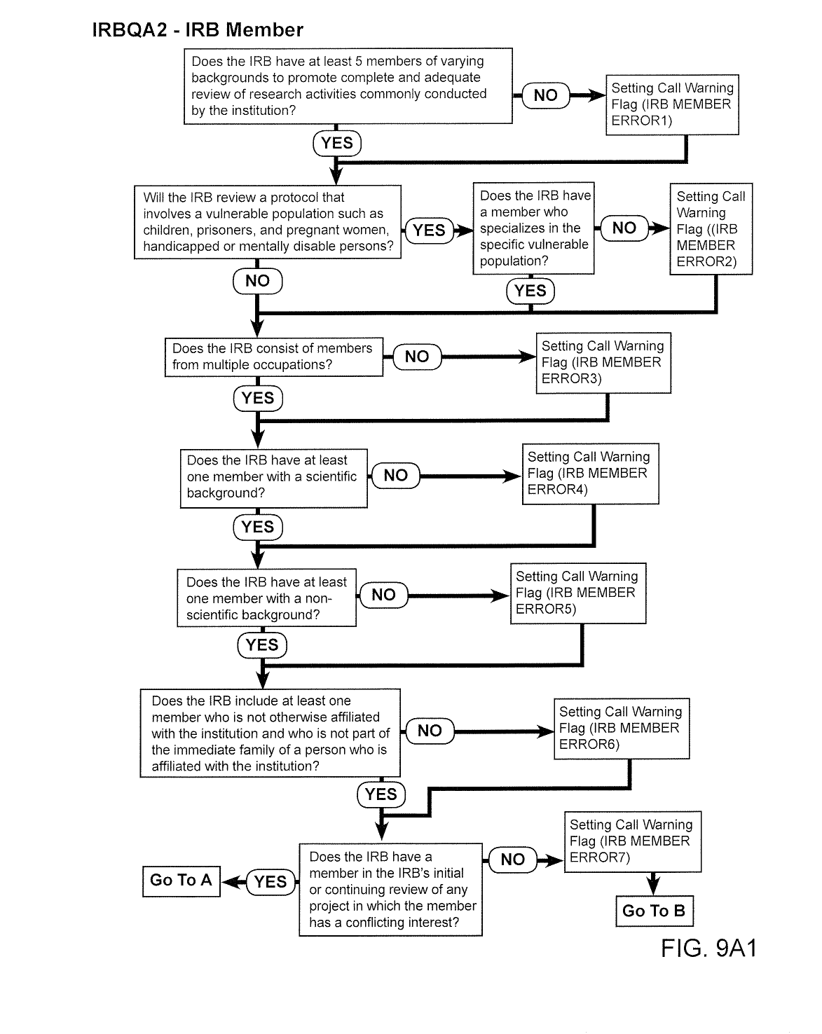

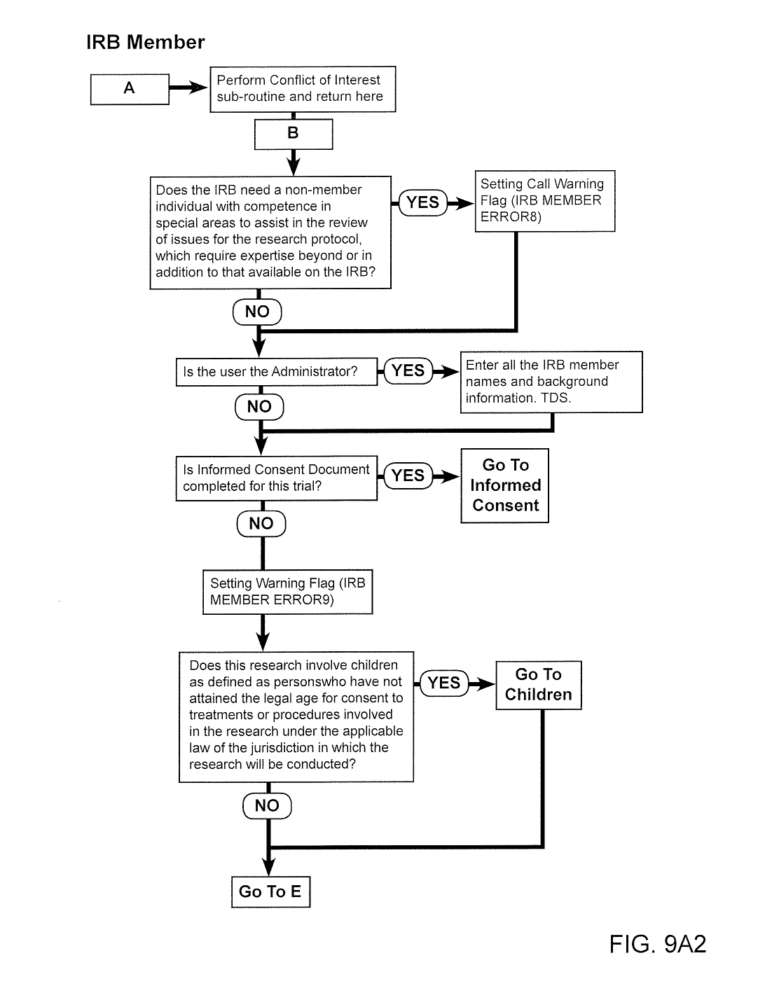

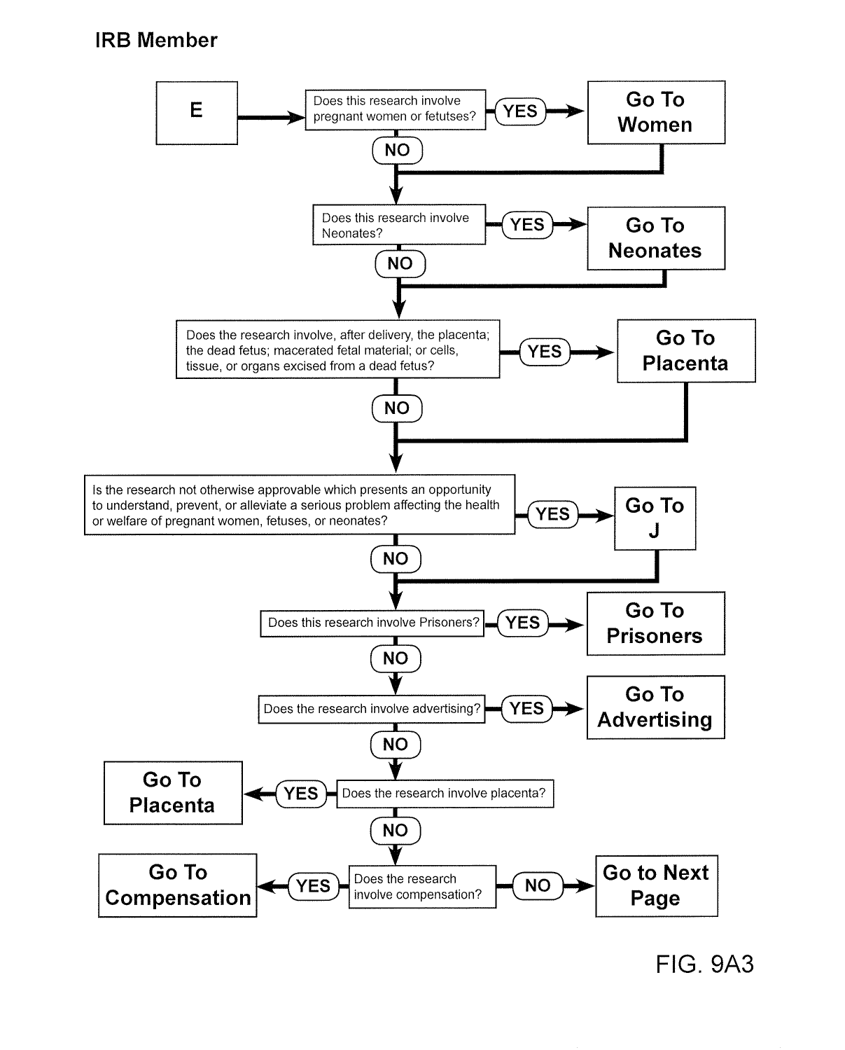

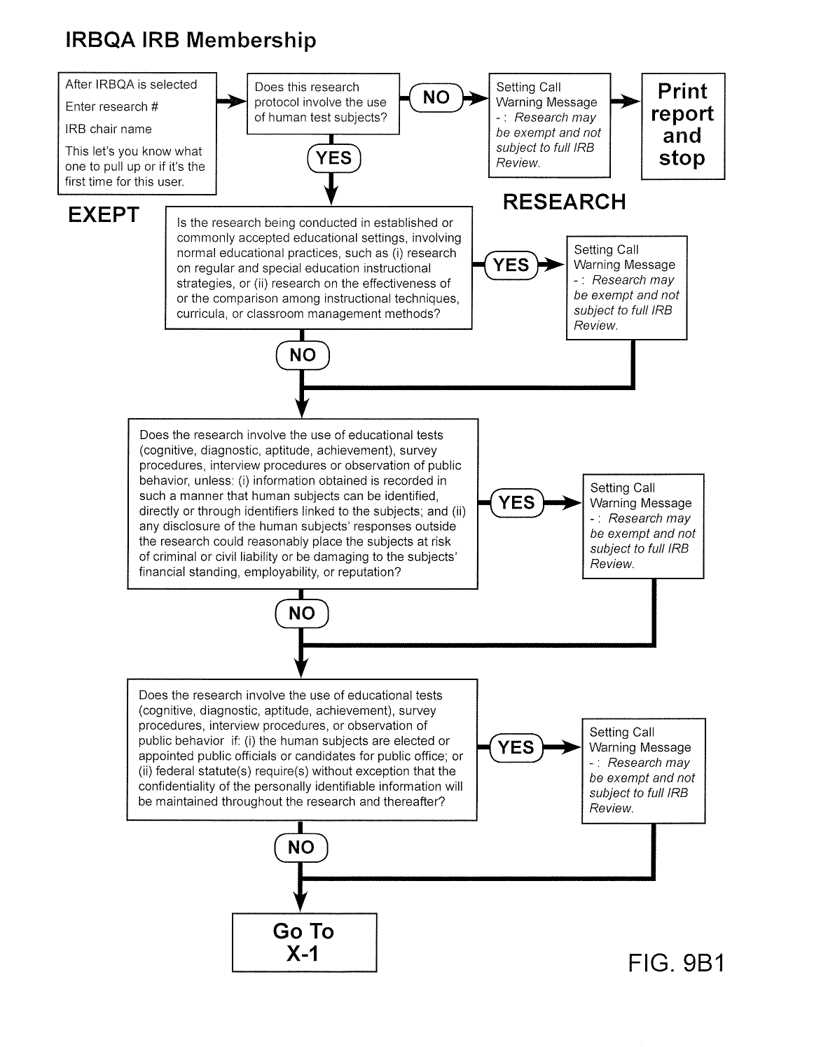

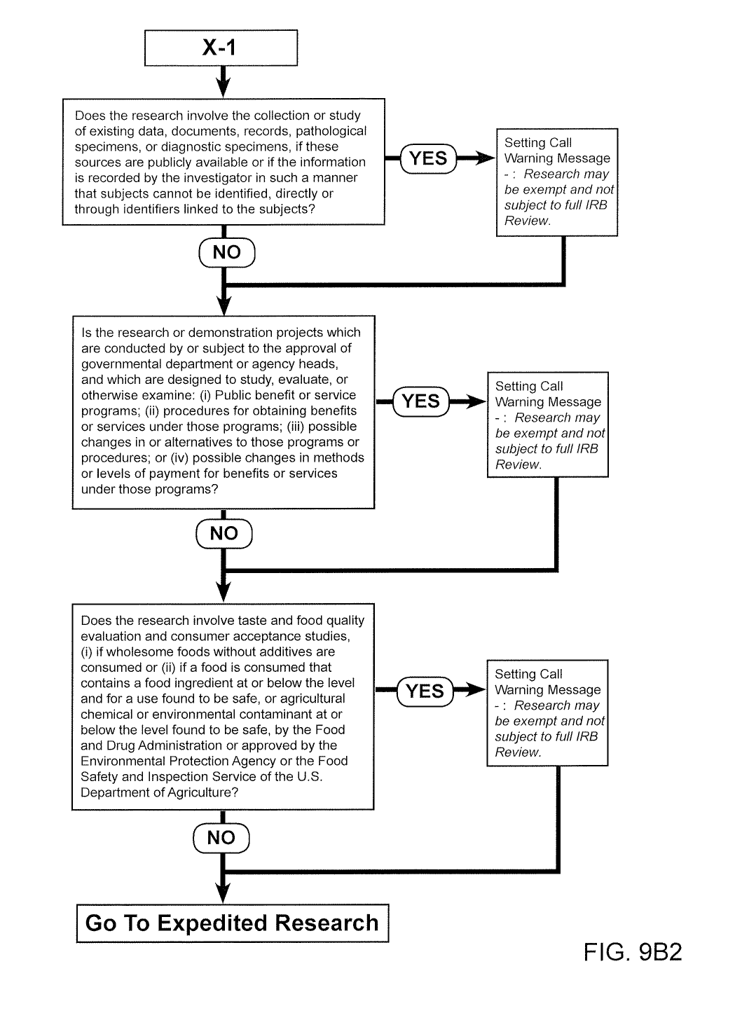

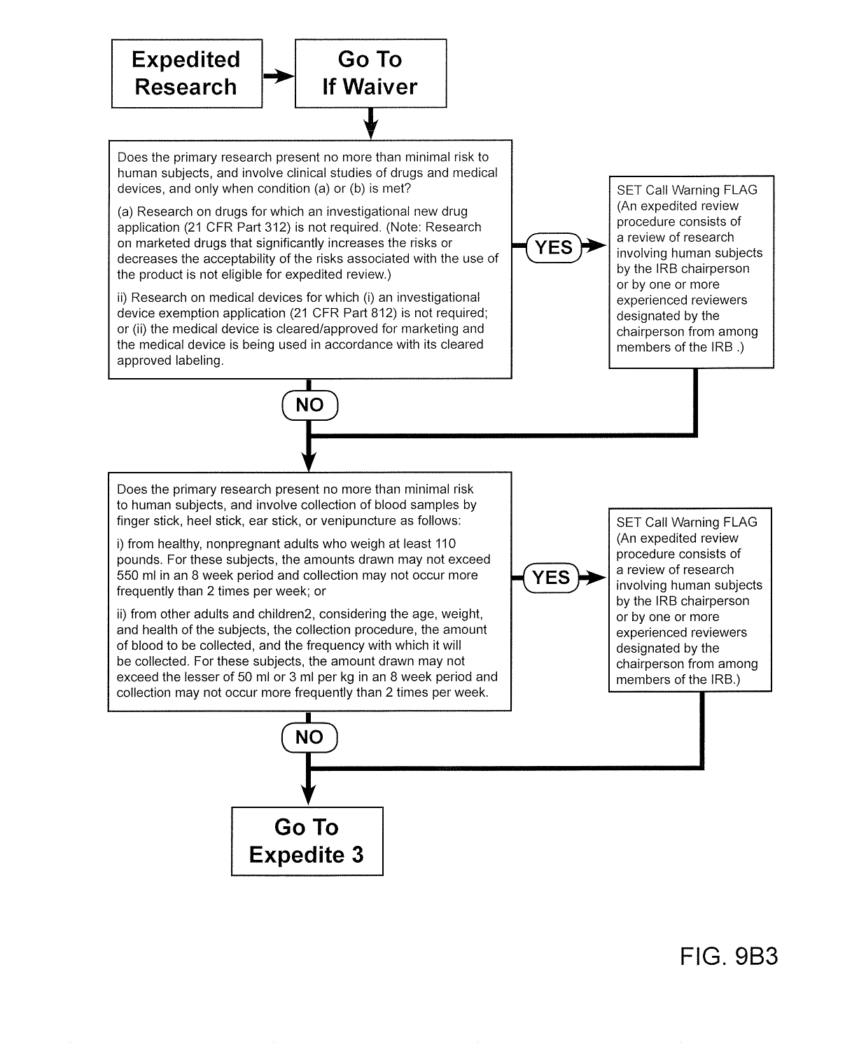

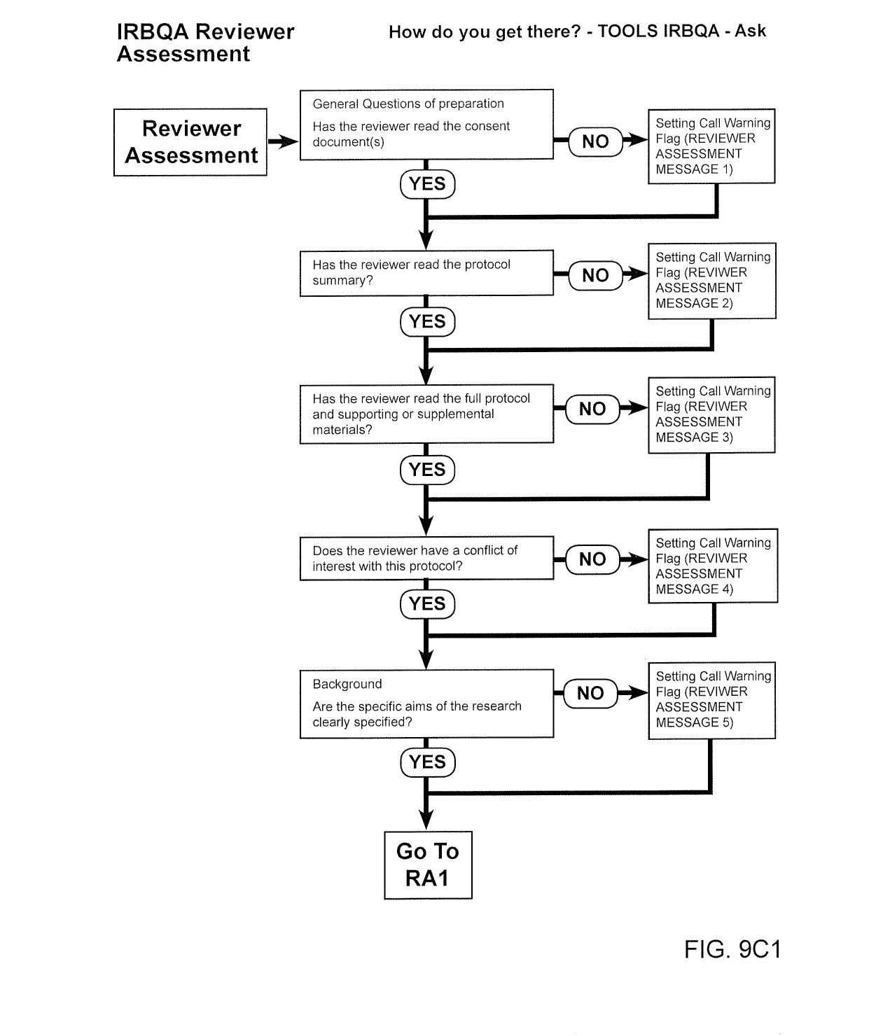

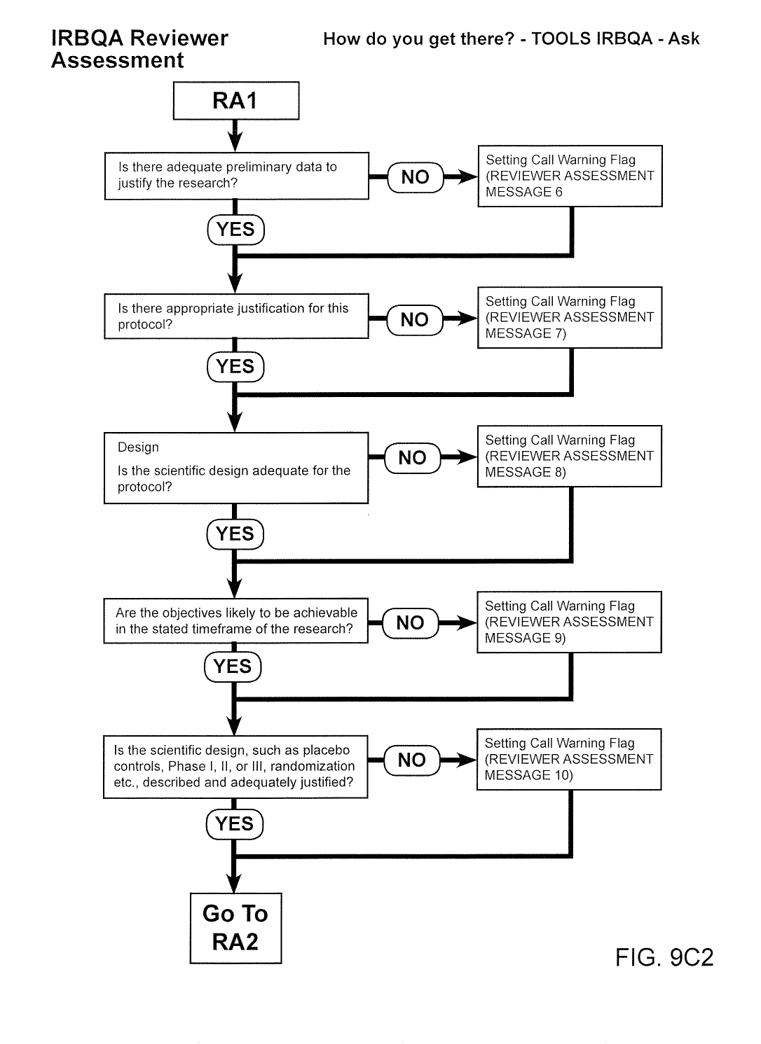

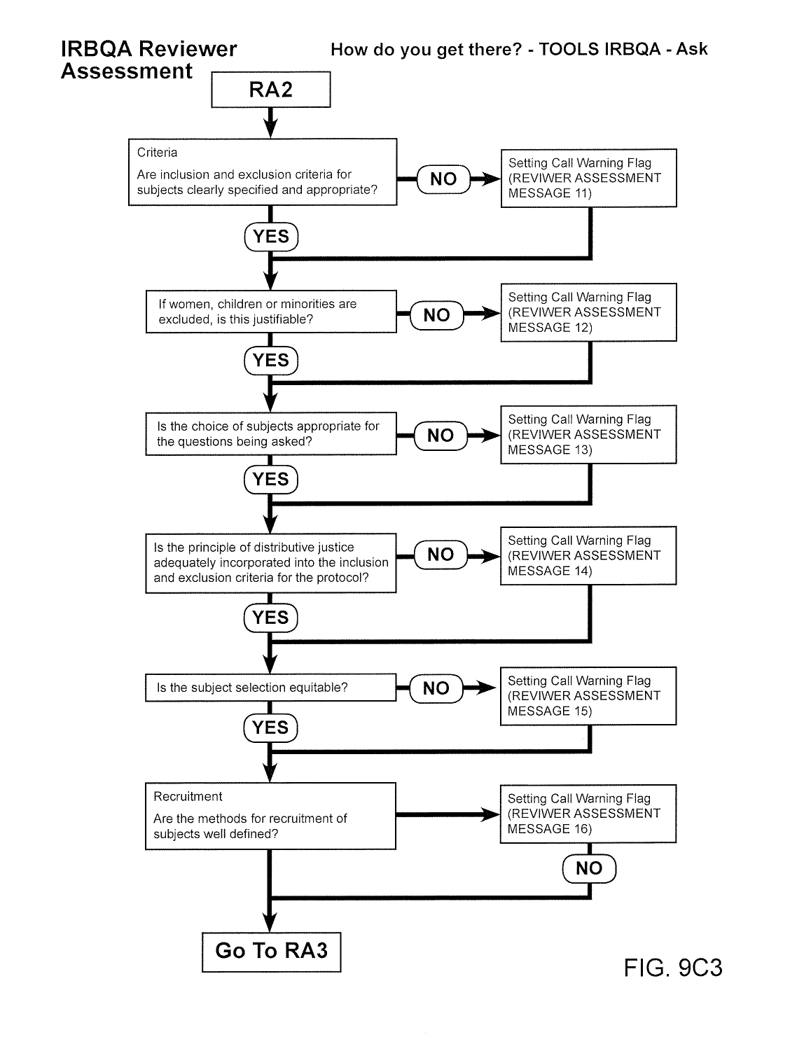

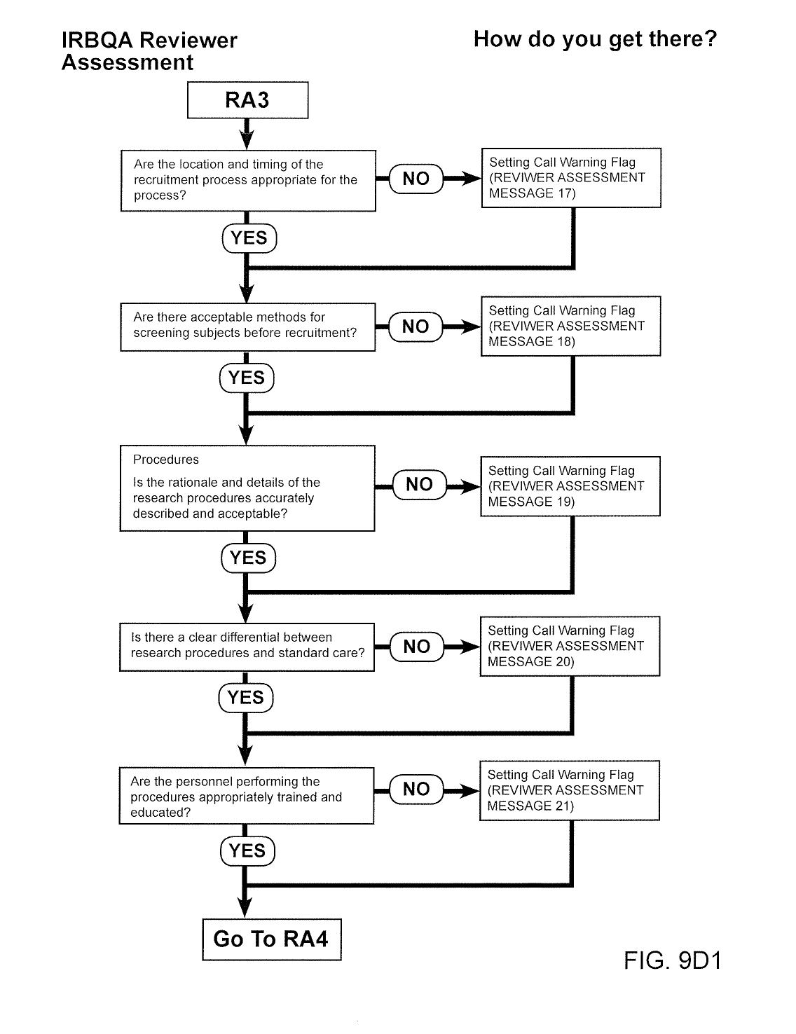

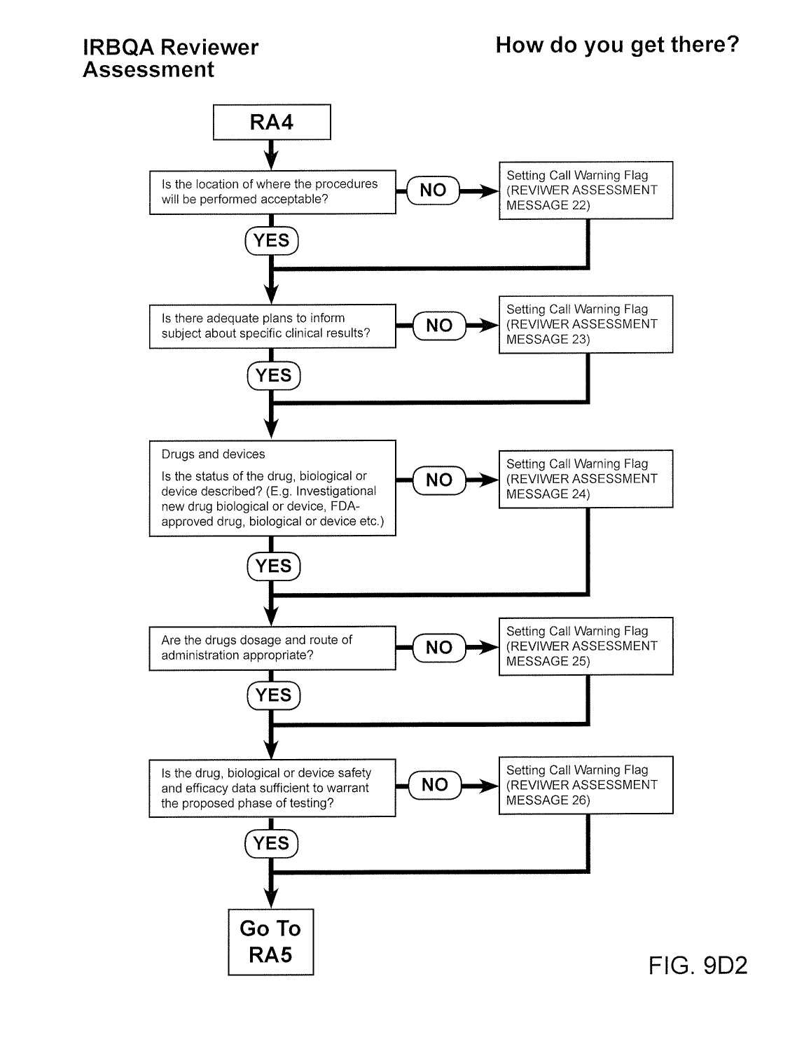

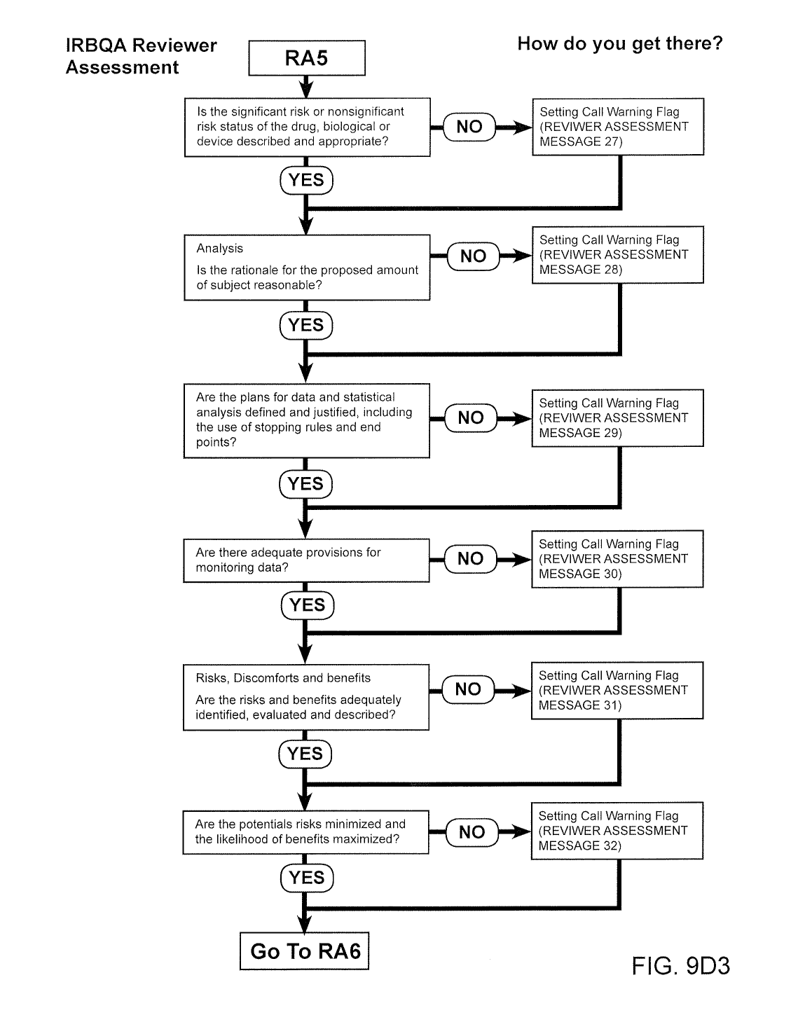

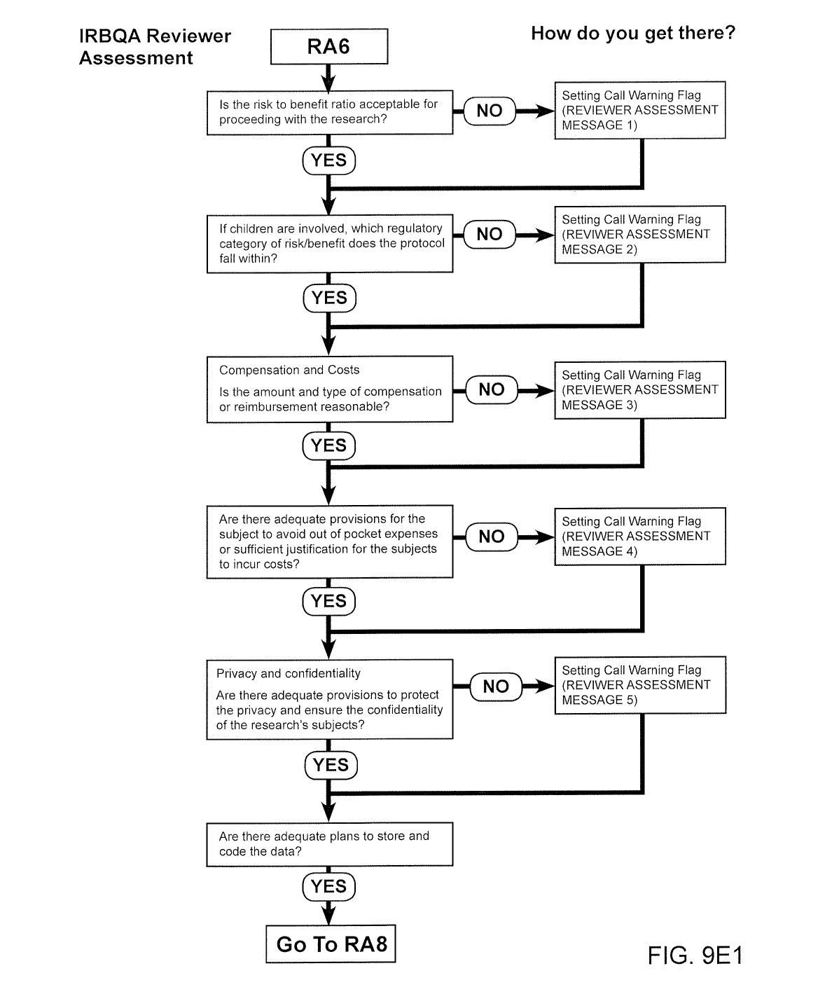

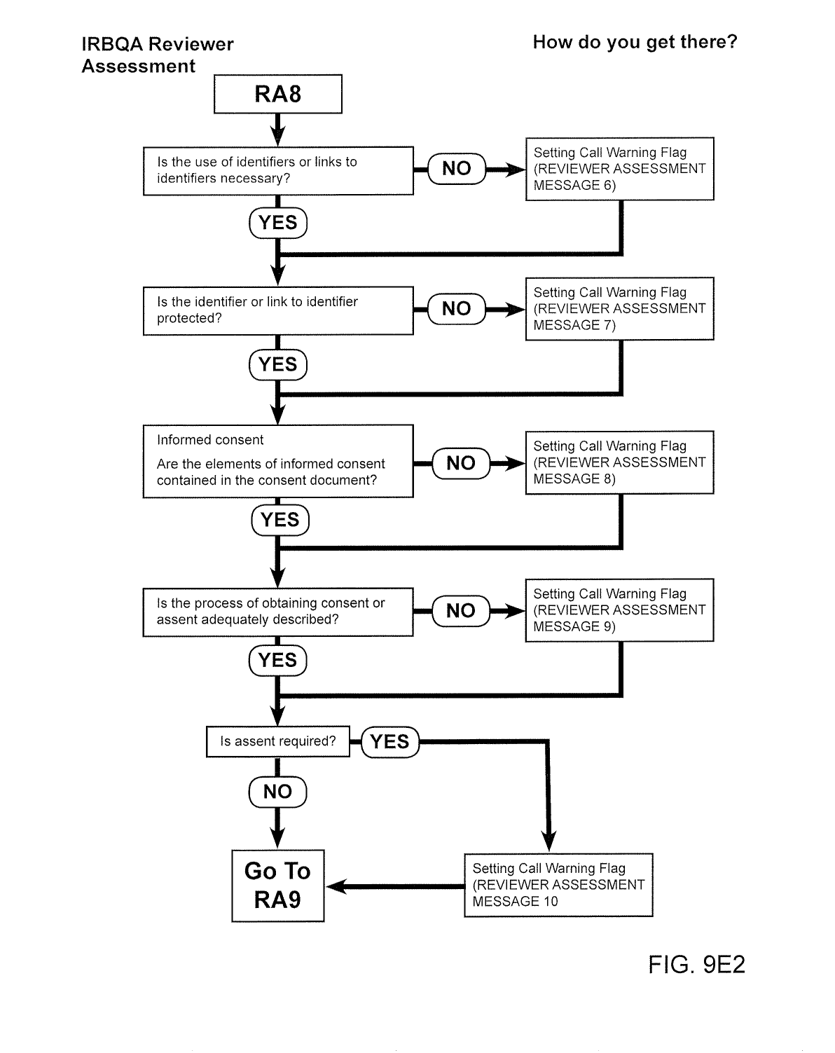

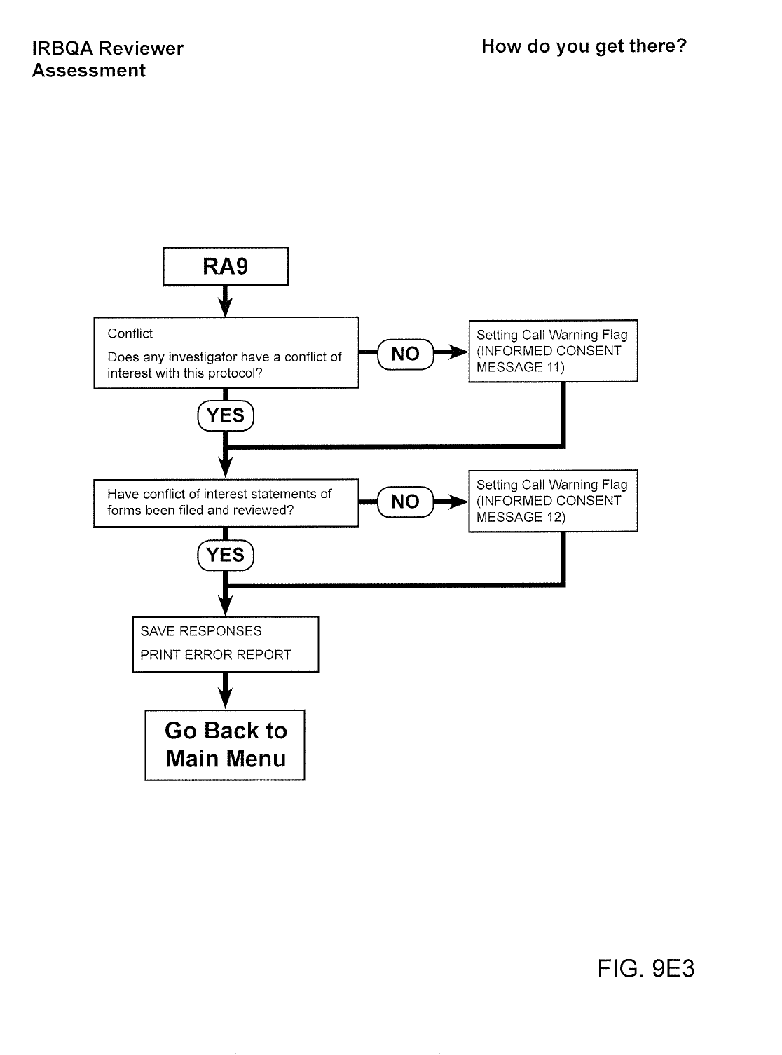

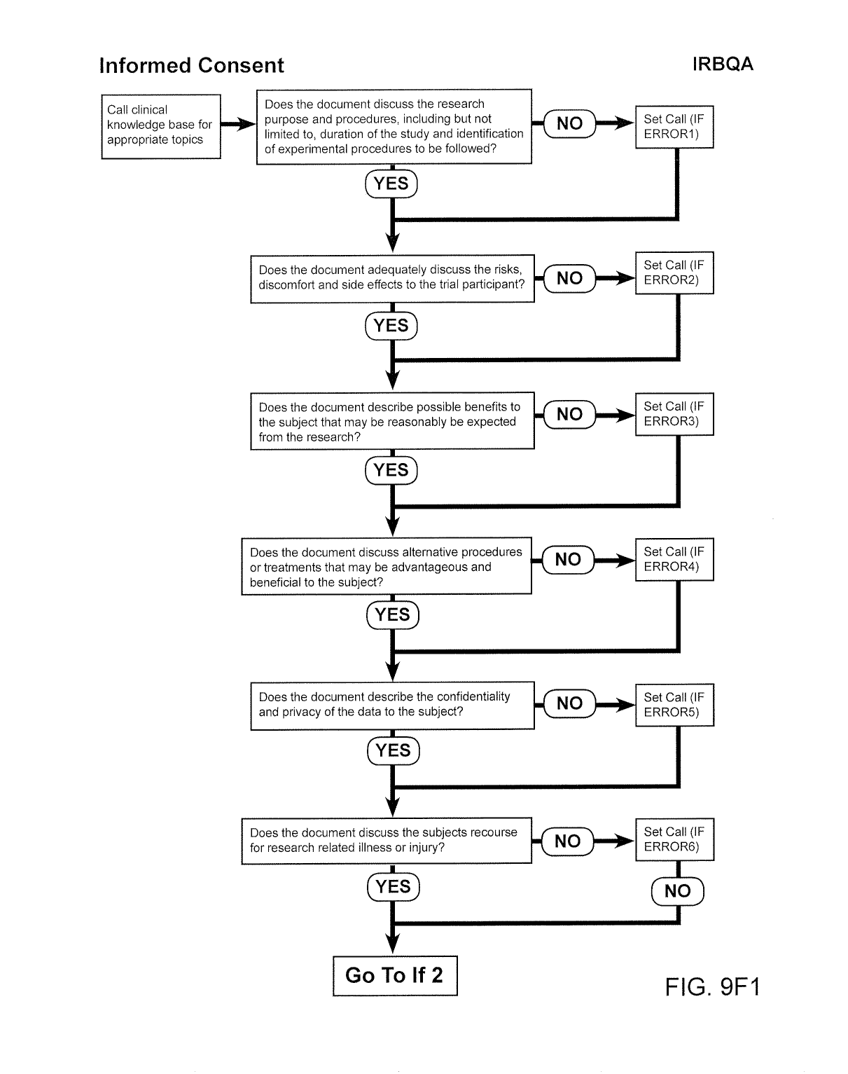

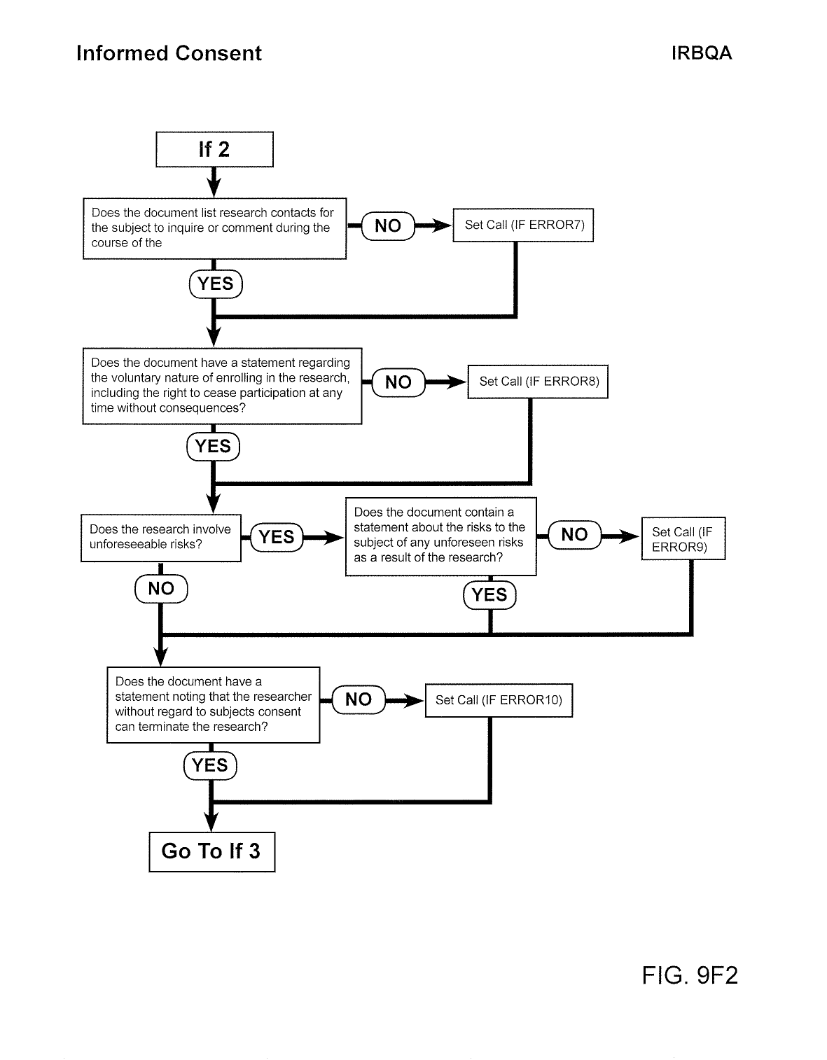

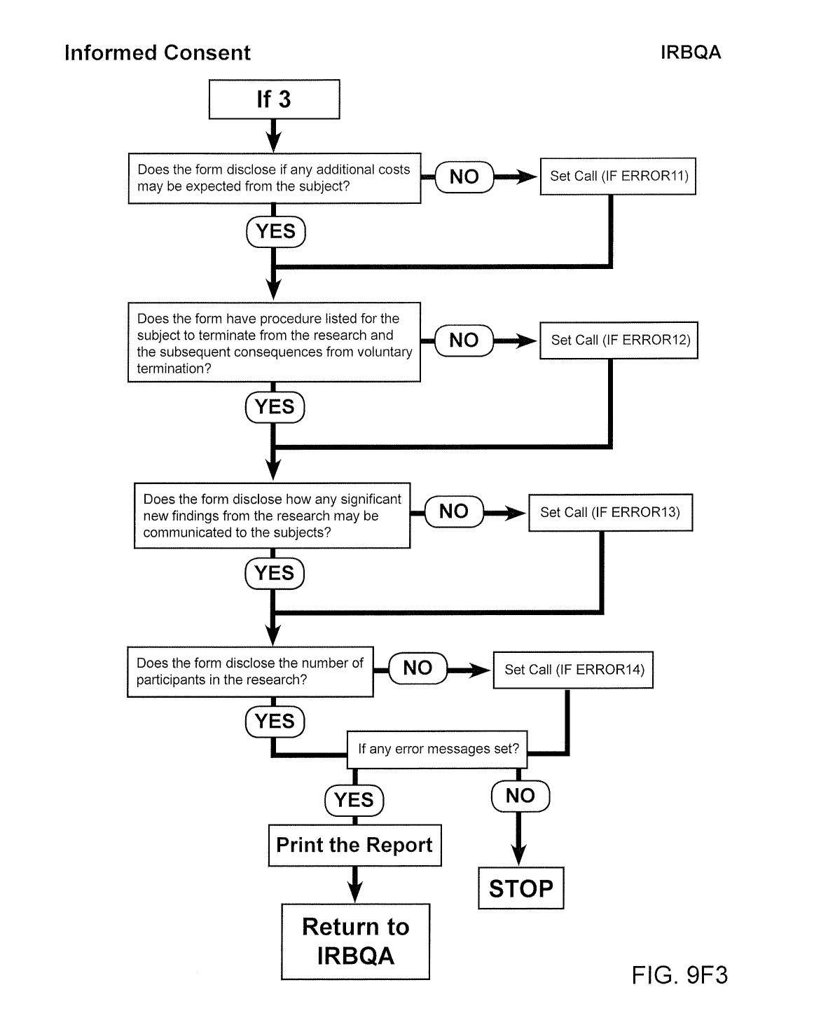

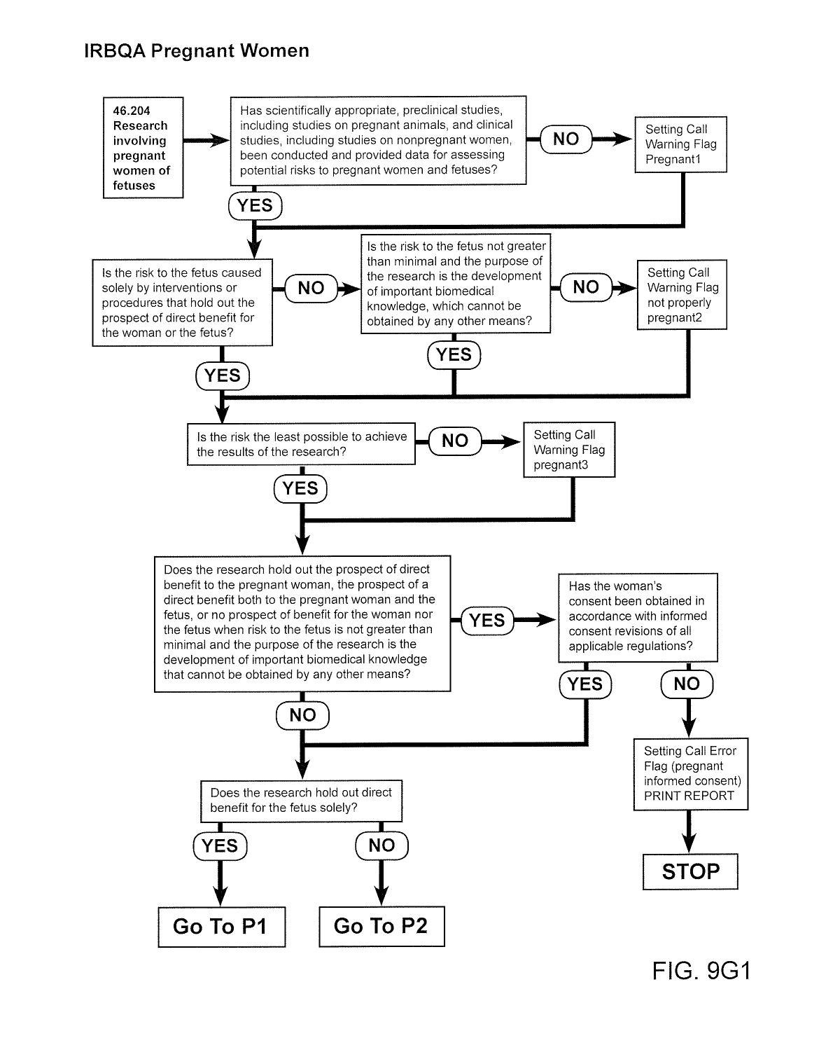

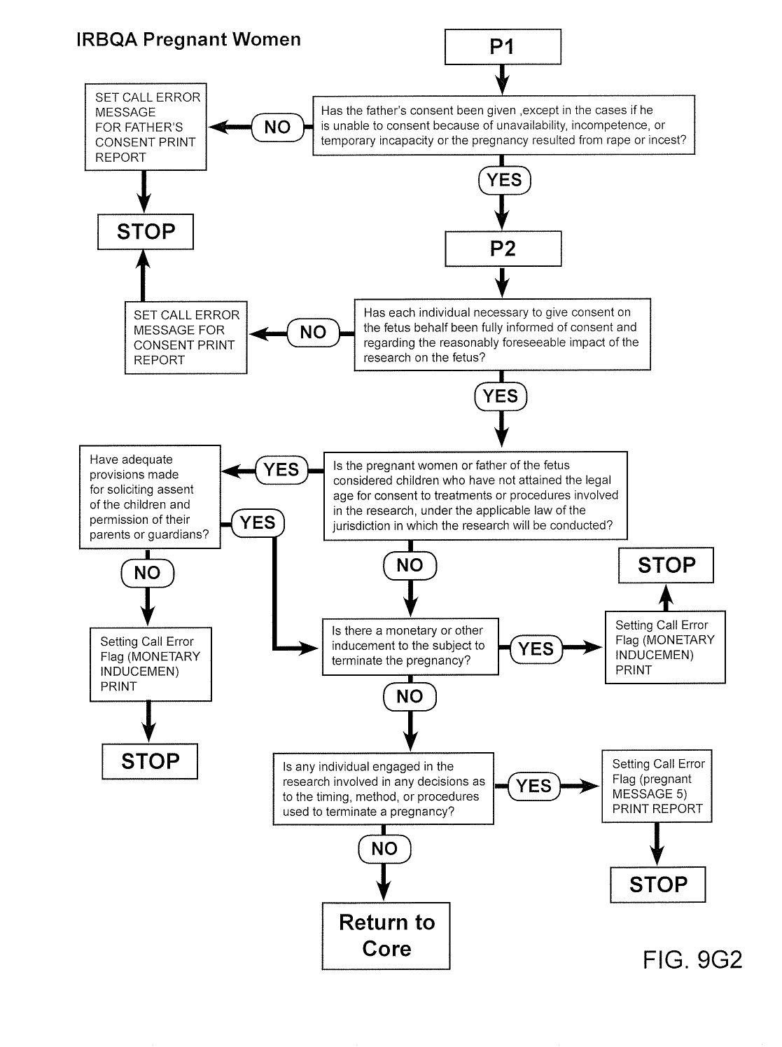

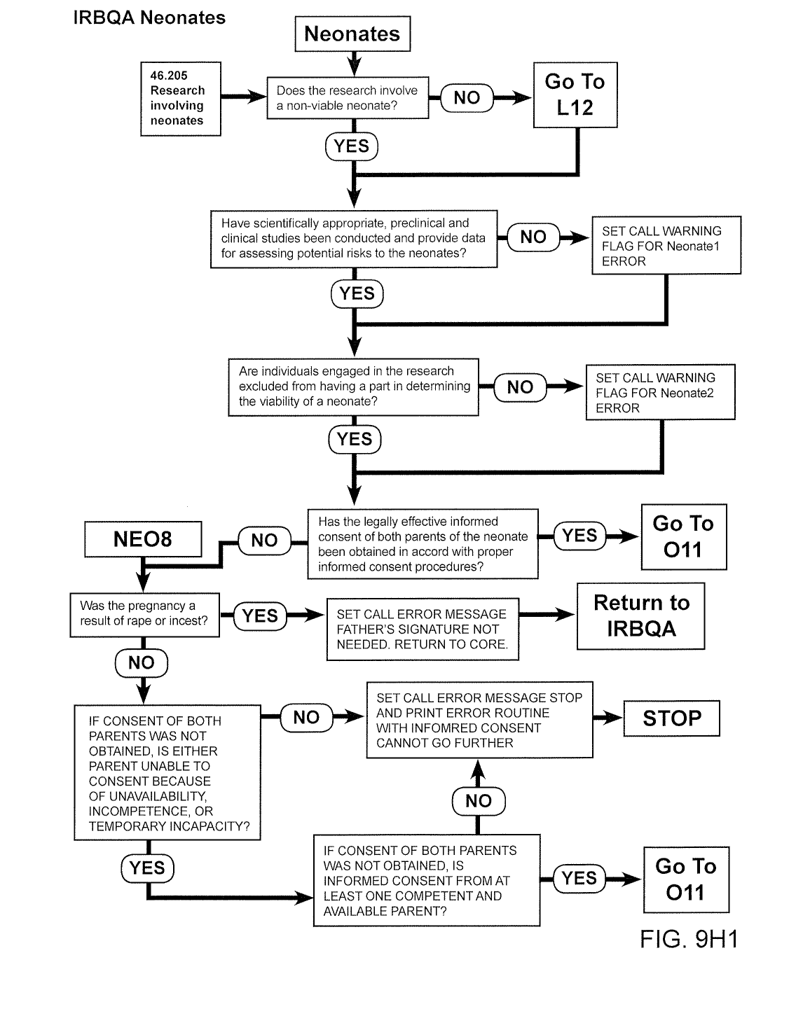

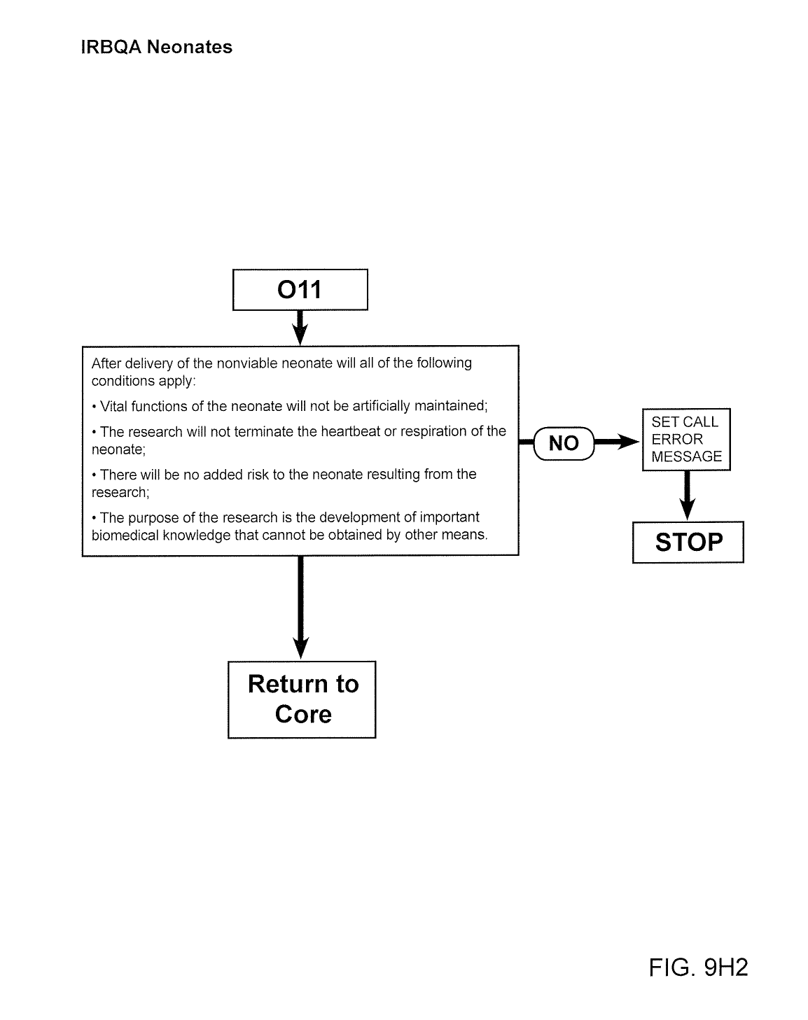

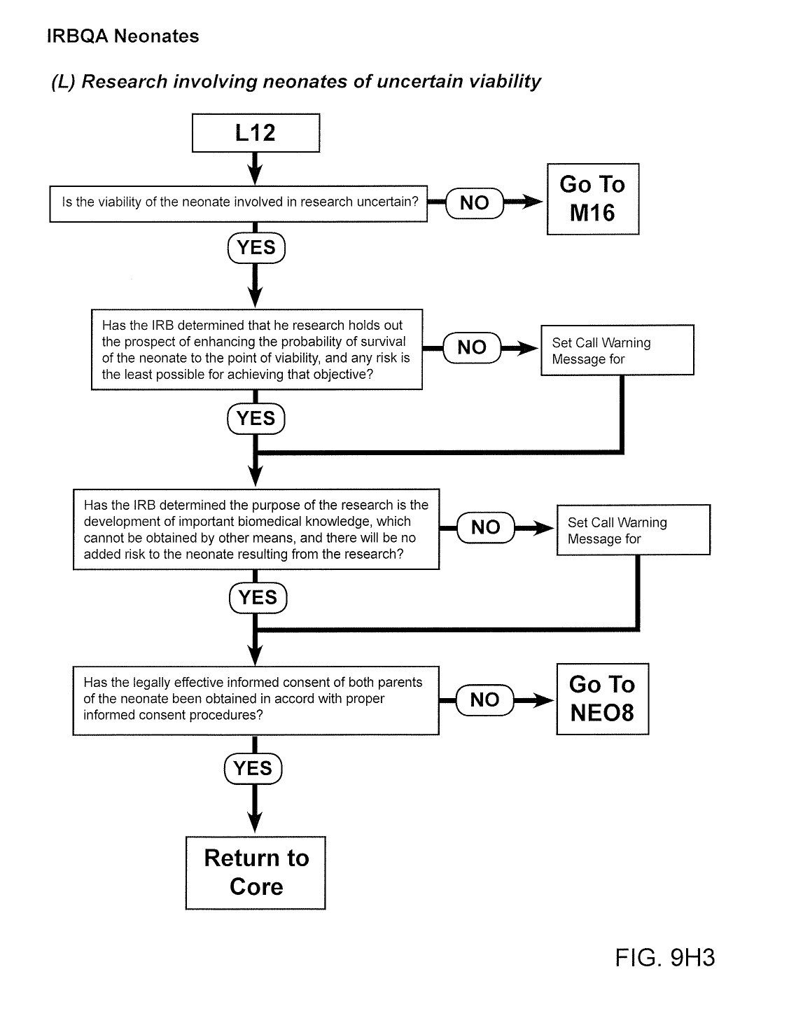

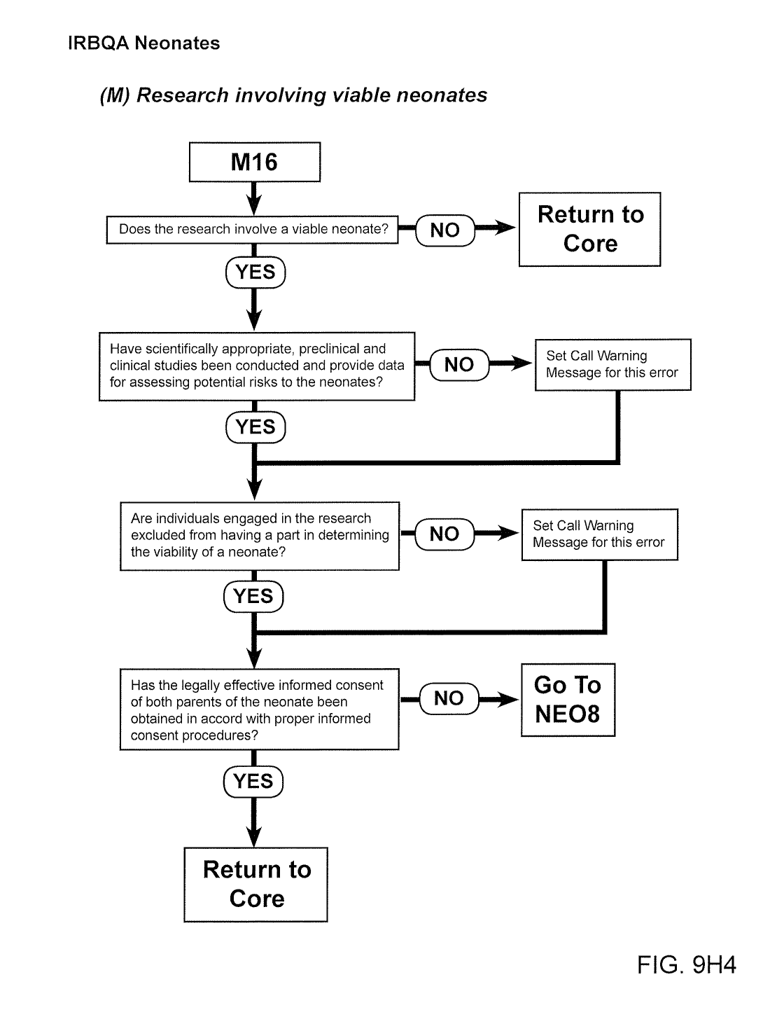

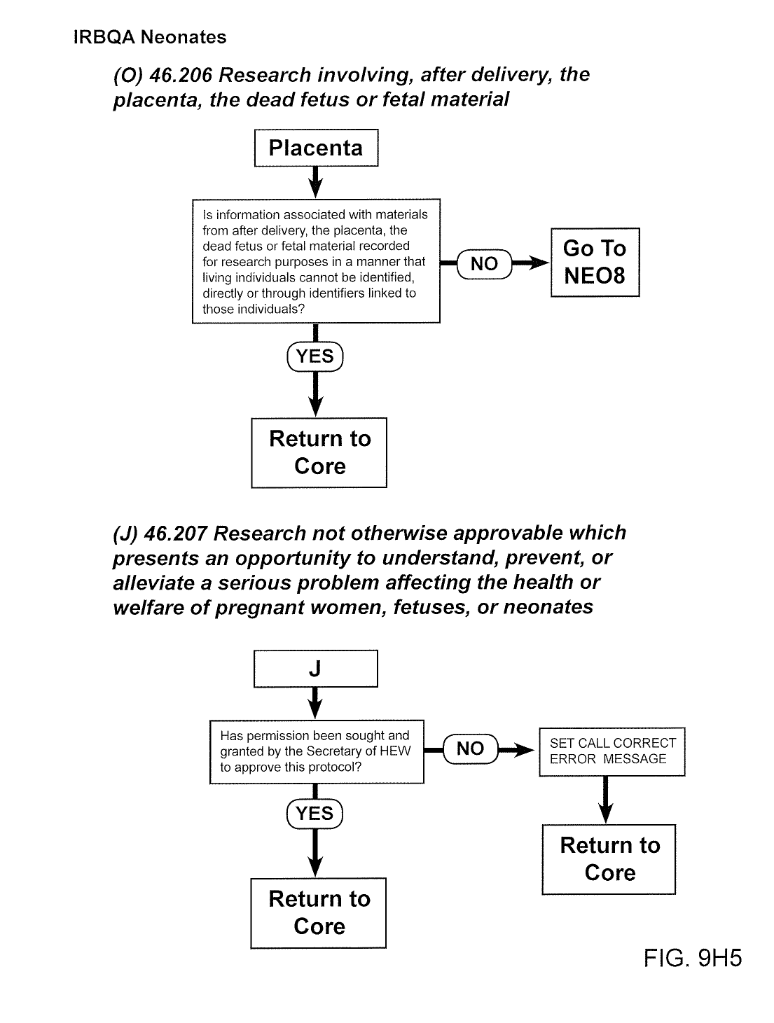

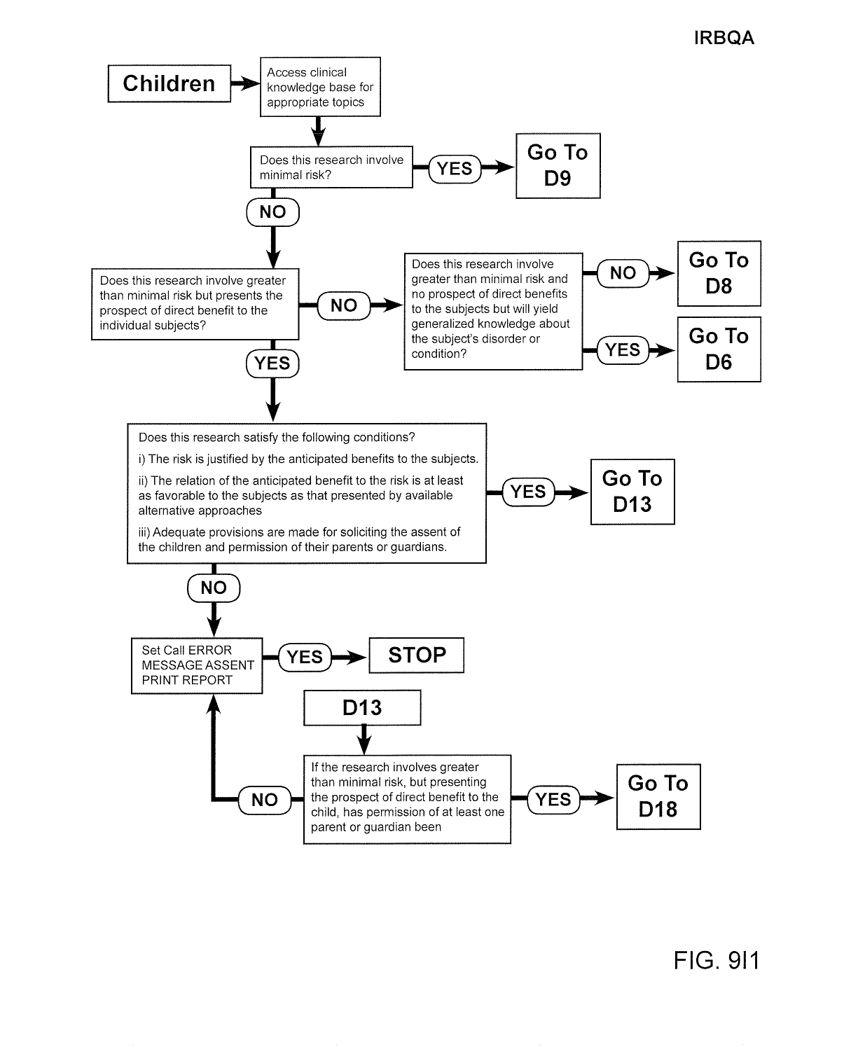

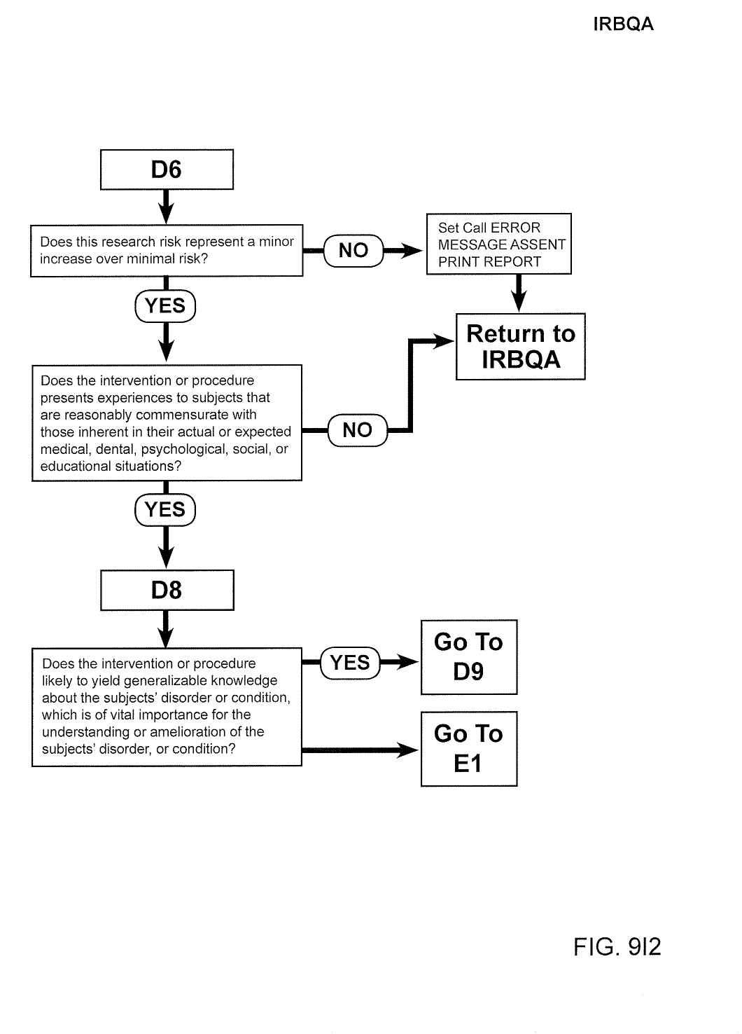

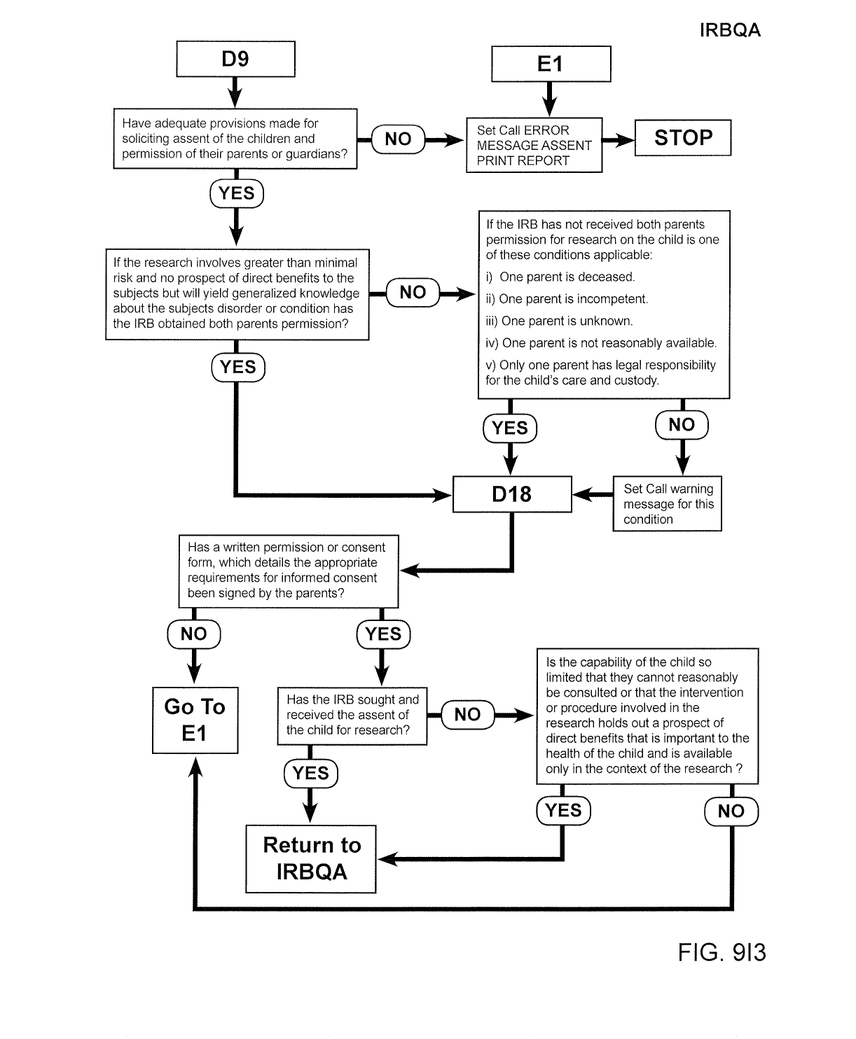

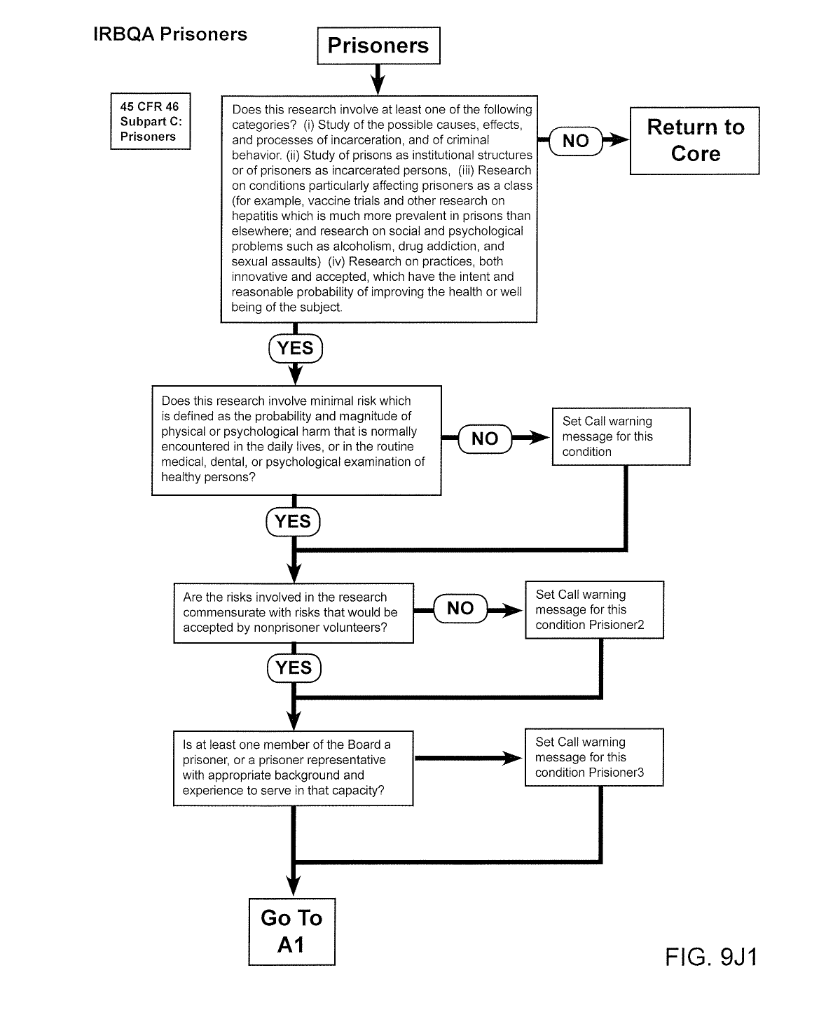

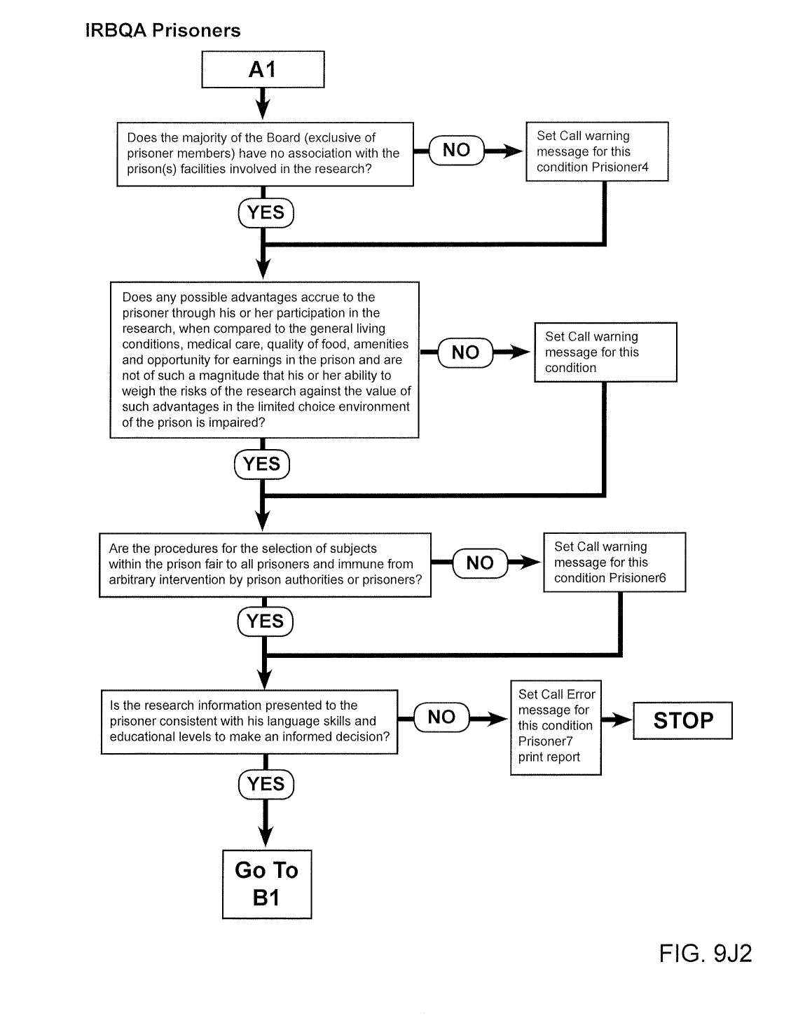

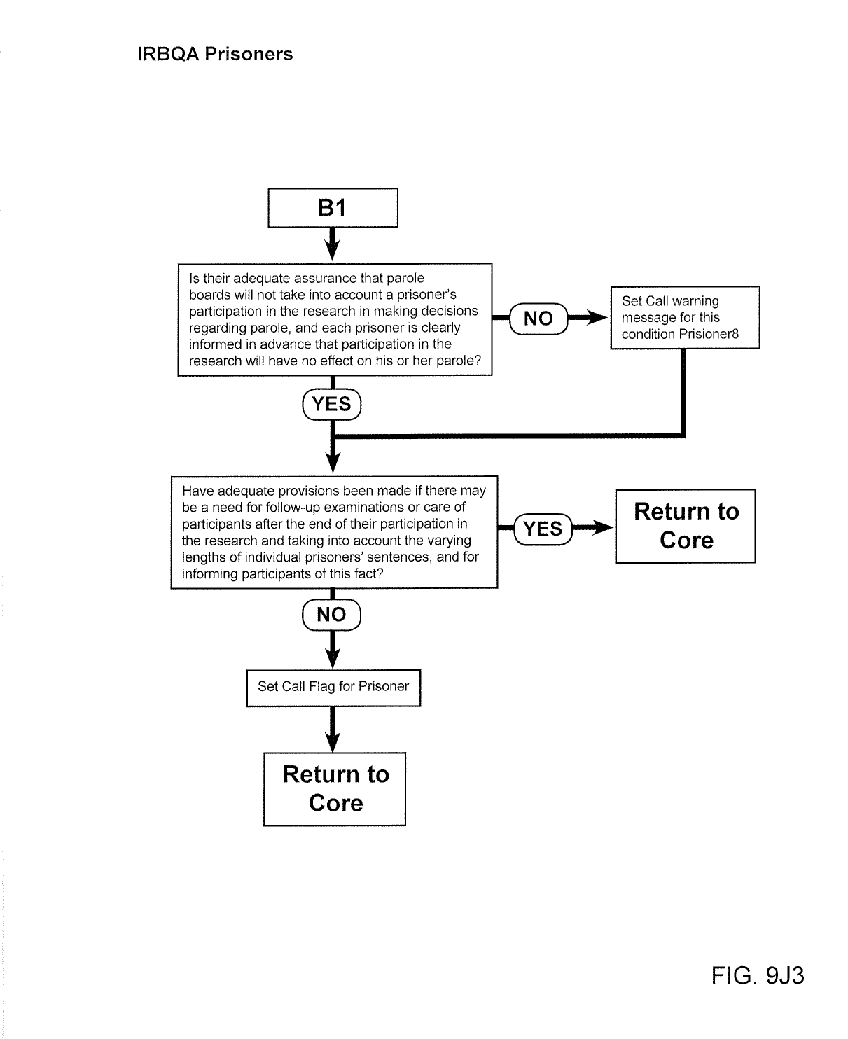

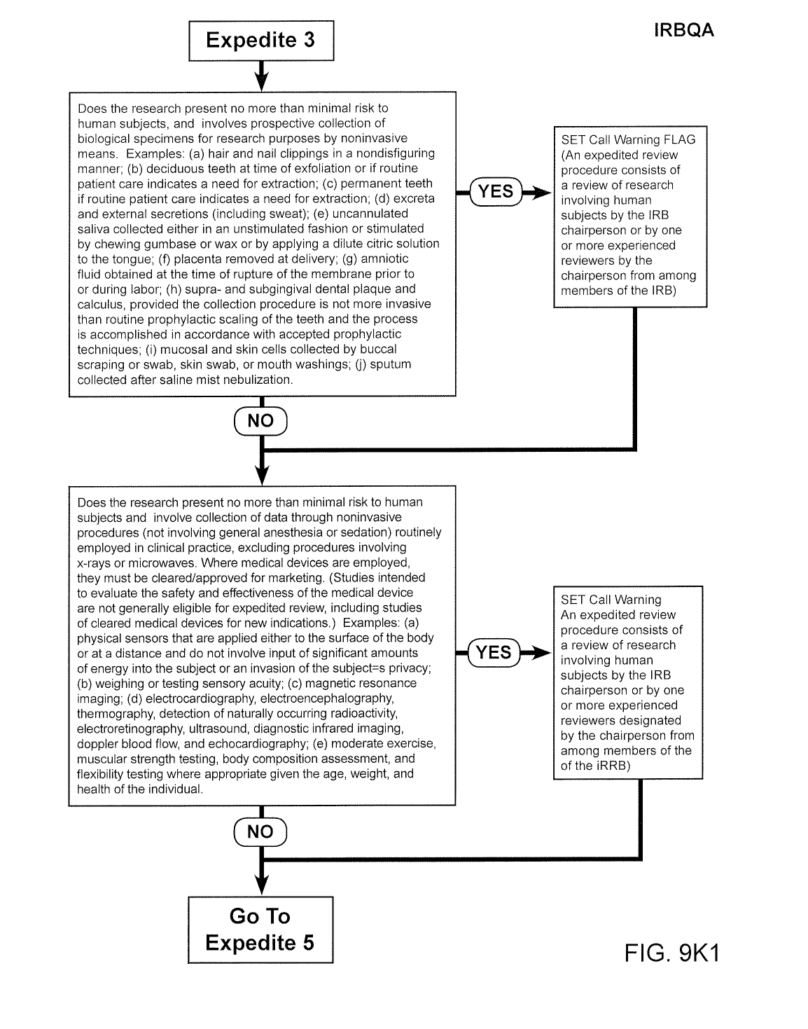

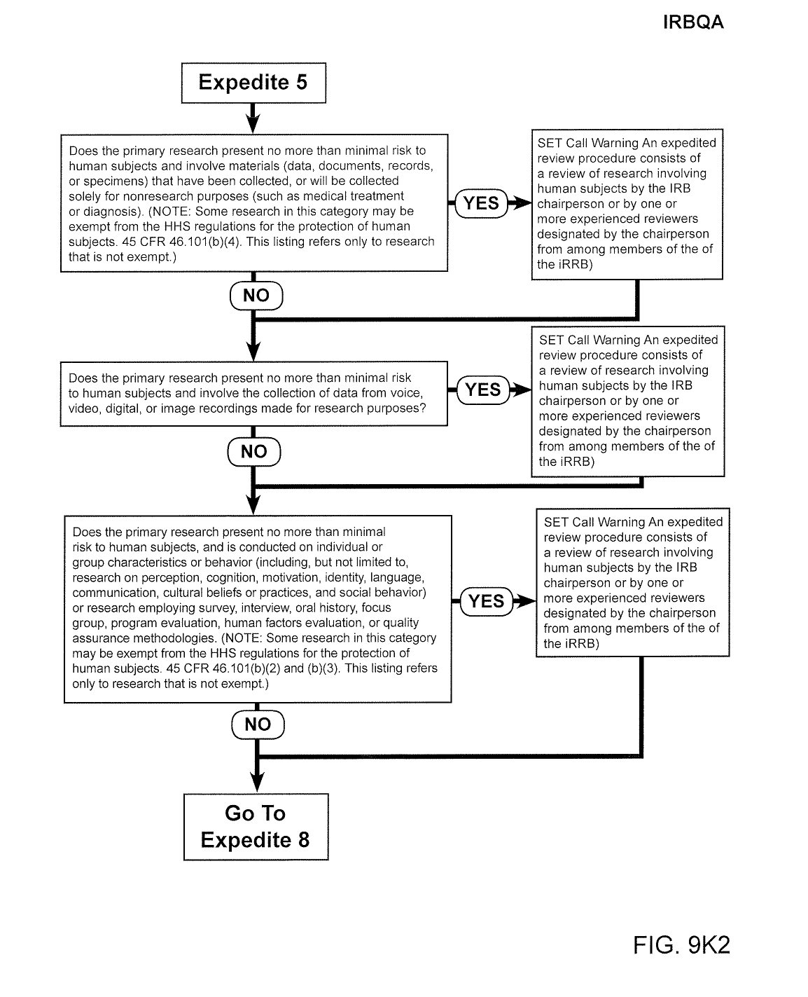

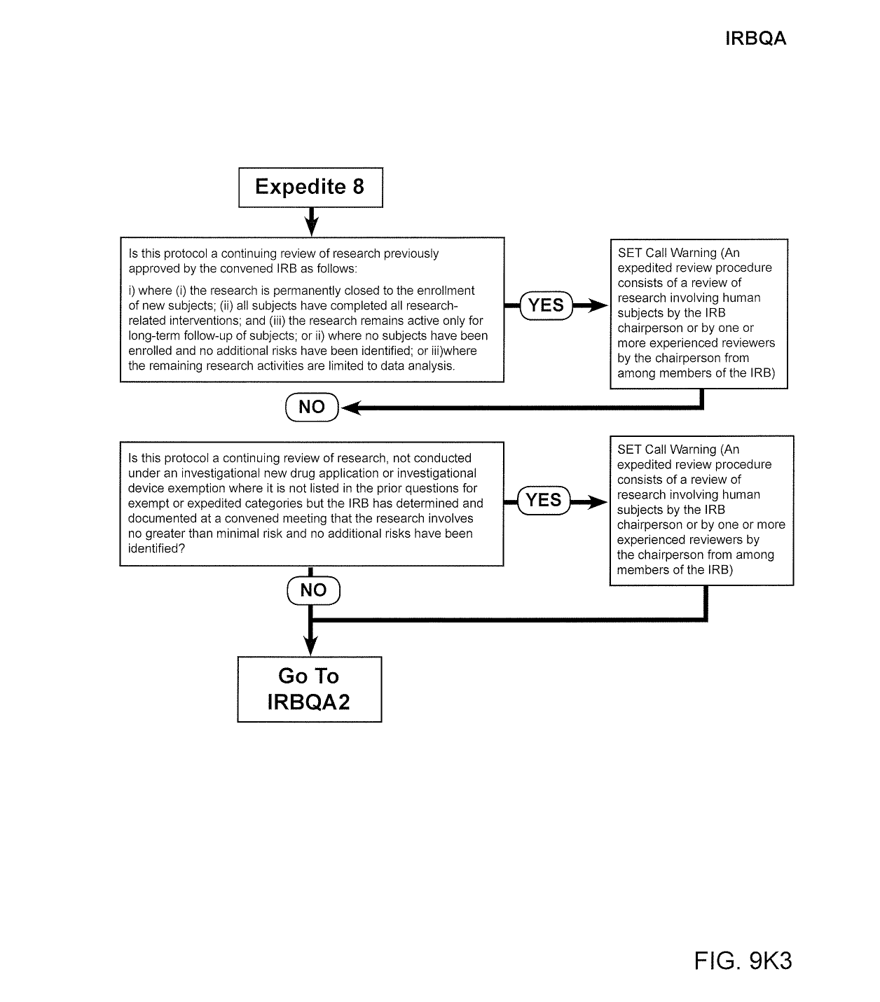

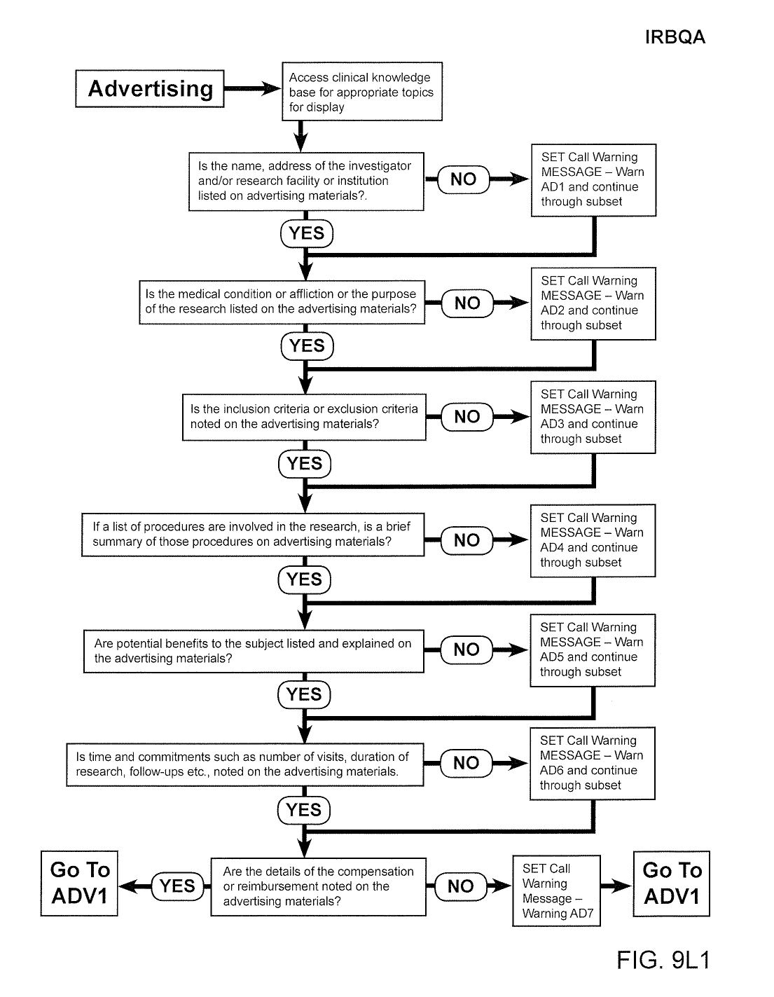

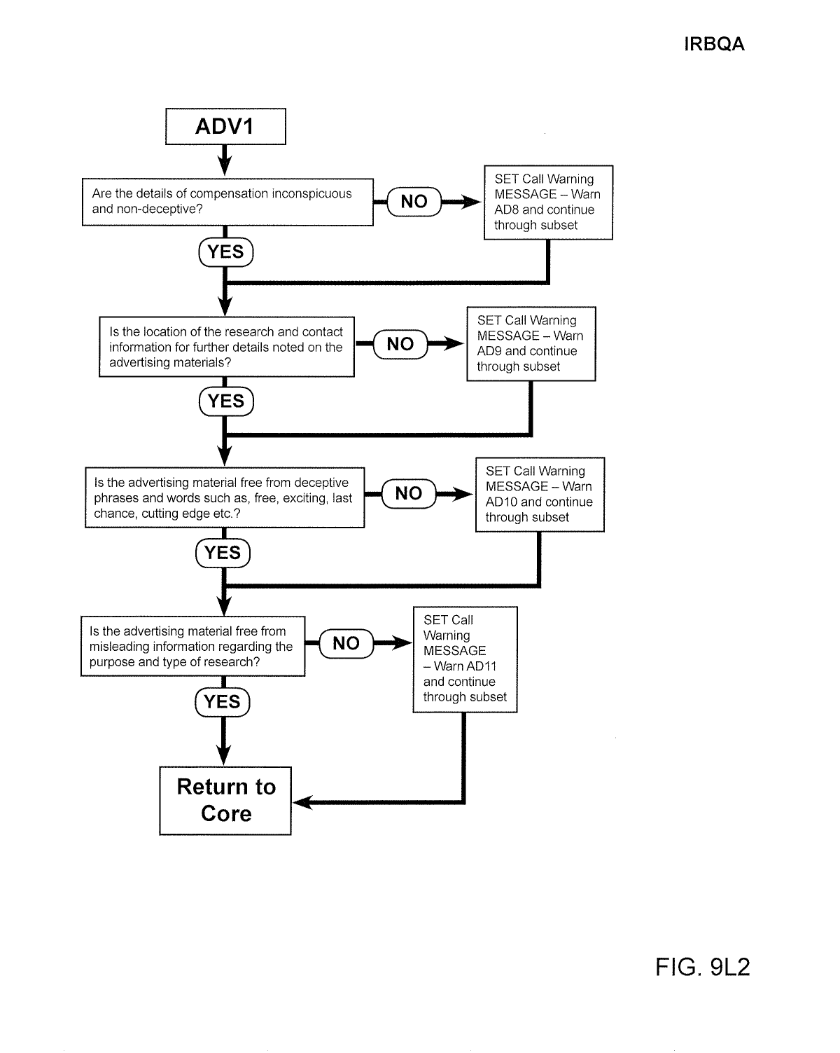

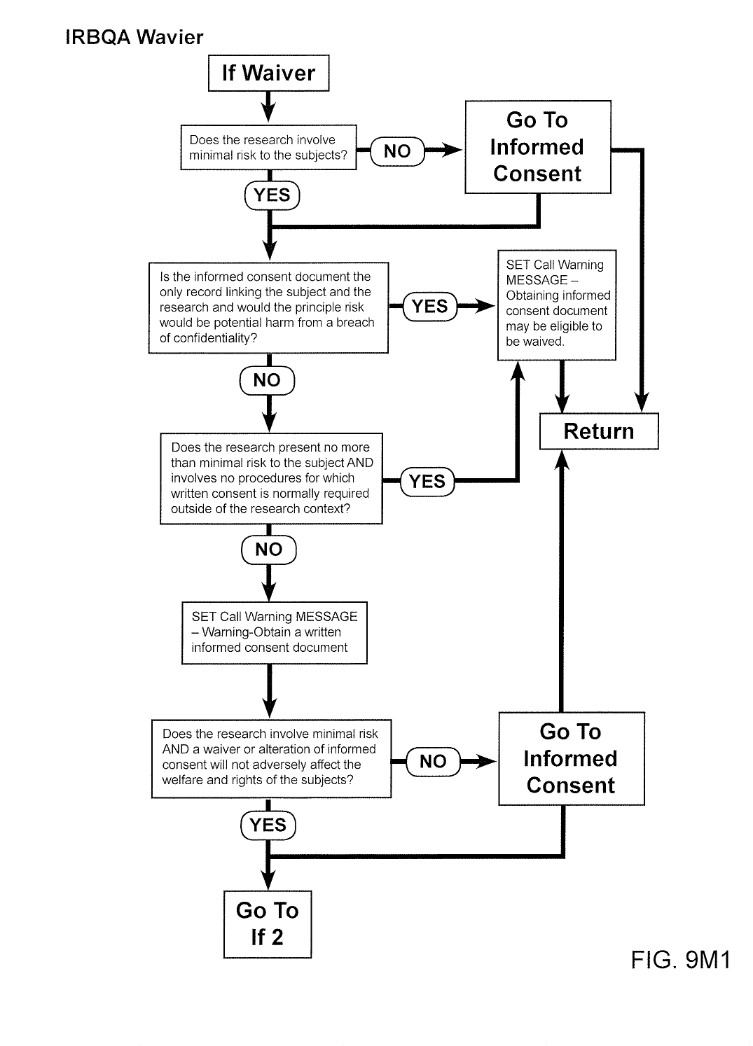

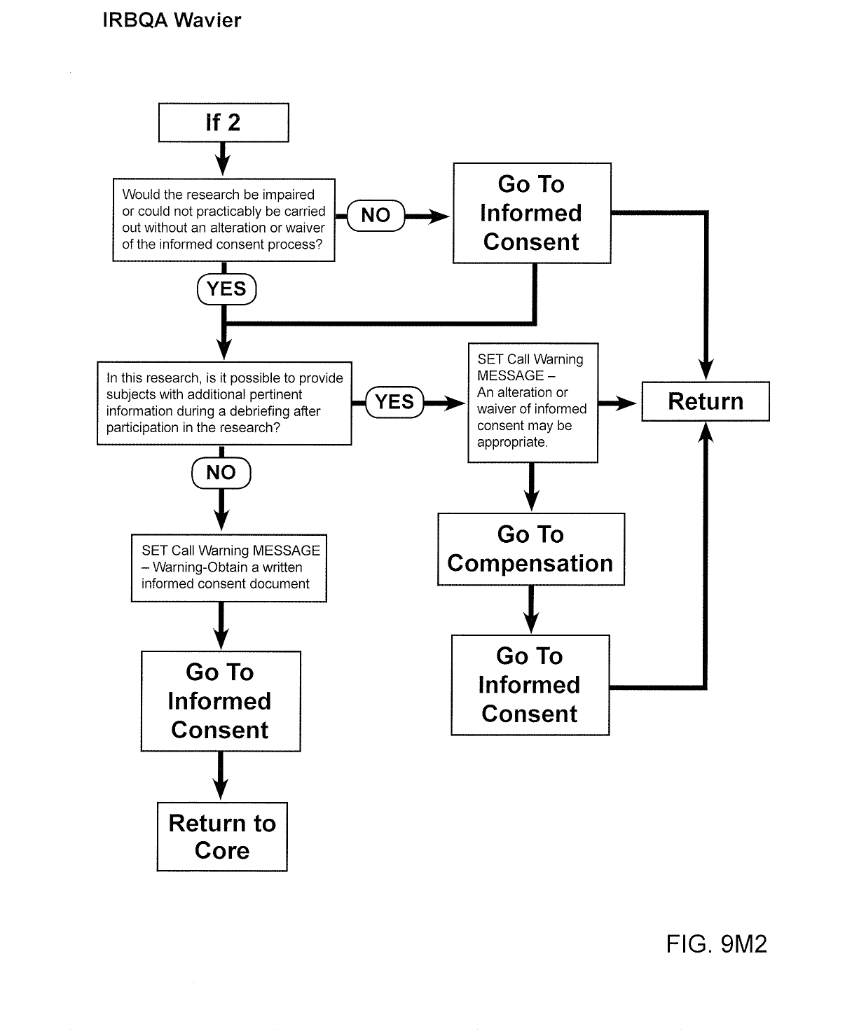

The following are the sub-set clinical trial review subject topics and sequential questions and decision points within the subject topics automated by IRBQA. FIGS. 9A1-9M2 are the flow charts that document decision points and warning or critical responses to questions and “Calls” to send and receive information to Knowledge-ICB 22.

§46.107 IRB Membership.

See FIG. 9A1 for the decision flow chart for the following questions:

1) Does the IRB have at least 5 members of varying backgrounds to promote complete and adequate review of research activities commonly conducted by the institution?

a) If “yes” proceed.”

b) If “no” please insure IRB is properly staffed.

2) Will the IRB review a protocol that involves a vulnerable population such as children, prisoners, and pregnant women, handicapped or mentally disable persons.

a) If “yes” please answer following: Does the IRB have a member who specializes in the specific vulnerable population?

i) If “yes” proceed.

b) If “no” proceed.

3) Does the IRB consist of members from multiple occupations?

a) If “no”, IRB must have a more diversified makeup.

b) If “yes” proceed.

4) Does the IRB have at least one member with a scientific background?

a) If “yes” proceed.

b) If “no”, IRB must admit a member with a scientific background.

5) Does the IRB have at least one member with a non-scientific background?

a) If “yes” proceed.

b) If “no” IRB must have at least one member with a non-scientific background.

6) Does the IRB include at least one member who is not otherwise affiliated with the institution and who is not part of the immediate family of a person who is affiliated with the institution?

a) If “yes” proceed.

b) If “no” IRB must review membership qualifications.

7) Does the IRB have a member in the IRB's initial or continuing review of any project in which the member has a conflicting interest?

a) If “yes” please review for conflict of interest (Note: Example, can insert a link for conflict of interest from education module)

b) If “no” proceed.

See FIG. 9A2 for the decision flow chart for the following questions:

8) Does the IRB need a non-member individual with competence in special areas to assist in the review of issues for the research protocol, which require expertise beyond or in addition to that available on the IRB?

a) If “yes,” please seek and appoint expert.

b) If “no”, proceed.

9) Is the user the Administrator?

a) If “yes,” enter all IRB members names and background information.

b) If “no”, proceed.

10) Is Informed Consent Document completed for this trial?

a) If “yes,” go to Informed Consent section.

b) If “no”, set warning flag and STOP.

11) Does this research involve children as defined as persons who have not attained the legal age for consent to treatments or procedures involved in the research under the applicable law of the jurisdiction in which the research will be conducted?

a) If “yes,” go to Children section.

b) If “no”, proceed.

FIG. 9B3 are gateways to policies related to other possible subjects (e.g., women, neonates, prisoners) and other topics (e.g., placenta, advertising, compensation). This list is not intended to limit the invention but to provide examples of the broad and flexible capabilities of system 10.

Reviewer Assessment Questions

See FIGS. 9C1-9C3 for the decision flow chart for the following questions:

General Questions of Preparation

a) Has the reviewer read the consent document(s)?

b) Has the reviewer read the protocol summary?

c) Has the reviewer read the full protocol and supporting or supplemental materials?

d) Does the reviewer have a conflict of interest with this protocol?

Background

1) Are the specific aims of the research clearly specified?

2) Is there adequate preliminary data to justify the research?

3) Id their appropriate justification for this protocol?

Design

4) Is the scientific design adequate for the protocol?

5) Are the objectives likely to be achievable in the stated timeframe of the research?

6) Is the scientific design, such as placebo controls, Phase I, II, or III, randomization etc., described and adequately justified?

Criteria

7) Are inclusion and exclusion criteria for subjects clearly specified and appropriate?

8) If women, children or minorities are excluded, is this justifiable?

9) Is the choice of subjects appropriate for the questions being asked?

10) Is the principle of distributive justice adequately incorporated into the inclusion and exclusion criteria for the protocol?

11) Is the subject selection equitable?

Recruitment

12) Are the methods for recruitment of subjects well defined?

See FIGS. 9D1-9D3 for the decision flow chart for the following questions:

13) Are the location and timing of the recruitment process appropriate for the process?

14) Are there acceptable methods for screening subjects before recruitment?

Procedures

15) Is the rationale and details of the research procedures accurately described and acceptable?

16) Is there a clear differential between research procedures and standard care?

17) Are the personnel performing the procedures appropriately trained and educated?

18) Is the location of where the procedures will be performed acceptable?

19) Is there adequate plans to inform subject about specific clinical results?

Drugs and Devices

20) Is the status of the drug, biological or device described? (E.g. Investigational new drug biological or device, FDA-approved drug, biological or device etc.)

21) Are the drugs dosage and route of administration appropriate?

22) Is the drug, biological or device safety and efficacy data sufficient to warrant the proposed phase of testing?

23) Is the significant risk or nonsignificant risk status of the drug, biological or device described and appropriate?

Analysis

24) Is the rationale for the proposed amount of subject reasonable?

25) Are the plans for data and statistical analysis defined and justified, including the use of stopping rules and end points?

26) Are there adequate provisions for monitoring data?

Risks, Discomforts and Benefits

27) Are the risks and benefits adequately identified, evaluated and described?

28) Are the potentials risks minimized and the likelihood of benefits maximized?

See FIGS. 9E1-9E3 for the decision flow chart for the following questions:

29) Is the risk to benefit ratio acceptable for proceeding with the research?

30) If children are involved, which regulatory category of risk/benefit does the protocol fall within?

Compensation and Costs

31) Is the amount and type of compensation or reimbursement reasonable?

32) Are there adequate provisions for the subject to avoid out of pocket expenses or sufficient justification for the subjects to incur costs?

Privacy and Confidentiality

33) Are there adequate provisions to protect the privacy and ensure the confidentiality of the research's subjects?

34) Are there adequate plans to store and code the data?

35) Is the use of identifiers or links to identifiers necessary?

36) Is the identifier or link to identifier protected?

Informed Consent

37) Are the elements of informed consent contained in the consent document?

38) Is the process of obtaining consent or assent adequately described?

39) Is assent required?

40) Is a waiver of consent or assent possible and justifiable?

Conflict

41) Does any investigator have a conflict of interest with this protocol?

42) Have conflict of interest statements of forms been filed and reviewed?

See FIGS. 9F1-9F3 for the decision flow chart for the following questions:

Informed Consent Document

1) Has a consent document been prepared for this trial? —CORE

A. If “yes” proceed.

B. If “no” prepare document

2) Does the document discuss the research purpose and procedures, including but not limited to, duration of the study and identification of experimental procedures to be followed?

A. If “yes” proceed.

B. If “no” review document

3) Does the document adequately discuss the risks, discomfort and side effects to the trial participant?

A. If “yes” proceed.

B. If “no” review document.

4) Does the document describe possible benefits to the subject that may be reasonably be expected from the research?

A. If “yes” proceed.

B. If “no” review document.

5) Does the document discuss alternative procedures or treatments that may be advantageous and beneficial to the subject?

A. If “yes” proceed.

B. If “no” review document.

6) Does the document describe the confidentiality and privacy of the data to the subject?

A. If “yes” proceed.

B. If “no” review document.

7) Does the document discuss the subjects recourse for research related illness or injury?

A. If “yes” proceed.

B. If “no” review document.

8) Does the document list research contacts for the subject to inquire or comment during the course of the trials?

A. If “yes” proceed.

B. If “no” review document.

9) Does the document have a statement regarding the voluntary nature of enrolling in the research, including the right to cease participation at any time without consequences?

A. If “yes” proceed.

B. If “no” review document

10) Does the research involve unforeseeable risks?

A. If “yes” answer following:

I. Does the document contain a statement about the risks to the subject of any unforeseen risks as a result of the research?

a) If “yes” proceed to next question.

b) If “no” review document.

B. If “no” proceed.

11) Does the document have a statement noting that the researcher without regard to subjects consent can terminate the research?

A. If “yes” proceed.

B. If “no” review document.

12) Does the form disclose if any additional costs may be expected from the subject?

A. If “yes” proceed.

B. If “no” review document.

13) Does the form have procedure listed for the subject to terminate from the research and the subsequent consequences from voluntary termination?

A. If “yes” proceed.

B. If “no” review document

14) Does the form disclose how any significant new findings from the research may be communicated to the subjects?

A. If “yes” proceed.

B. If “no” review document.

15) Does the form disclose the number of participants in the research.

A. If “yes” proceed.

B. If “no” review form.

See FIGS. 9G1-9G2 for the decision flow chart for the following questions:

Research Involving Pregnant Women or Fetuses.

1) Does the research involve pregnant women or fetuses.?

a) If “yes” proceed.

b) If “no” Skip below questions

2) Has scientifically appropriate, preclinical studies, including studies on pregnant animals, and clinical studies, including studies on nonpregnant women, been conducted and provided data for assessing potential risks to pregnant women and fetuses?

a) If “yes” proceed.

b) If “no” Stop

3) Is the risk to the fetus caused solely by interventions or procedures that hold out the prospect of direct benefit for the woman or the fetus?

a) If “yes” proceed.

b) If “no” see further questions:

i) Is the risk to the fetus not greater than minimal and the purpose of the research is the development of important biomedical knowledge, which cannot be obtained by any other means?

a) If “yes” proceed.

b) If “no” Stop

4) Is the risk the least possible to achieve the results of the research?

a) If “yes” proceed.

b) If “no” Stop

5) Does the research hold out the prospect of direct benefit to the pregnant woman, the prospect of a direct benefit both to the pregnant woman and the fetus, or no prospect of benefit for the woman nor the fetus when risk to the fetus is not greater than minimal and the purpose of the research is the development of important biomedical knowledge that cannot be obtained by any other means?

a) If “yes”, Has the woman's consent been obtained in accordance with informed consent revisions of all applicable regulations?

i) If “yes” proceed.

b) If “no” Stop

6) Does the research hold out direct benefit for the fetus solely?

a) If “yes”, Has the father's consent been given, except in the cases if he is unable to consent because of unavailability, incompetence, or temporary incapacity or the pregnancy resulted from rape or incest?

i) If “yes” proceed.

ii) If “no” “Obtain fathers consent.”

7) Has each individual necessary to give consent on the fetus behalf been fully informed of consent and regarding the reasonably foreseeable impact of the research on the fetus?

a) if “yes”, proceed.

b) If “no” secure proper informed consent from all parties.

8) Is the pregnant women or father of the fetus considered children who have not attained the legal age for consent to treatments or procedures involved in the research, under the applicable law of the jurisdiction in which the research will be conducted?

a) If “yes” go to

b) If “no” proceed.

9) Is there a monetary or other inducement to the subject to terminate the pregnancy?

a) if “yes” Stop, go to regulation 45 CFR 46.204

b) If “no” proceed.

10) Is any individual engaged in the research involved in any decisions as to the timing, method, or procedures used to terminate a pregnancy?

a) If “yes” Stop.

b) If “no” proceed.

See FIGS. 9H1-9H5 for the decision flow chart for the following questions:

Research involving neonates.

Research Involving Non-Viable Neonates.

1) Have scientifically appropriate, preclinical and clinical studies been conducted and provide data for assessing potential risks to the neonates?

a) If “yes” continue.

b) If “no” Stop

2) Do individuals engaged in the research have a part in determining the viability of a neonate?

a) If “yes” Stop.

b) If “No” continue.

3) Has the legally effective informed consent of both parents of the neonate been obtained in accord with proper informed consent procedures?

a) If “yes” proceed.

b) If “No” answer following:

i Was the pregnancy a result of rape or incest?

a. If “yes,” then father's signature not needed.

B. If “no,” then:

i) Is either parent unable to consent because of unavailability, incompetence, or temporary incapacity?

a) If “no” stop.

b) If “yes” answer following:

Is informed consent obtained from at least one competent and available parent?

A) “If “yes” continue to Question 4

B) If “no” Stop.

4) After delivery of the nonviable neonate will all of the following conditions apply:

A) Vital functions of the neonate will not be artificially maintained;

B) The research will not terminate the heartbeat or respiration of the neonate;

C) There will be no added risk to the neonate resulting from the research;

D) The purpose of the research is the development of important biomedical knowledge that cannot be obtained by other means.

a) If “yes” continue,

b) If “No” stop.

Research Involving Neonates of Uncertain Viability

1) Has the IRB determined that he research holds out the prospect of enhancing the probability of survival of the neonate to the point of viability, and any risk is the least possible for achieving that objective?

a) If “yes” continue.

b) If “no” stop.

2) Has the IRB determined the purpose of the research is the development of important biomedical knowledge, which cannot be obtained by other means, and there will be no added risk to the neonate resulting from the research?

a) If “yes” continue.

b) If “no” stop.

3) Has the legally effective informed consent of both parents of the neonate been obtained in accord with proper informed consent procedures?

a) If “yes” proceed.

b) If “No” answer following:

i) Is either parent unable to consent because of unavailability, incompetence, or temporary incapacity?

a) If “no” stop.

b) If “yes” answer following:

Is informed consent obtained from at least one competent and available parent?

A) “If “yes” continue to Question ii

B) If “no” Stop.

ii) Was the pregnancy a result of rape or incest?

a) If “yes” the father's signature not needed.

b) If “No” continue.

Research Involving Viable Neonates.

1) Have scientifically appropriate, preclinical and clinical studies been conducted and provide data for assessing potential risks to the neonates?

a) If “yes” continue.

b) If “no” Stop

2) Do individuals engaged in the research have a part in determining the viability of a neonate?

a) If “yes” Stop.

b) If “No” continue.

3) Has the legally effective informed consent of both parents of the neonate been obtained in accord with proper informed consent procedures?

a) If “yes” proceed.

b) If “No” answer following:

i) Is either parent unable to consent because of unavailability, incompetence, or temporary incapacity?

a) If “no” stop.

b) If “yes” answer following:

Is informed consent obtained from at least one competent and available parent?

A) “If “yes” continue to Question ii

B) If “no” Stop.

ii) Was the pregnancy a result of rape or incest?

a) If “yes” the father's signature not needed.

b) If “No” continue.

§46.206 Research involving, after delivery, the placenta, the dead fetus or fetal material.

1) Does the research involve, after delivery, the placenta; the dead fetus; macerated fetal material; or cells, tissue, or organs excised from a dead fetus?

a) If “yes” continue.

b) If “no” stop.

2) Is information associated with material described in question #1 recorded for research purposes in a manner that living individuals can be identified, directly or through identifiers linked to those individuals?

a) If “yes” those individuals are research subjects and proper methods of consent must be obtained.

b) If “no” stop.

§46.207 Research not otherwise approvable which presents an opportunity to understand, prevent, or alleviate a serious problem affecting the health or welfare of pregnant women, fetuses, or neonates.

1) Is the research not otherwise approvable which presents an opportunity to understand, prevent, or alleviate a serious problem affecting the health or welfare of pregnant women, fetuses, or neonates?

a) If “yes”. Notification by the Secretary of HEW must be sought to approve this protocol.

b) If “no” stop.

See FIGS. 9I1-9I3 for the decision flow chart for the following questions:

Research on children 45 CFR 46, Subpart C.

1) Does this research involve children as defined as persons who have not attained the legal age for consent to treatments or procedures involved in the research under the applicable law of the jurisdiction in which the research will be conducted?

a) If yes, proceed #2.

b) If no, stop.

2) Does this research involve minimal risk?

a) If yes, proceed to question #9.

b) If no, go to #3

3) Does this research involve greater than minimal risk and no prospect of direct benefits to the subjects but will yield generalized knowledge about the subject's disorder or condition?

a) If yes, proceed to question #4.

b) If no go to #5.

4) Does this research satisfy the following conditions?

i) The risk is justified by the anticipated benefits to the subjects.

ii) The relation of the anticipated benefit to the risk is at least as favorable to the subjects as that presented by available alternative approaches

iii) Adequate provisions are made for soliciting the assent of the children and permission of their parents or guardians.

a) If yes, proceed #13.

b) If no, stop.

5) Does this research involve greater than minimal risk and no prospect of direct benefits to the subjects but will yield generalized knowledge about the subject's disorder or condition?

a) If yes, go to #6.

b) If no, go to #8.

6) Does this research risk represent a minor increase over minimal risk?

a) If yes, proceed #7.

b) If no, Stop.

7) Does the intervention or procedure presents experiences to subjects that are reasonably commensurate with those inherent in their actual or expected medical, dental, psychological, social, or educational situations?

a) If yes, proceed #8

b) If no, stop.

8) Does the intervention or procedure likely to yield generalizable knowledge about the subjects' disorder or condition, which is of vital importance for the understanding or amelioration of the subjects' disorder, or condition?

a) If yes, go to #9.

b) If no, stop.

9) Have adequate provisions made for soliciting assent of the children and permission of their parents or guardians?

a) If yes, go to #14.

b) If no, seek permission.

10) Is this research not otherwise approvable which presents an opportunity to understand, prevent, or alleviate a serious problem affecting the health or welfare of children?

a) If yes, go to #11.

b) If no, stop.

11) Does the IRB the IRB find that the research presents a reasonable opportunity to further the understanding, prevention, or alleviation of a serious problem affecting the health or welfare of children?

a) If yes, go to #12

b) If no, stop.

12) Has the IRB received approval from the Secretary of DHHS, after consultation with a panel of experts in pertinent disciplines (for example: science, medicine, education, ethics, law) and following opportunity for public review and comment that the research is warranted?

a) If yes, go to #16.

b) If no

13) If the research involves greater than minimal risk, but presenting the prospect of direct benefit to the child, has permission of at least one parent or guardian been given?

a) If yes, go to #18.

b) If no, stop.

14) If the research involves greater than minimal risk and no prospect of direct benefits to the subjects but will yield generalized knowledge about the subjects disorder or condition has the IRB obtained both parents' permission?

a) If yes, go to #18

b) If no, go to #15.

15) If the IRB has not received both parents' permission for research on the child is one of these conditions applicable:

i) One parent is deceased.

ii) One parent is incompetent.

iii) One parent is unknown.

iv) One parent is not reasonably available.

v) Only one parent has legal responsibility for the child's care and custody.

a) If yes, go to #18.

b) If no, stop.

16) If this research is not otherwise approvable which presents an opportunity to understand, prevent, or alleviate a serious problem affecting the health or welfare of children and has been approved by the Secretary of DHHS, has permission of one parent been given?

a) If yes, go to #18.

b) If no, go to #17

17) If the IRB has not received both parents' permission for research on the child is one of these conditions applicable:

i) One parent is deceased.

ii) One parent is incompetent.

iii) One parent is unknown.

iv) One parent is not reasonably available.

v) Only one parent has legal responsibility for the child's care and custody.

a) If yes, go to #18.

b) If no, stop.

18) Has a written permission or consent form, which details the appropriate requirements for informed consent been signed by the parents?

a) If yes, go to #19.

b) If no, stop.

19) Has the IRB sought and received the assent of the child for research?

a) If yes, go to CORE

b) If no, go to #20

20) Is the capability of the child so limited that they cannot reasonably be consulted or that the intervention or procedure involved in the research holds out a prospect of direct benefits that is important to the health of the child and is available only in the context of the research?

a) If yes, go to CORE

b) If no, seek assent

See FIGS. 9J1-9J3 for the decision flow chart for the following questions:

Prisoners 45 CFR 46 Subpart C:

1) Does this research involve prisoners? Core Question

a. If yes, proceed to subset.

b. If no,—Return to core

Subset Questions

1) Does this research involve at least one of the following categories?

(i) Study of the possible causes, effects, and processes of incarceration, and of criminal behavior.

(ii) Study of prisons as institutional structures or of prisoners as incarcerated persons,

(iii) Research on conditions particularly affecting prisoners as a class (for example, vaccine trials and other research on hepatitis which is much more prevalent in prisons than elsewhere; and research on social and psychological problems such as alcoholism, drug addiction, and sexual assaults)

(iv) Research on practices, both innovative and accepted, which have the intent and reasonable probability of improving the health or well-being of the subject.

a) If yes, #2

b) If no, return to core

2) Does this research involve minimal risk which is defined as the probability and magnitude of physical or psychological harm that is normally encountered in the daily lives, or in the routine medical, dental, or psychological examination of healthy persons?

a. If yes, #3

b. If no, core

3) Are the risks involved in the research commensurate with risks that would be accepted by non-prisoner volunteers?

a. If yes, #4

b. If no, core.

4) Is at least one member of the Board a prisoner, or a prisoner representative with appropriate background and experience to serve in that capacity?

a. If yes, #5.

b. If no, core.

5) Does the majority of the Board (exclusive of prisoner members) have no association with the prison(s) facilities involved in the research?

a. If yes, #6.

b. If no, core.

6) Does any possible advantages accrue to the prisoner through his or her participation in the research, when compared to the general living conditions, medical care, quality of food, amenities and opportunity for earnings in the prison and are not of such a magnitude that his or her ability to weigh the risks of the research against the value of such advantages in the limited choice environment of the prison is impaired?

a. If yes, #7.

b. If no, core.

7) Are the procedures for the selection of subjects within the prison fair to all prisoners and immune from arbitrary intervention by prison authorities or prisoners?

a. If yes, #8.

b. If no, core.

8) Is the research information presented to the prisoner consistent with his language skills and educational levels to make an informed decision?

a. If yes, #9.

b. If no, core.

9) Is their adequate assurance that parole boards will not take into account a prisoner's participation in the research in making decisions regarding parole, and each prisoner is clearly informed in advance that participation in the research will have no effect on his or her parole?

a. If yes, #10.

b. If no, core.

10) Have adequate provisions been made if there may be a need for follow-up examinations or care of participants after the end of their participation in the research and taking into account the varying lengths of individual prisoners' sentences, and for informing participants of this fact?

a. If yes, finished, return to core.

b. If no, stop.

See FIGS. 9L1-9L2 for the decision flow chart for the following questions:

Advertising

1) Will the research involve advertisements, through various posters, brochures, scripts or other advertising for recruitment of subjects? CORE

a) If yes, go to #2.

b) If no, stop return to core.

Subset questions:

2) Is the name, address of the investigator and/or research facility or institution listed on advertising materials?

a) If yes, go to #3

b) If no, stop. Warn and continue through subset

3) Is the medical condition or affliction or the purpose of the research listed on the advertising materials?

a) If yes, go to #4

b) If no, stop. Warn and continue through subset

4) Is the inclusion criteria or exclusion criteria noted on the advertising materials?

a) If yes, go to #5.

b) If no, stop. Warn and continue through subset

5) If a list of procedures are involved in the research, is a brief summary of those procedures on advertising materials?

a) If yes, go to #6.

b) If no, stop. Warn and continue through subset

6) Are potential benefits to the subject listed and explained on the advertising materials?

a) If yes, go to #7.

b) If no, stop. Warn and continue through subset

7) Is time and commitments such as number of visits, duration of research, follow-ups etc., noted on the advertising materials.

a) If yes, go to #8.

b) If no, stop. Warn and continue through subset

8) Are the details of the compensation or reimbursement noted on the advertising materials?

a) If yes, go to #9.

b) If no, stop. Warn and continue through subset

9) Are the details of compensation inconspicuous and non-deceptive?

a) If yes, go to #10.

b) If no, Warn and continue through subset

10) Is the location of the research and contact information for further details noted on the advertising materials?

a) If yes, go to #11.

b) If no, stop. Warn and continue through subset

11) Is the advertising material free from deceptive phrases and words such as, free, exciting, last chance, cutting edge etc.?

a) If yes, go to #12

b) If no, stop. Warn and continue through subset

12) Is the advertising material free from misleading information regarding the purpose and type of research?

a) If yes, go to CORE.

b) If no, stop. Warn and continue to CORE.

See FIGS. 9M1-9M2 for the decision flow chart for the following questions:

Waiver or Alteration of Consent

1) Does the research involve minimal risk to the subjects? Core

a) If yes, go to #2.

b) If no, go to CORE—INFORMED CONSENT MODULE

2) Is the informed consent document the only record linking the subject and the research and would the principle risk would be potential harm from a breach of confidentiality?

a) If yes, Warning—Obtaining informed consent document may be eligible to be waived. Go to CORE.

b) If no, go to #3.

3) Does the research present no more than minimal risk to the subject AND involves no procedures for which written consent is normally required outside of the research context?

a) If yes, Warning—Obtaining informed consent document may be eligible to be waived. Go to CORE.

b) If no, “Warning-Obtain a written informed consent document,” go to CORE #4

4) Does the research involve minimal risk AND a waiver or alteration of informed consent will not adversely affect the welfare and rights of the subjects? CORE

a) If yes, go to #5

b) If no, go to CORE—INFORMED CONSENT MODULE

5) Would the research be impaired or could not practicably be carried out without an alteration or waiver of the informed consent process?

a) If yes, go to #6

b) If no, go to CORE—INFORMED CONSENT MODULE

6) In this research, is it possible to provide subjects with additional pertinent information during a debriefing after participation in the research?

a) If yes, “Warning—An alteration or waiver of informed consent may be appropriate. Go to, CORE—COMPENSATION MODULE (NOTE: SKIP INFORMED CONSENT MODULE)

b) If no, “Warning-Obtain a written informed consent document” Go to CORE—INFORMED CONSENT MODULE

See FIGS. 9B1-9B3 for the decision flow chart for the following questions:

Categories of IRB Reviews.

1) Does this research protocol involve the use of human test subjects? CORE

a) If yes, go to #2

b) If no, WARNING: Research may be exempt and not subject to full IRB

Review.

Exempted research.

2) Is the research being conducted in established or commonly accepted educational settings, involving normal educational practices, such as (i) research on regular and special education instructional strategies, or (ii) research on the effectiveness of or the comparison among instructional techniques, curricula, or classroom management methods?CORE

a) If yes, WARNING: Research may be exempt and not subject to full IRB Review.

b) No, go to #3

3) Does the research involve the use of educational tests (cognitive, diagnostic, aptitude, achievement), survey procedures, interview procedures or observation of public behavior, unless: (i) information obtained is recorded in such a manner that human subjects can be identified, directly or through identifiers linked to the subjects; and (ii) any disclosure of the human subjects' responses outside the research could reasonably place the subjects at risk of criminal or civil liability or be damaging to the subjects' financial standing, employability, or reputation? CORE

a) If yes, WARNING: Research may be exempt and not subject to full IRB Review.

b) No, go to #4

4) Does the research involve the use of educational tests (cognitive, diagnostic, aptitude, achievement), survey procedures, interview procedures, or observation of public behavior if: (i) the human subjects are elected or appointed public officials or candidates for public office; or (ii) federal statute(s) require(s) without exception that the confidentiality of the personally identifiable information will be maintained throughout the research and thereafter?CORE

a) If yes, WARNING: Research may be exempt and not subject to full IRB Review.

b) No, go to #5

5) Does the research involve the collection or study of existing data, documents, records, pathological specimens, or diagnostic specimens, if these sources are publicly available or if the information is recorded by the investigator in such a manner that subjects cannot be identified, directly or through identifiers linked to the subjects? CORE

a) If yes, WARNING: Research may be exempt and not subject to full IRB Review.

b) No, go to #6

6) Is the research or demonstration projects which are conducted by or subject to the approval of governmental department or agency heads, and which are designed to study, evaluate, or otherwise examine: (i) Public benefit or service programs; (ii) procedures for obtaining benefits or services under those programs; (iii) possible changes in or alternatives to those programs or procedures; or (iv) possible changes in methods or levels of payment for benefits or services under those programs? CORE

a) If yes, WARNING: Research may be exempt and not subject to full IRB

Review.

b) No, go to #7

7) Does the research involve taste and food quality evaluation and consumer acceptance studies, (i) if wholesome foods without additives are consumed or (ii) if a food is consumed that contains a food ingredient at or below the level and for a use found to be safe, or agricultural chemical or environmental contaminant at or below the level found to be safe, by the Food and Drug Administration or approved by the Environmental Protection Agency or the Food Safety and Inspection Service of the U.S. Department of Agriculture? CORE

a) If yes, WARNING: Research may be exempt and not subject to full IRB Review.

b) No, go to next CORE question.

Expedited Research

1) Does the primary research present no more than minimal risk to human subjects, and involve clinical studies of drugs and medical devices, and only when condition (a) or (b) is met? CORE

i) (a) Research on drugs for which an investigational new drug application (21 CFR Part 312) is not required. (Note: Research on marketed drugs that significantly increases the risks or decreases the acceptability of the risks associated with the use of the product is not eligible for expedited review.)

ii) Research on medical devices for which (i) an investigational device exemption application (21 CFR Part 812) is not required; or (ii) the medical device is cleared/approved for marketing and the medical device is being used in accordance with its cleared/approved labeling.

a) If yes, Warning An expedited review procedure consists of a review of research involving human subjects by the IRB chairperson or by one or more experienced reviewers designated by the chairperson from among members of the IRB

b) If no go to #2.

2) Does the primary research present no more than minimal risk to human subjects, and involve collection of blood samples by finger stick, heel stick, ear stick, or venipuncture as follows: CORE

i) (a) from healthy, nonpregnant adults who weigh at least 110 pounds. For these subjects, the amounts drawn may not exceed 550 ml in an 8 week period and collection may not occur more frequently than 2 times per week; or

ii) from other adults and children², considering the age, weight, and health of the subjects, the collection procedure, the amount of blood to be collected, and the frequency with which it will be collected. For these subjects, the amount drawn may not exceed the lesser of 50 ml or 3 ml per kg in an 8 week period and collection may not occur more frequently than 2 times per week.

a) If yes, Warning An expedited review procedure consists of a review of research involving human subjects by the IRB chairperson or by one or more experienced reviewers designated by the chairperson from among members of the IRB

b) If no go to #3.

See FIGS. 9K1-9K3 for the decision flow chart for the following questions:

3) Does the research present no more than minimal risk to human subjects, and involves prospective collection of biological specimens for research purposes by noninvasive means. Examples: (a) hair and nail clippings in a nondisfiguring manner; (b) deciduous teeth at time of exfoliation or if routine patient care indicates a need for extraction; (c) permanent teeth if routine patient care indicates a need for extraction; (d) excreta and external secretions (including sweat); (e) uncannulated saliva collected either in an unstimulated fashion or stimulated by chewing gumbase or wax or by applying a dilute citric solution to the tongue; (f) placenta removed at delivery; (g) amniotic fluid obtained at the time of rupture of the membrane prior to or during labor; (h) supra- and subgingival dental plaque and calculus, provided the collection procedure is not more invasive than routine prophylactic scaling of the teeth and the process is accomplished in accordance with accepted prophylactic techniques; (i) mucosal and skin cells collected by buccal scraping or swab, skin swab, or mouth washings; (j) sputum collected after saline mist nebulization. CORE

a) If yes, Warning An expedited review procedure consists of a review of research involving human subjects by the IRB chairperson or by one or more experienced reviewers designated by the chairperson from among members of the IRB

b) If no, go to #4.

4) Does the research present no more than minimal risk to human subjects and involve collection of data through noninvasive procedures (not involving general anesthesia or sedation) routinely employed in clinical practice, excluding procedures involving x-rays or microwaves. Where medical devices are employed, they must be cleared/approved for marketing. (Studies intended to evaluate the safety and effectiveness of the medical device are not generally eligible for expedited review, including studies of cleared medical devices for new indications.) Examples: (a) physical sensors that are applied either to the surface of the body or at a distance and do not involve input of significant amounts of energy into the subject or an invasion of the subject=s privacy; (b) weighing or testing sensory acuity; (c) magnetic resonance imaging; (d) electrocardiography, electroencephalography, thermography, detection of naturally occurring radioactivity, electroretinography, ultrasound, diagnostic infrared imaging, doppler blood flow, and echocardiography; (e) moderate exercise, muscular strength testing, body composition assessment, and flexibility testing where appropriate given the age, weight, and health of the individual. CORE

a) If yes, Warning An expedited review procedure consists of a review of research involving human subjects by the IRB chairperson or by one or more experienced reviewers designated by the chairperson from among members of the IRB

b) If no, go to #5.

5) Does the primary research present no more than minimal risk to human subjects and involve materials (data, documents, records, or specimens) that have been collected, or will be collected solely for nonresearch purposes (such as medical treatment or diagnosis). (NOTE: Some research in this category may be exempt from the HHS regulations for the protection of human subjects. 45 CFR 46.101(b)(4). This listing refers only to research that is not exempt.) CORE

a) If yes, Warning An expedited review procedure consists of a review of research involving human subjects by the IRB chairperson or by one or more experienced reviewers designated by the chairperson from among members of the IRB

b) If no, go to #6

6) Does the primary research present no more than minimal risk to human subjects and involve the collection of data from voice, video, digital, or image recordings made for research purposes? CORE

a) If yes, Warning An expedited review procedure consists of a review of research involving human subjects by the IRB chairperson or by one or more experienced reviewers designated by the chairperson from among members of the IRB

b) If no, go to #7.

7) Does the primary research present no more than minimal risk to human subjects, and is conducted on individual or group characteristics or behavior (including, but not limited to, research on perception, cognition, motivation, identity, language, communication, cultural beliefs or practices, and social behavior) or research employing survey, interview, oral history, focus group, program evaluation, human factors evaluation, or quality assurance methodologies. (NOTE: Some research in this category may be exempt from the HHS regulations for the protection of human subjects. 45 CFR 46.101(b)(2) and (b)(3). This listing refers only to research that is not exempt.) CORE

a) If yes, Warning An expedited review procedure consists of a review of research involving human subjects by the IRB chairperson or by one or more experienced reviewers designated by the chairperson from among members of the IRB

b) If no, go to #8.

8) Is this protocol a continuing review of research previously approved by the convened IRB as follows: CORE

i) where (i) the research is permanently closed to the enrollment of new subjects; (ii) all subjects have completed all research-related interventions; and (iii) the research remains active only for long-term follow-up of subjects; or ii) where no subjects have been enrolled and no additional risks have been identified; or

iii) where the remaining research activities are limited to data analysis.

a) If yes, Warning An expedited review procedure consists of a review of research involving human subjects by the IRB chairperson or by one or more experienced reviewers designated by the chairperson from among members of the IRB

b) If no, go to #9.

9) Is this protocol a continuing review of research, not conducted under an investigational new drug application or investigational device exemption where it is not listed in the prior questions for exempt or expedited categories but the IRB has determined and documented at a convened meeting that the research involves no greater than minimal risk and no additional risks have been identified. CORE

a) If yes, Warning An expedited review procedure consists of a review of research involving human subjects by the IRB chairperson or by one or more experienced reviewers designated by the chairperson from among members of the IRB

b) If no, go to next CORE.

Alternative embodiments of the present invention include computer generated notices to users (e.g., curriculum builders) that the Knowledge-ICB database has been updated and that information previously pulled or downloaded from the Knowledge-ICB database for course building, for example, may be outdated. System 10 will maintain the old version of the lesson 76 until all students complete the lesson 76 when topic 64 is updated in a RLO 52 that are part of a lesson 76. Further embodiments of the present invention can include identifying the particular course that contains the outdated information and identifying the students whom have taken test questions that relate to the outdated information.

Another embodiment of system 10 can be used by an organization to load their organization policies and procedures for electronic distribution and training of employees. For example, Carlow University can access the Knowledge ICB 22 through EthAssist web page 68 by selecting the Carlow University button 232 on FIG. 8A. The subsequent web pages can be customized to meet the educational and training needs of the organization, where the organization can place its policies and procedures on Knowledge ICB 22 for exclusive use by its employees and other authorized personnel. The educational and training modules can be developed based on the techniques described above.

Yet another embodiment of system 10 can allow patients to directly access Knowledge-ICB 22 to educate themselves regarding healthcare ethics they are facing. A separate login screen, possibly through an insurance company web site, is provided for read-only access to ethics topics and other applicable topics.

Still yet another embodiment of system 10 can allow the general public to take specific lessons in Curriculum Builder 28 for continuing education units, for example for a subscription fee, pay for play transaction.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

1. A system, comprising:
a server which executes a software module, and
a database comprising a plurality of topics and associated reusable learning objects;
wherein the software module contains an executable routine to send one or more user selected inquiries to the database for extraction of one or more topics and associated reusable learning object from the plurality of topics and associated reusable learning objects.

2. The system according to claim 1, wherein the extracted one or more topics and associated reusable learning objects are incorporated into a real-time questionnaire.

3. The system according to claim 1, wherein the executable routine incorporates the extracted one or more topics and associated reusable learning objects into a course.

4. The system according to claim 1, wherein the executable routine is pre-programmed in drop down menus.

5. The system according to claim 1, wherein the executable routine is pre-programmed in “Yes” and “No” user selections.

6. The system according to claim 3, wherein:
the executable routine transmits a record of each topic and related reusable learning objects associate with a user to the database for storage; and
the executable routine transmits an update notice to the user when the each topic and related reusable learning objects are updated in the database,
whereby the user is informed that the course may be outdated.

7. The system according to claim 2, wherein a record is generated when the questionnaire is completed.

8. The system according to claim 3, wherein the executable routine generates a pre-determined number of random test questions when a signal is received that a student requests a quiz.

9. The system according to claim 3, wherein the executable routine incorporates one or more videos into the course when a signal is received selecting the one or more videos.

10. A computer-implemented ethics compliance method, comprising the steps of:
providing a server which executes a software module associated with a plurality of questionnaires, and a data storage medium to store a database associated with the plurality of questionnaires;
creating the database comprising a plurality of topics and associated reusable learning objects, and the plurality of questionnaires;
launching a questionnaire of the plurality of questionnaires in response to a start questionnaire request, wherein the questionnaire contains a plurality of input fields to collect data on a patient;
recording in the database in a patient file an input to each input field of the plurality of input fields in response to a transmission of the input;
displaying a subsequent input field of the plurality of input fields depending on the input; and
displaying a topic of the plurality of topics prior to displaying predetermined input fields,
whereby most current topics will be contained in the questionnaire.

11. A computer-implemented training method, comprising the steps of:
providing a server which executes a software module associated with a quiz questions, and a data storage medium to store a database associated with the plurality of quiz questions;
creating the database that comprises a plurality of topics and associated reusable learning objects, and the plurality of quiz questions;
launching a curriculum builder module to create a lesson;
storing one or more topics selected by a user from the database as the lesson;
linking one or more videos related to the one or more topics of the lesson, wherein each video comprises a multimedia duration;
assigning one or more students to the lesson;
creating a quiz based on random selection of questions from the plurality of questions; and
storing results of the quiz on the database.

12. A computer-implemented review board selection method, comprising the steps of:
providing a server which executes a software module associated with a questionnaire, and a data storage medium to store a database associated with the questionnaire;
creating the database comprises a plurality of topics and associated reusable learning objects, and the questionnaire;
launching the questionnaire in response to a start questionnaire request, wherein the questionnaire contains a plurality of input fields to collect data on review board members;
recording in the database in a review board file an input to each input field of the plurality of input fields in response to a transmission of the input;
displaying a subsequent input field of the plurality of input fields depending on the input; and
displaying a topic of the plurality of topics prior to displaying predetermined input fields,
whereby the formation of the review board is in compliance with policies and procedures.

13. The method according to claim 12, further comprising the step of generating a warning report that contains critical messages and warning messages based on importance of the each input field of the plurality of input fields.

14. The method according to claim 11, wherein the step of selecting one or more topics from the database and storing as the lesson comprises the steps of:
opening a word search box;
typing one or more letters of a desired topic of the one or more topics;
displaying a listing of topics;
selecting the one or more topics from the listing of topics; and
storing the one or more topics as the lesson.

15. The method according to claim 11, wherein the step of selecting one or more topics from the database and storing as the lesson comprises the steps of:
selecting an ethical subject area from a drop down menu;
displaying a listing of topics of the selected ethical subject area;
selecting the one or more topics from the listing of topics from the database; and
storing the one or more topics as the lesson.

16. The method according to claim 10, further comprising the step of assigning a code to the questionnaire associated with the patient such that no actual names of patients are recorded.

17. The method according to claim 10, further comprising the steps of:
generating an interview summary upon completion of the questionnaire; and
removing the patient file from the database upon the generation of the interview summary.

18. The method according to claim 11, further comprising the steps of:
accumulating the multimedia durations of the one or more videos to calculate a running total of a training duration;
displaying the running total of the training duration; and
editing the lesson by adding the one or more topics to lesson or deleting the one or more topics from the lesson to meet course requirements or restrictions.

19. The method according to claim 11, further comprising the step of saving the lesson as a template.

20. The method according to claim 11, further comprising the step of assigning a homework assignment to the one or more students.

21. The method according to claim 20, wherein the step of assigning the homework assignment to the one or more students comprising the steps of:
sending a request to the database to return a listing of students who match one or more letters typed into a user name box;
displaying the listing of students;

22. The method according to claim 12, further comprising the step of providing a report of outstanding responses by board members.

23. The method according to claim 22, wherein the step of recording further comprises the assigning a warning or a critical message to the input.

24. The method according to claim 12, further comprising the step of assigning a time and a date to the input.

25. The method according to claim 11, further comprising the steps of:
recording the user who created the lesson; and
generating and sending a notice to the user when the one or more topics selected by the user from the database is updated.

26. The method according to claim 25, further comprising the step of deleting an outdate version of the one or more topics when all assigned students have completed the lesson.

27. The method according to claim 26, further comprising the step of identifying students whom have taken test questions that relate to the outdated version of the one or more topics.

28. The method according to claim 11, wherein the plurality of topics are organizational policies and procedures.

29. The method according to claim 11, wherein the user is a patient.

30. the method according to claim 11, wherein the user is a subscription user or a pay-per-transaction user.
